(19) United States
(12) Patent Application Publication
(10) Pub. No.: US 2026/0099975 A1
(43) Pub. Date: Apr. 9, 2026

(54) REAL-TIME INTERACTIVE MEDIA CONTENT AND MULTIMODAL PERFORMANCE ANALYSIS

(71) Applicant: Assurant, Inc., New York, NY (US)

(72) Inventor: Dan GRONSBELL, Marietta, GA (US)

(21) Appl. No.: 18/906,329

(22) Filed: Oct. 4, 2024

(51) Int. Cl. G06T 13/40; G10L 15/26

(52) U.S. Cl. CPC G06T 13/40; G10L 15/26

(57) ABSTRACT

Various embodiments are directed to apparatuses, methods, computer-readable media, computer program products, and systems related to simulated training and performance analysis. In some embodiments, the method may comprise causing, by one or more processors, display of real-time interactive media content to a user; receiving, by one or more processors, one or more audiovisual inputs captured in association with the user; causing, by one or more processors, the real-time interactive media content to interact with the user in real time by generating and displaying one or more audiovisual responses to the one or more audiovisual inputs; applying, by one or more processors, the one or more audiovisual inputs into a multimodal performance analysis engine to generate one or more performance analysis data objects; and generating, by one or more processors, one or more visual feedback interfaces based at least in part on the one or more performance analysis data objects.

### FIELD OF THE INVENTION

The present disclosure relates to systems, methods, computer readable media, assemblies, components, and apparatuses for generating real-time interactive media content and multimodal performance analysis.

### BACKGROUND

Existing technology cannot effectively generate real-time interactive media content to simulate human audiovisual features, personalities, and interactions, or programmatically analyze and respond to human audiovisual inputs due to current technological deficiencies, particularly at scale and in remote scenarios. Applicant has identified a number of additional challenges associated with providing simulated training and performance analysis data. Through applied effort, ingenuity, and innovation many deficiencies of existing systems have been solved by developing solutions that are in accordance with the embodiments as discussed herein, many examples of which are described in detail herein.

### BRIEF SUMMARY

In general, embodiments of the present disclosure provided herein may relate to providing simulated training and performance analysis data. Other implementations for simulated training and performance analysis will be, or will become, apparent to one with skill in the art upon examination of the following figures and detailed description. It is intended that all such additional implementations be included within this description be within the scope of the disclosure and be protected by the following claims.

In some embodiments, a real-time interactive media content system comprises at least one processor and at least one memory, the at least one memory comprising computer coded instructions therein, wherein the computer coded instructions are configured to, when executed by the at least one processor, cause the system to: cause display of real-time interactive media content to a user via a display device, the real-time interactive media content comprising at least a content audio component and a content video component; receive one or more audiovisual inputs captured in association with the user, the audiovisual inputs comprising a user audio component comprising audio data of the user captured during display of the real-time interactive media content and a user video component comprising one or more images of the user captured during display of the real-time interactive media content; programmatically cause the real-time interactive media content to interact with the user in real time by programmatically generating and displaying one or more audiovisual responses to the one or more audiovisual inputs, the one or more audiovisual responses including audio outputs configured to be played to the user and simulated facial expressions configured to be displayed to the user via the real-time interactive media content; apply the audiovisual inputs into a multimodal performance analysis engine to generate one or more performance analysis data objects; and programmatically generate one or more visual feedback interfaces based at least in part on the one or more performance analysis data objects, the one or more visual feedback interfaces comprising programmatically generated graphical representations determined based at least in part on the one or more performance analysis data objects. In various embodiments, the multimodal performance analysis engine is trained based at least in part on contextual interaction data comprising audiovisual media of interactive engagements. In various embodiments, the multimodal performance analysis engine is trained using reinforcement learning data received from human feedback based at least in part on (a) predetermined attention criteria data indicative of at least one of one or more audio-based features or one or more video-based features to be used in generating the one or more performance analysis data objects and (b) predetermined scoring criteria data comprising one or more weights respective to the predetermined attention criteria data. In various embodiments, applying the one or more audiovisual inputs into a multimodal performance analysis engine to generate one or more performance analysis data objects comprises: generating, based at least in part on the user audio component of the one or more audiovisual inputs, one or more audio-based features, the one or more audio-based features indicative of one or more audibly detected actions associated with the user; generating, based at least in part on the user video component of the one or more audiovisual inputs, one or more video-based features, the one or more video-based features indicative of one or more visually detected actions associated with the user; and generating the one or more performance analysis data objects based at least in part on the one or more audio-based features and the one or more video-based features. In various embodiments, the computer-implemented method further comprises generating, via the multimodal performance analysis engine and based at least in part on the one or more performance analysis data objects, one or more audiovisual suggestions, wherein the programmatically generated graphical representations are based at least in part on the one or more audiovisual suggestions. In various embodiments, the programmatically generated graphical representations comprise graphical representations of the one or more audiovisual suggestions, the one or more audiovisual suggestions comprising contextual interaction data configured to be displayed to the user. In various embodiments, the one or more graphical representations are associated with a trainee mode, wherein in the trainee mode, the programmatically generated graphical representations are based on (a) one or more historical performance analysis data objects associated with the user and (b) one or more respective historical performance analysis data objects associated with one or more different users. In various embodiments, the one or more graphical representations are associated with an administrator mode, wherein in the administrator mode, the programmatically generated graphical representations are based on a plurality of historical performance analysis data objects associated with a respective plurality of different users. In various embodiments, the one or more audiovisual responses are based at least in part on a simulated personality type and an experience rating, the experience rating associated with one or more historical performance analysis data objects associated with the user. In various embodiments, the multimodal performance analysis engine is further configured to generate a tiered sequence of real-time interactive media content comprising a recommended sequence (e.g., queue) of real-time interactive media content for the user associated with a time interval and based at least in part on one or more historical performance analysis data objects associated with the user. In various embodiments, the real-time interactive media content system further comprises: converting at least one of the user audio component or the user video component to one or more textual input data sets; inputting the one or more textual input data sets into an interaction engine configured to generate one or more contextual response data sets based at least in part on the one or more textual input data sets; and generating the one or more audiovisual responses by inputting the one or more contextual response data sets into an audiovisual media content engine configured to generate the one or more audiovisual responses based at least in part on the one or more contextual response data sets.

Various embodiments are directed to a computer-implemented method comprising: causing, by one or more processors, display of real-time interactive media content to a user via a display device, the real-time interactive media content comprising at least a content audio component and a content video component; receiving, by one or more processors, one or more audiovisual inputs captured in association with the user, the audiovisual inputs comprising a user audio component comprising audio data of the user captured during display of the real-time interactive media content and a user video component comprising one or more images of the user captured during display of the real-time interactive media content; programmatically causing, by one or more processors, the real-time interactive media content to interact with the user in real time by programmatically generating and displaying one or more audiovisual responses to the one or more audiovisual inputs, the one or more audiovisual responses including audio outputs configured to be played to the user and simulated facial expressions configured to be displayed to the user via the real-time interactive media content; applying, by one or more processors, the one or more audiovisual inputs into a multimodal performance analysis engine to generate one or more performance analysis data objects; and programmatically generating, by one or more processors, one or more visual feedback interfaces based at least in part on the one or more performance analysis data objects, the one or more visual feedback interfaces comprising programmatically generated graphical representations determined based at least in part on the one or more performance analysis data objects. In various embodiments, the multimodal performance analysis engine is trained based at least in part on contextual interaction data comprising audiovisual media of interactive engagements. In various embodiments, the multimodal performance analysis engine is trained using reinforcement learning data received from human feedback based at least in part on (a) predetermined attention criteria data indicative of at least one of one or more audio-based features or one or more video-based features to be used in generating the one or more performance analysis data objects and (b) predetermined scoring criteria data comprising one or more weights respective to the predetermined attention criteria data. In various embodiments, applying the one or more audiovisual inputs into a multimodal performance analysis engine to generate one or more performance analysis data objects comprises: generating, based at least in part on the user audio component of the one or more audiovisual inputs, one or more audio-based features, the one or more audio-based features indicative of one or more audibly detected actions associated with the user; generating, based at least in part on the user video component of the one or more audiovisual inputs, one or more video-based features, the one or more video-based features indicative of one or more visually detected actions associated with the user; and generating the one or more performance analysis data objects based at least in part on the one or more audio-based features and the one or more video-based features. In various embodiments, the computer-implemented method further comprises generating, via the multimodal performance analysis engine and based at least in part on the one or more performance analysis data objects, one or more audiovisual suggestions, wherein the programmatically generated graphical representations are based at least in part on the one or more audiovisual suggestions. In various embodiments, the programmatically generated graphical representations comprise graphical representations of the one or more audiovisual suggestions, the one or more audiovisual suggestions comprising contextual interaction data configured to be displayed to the user. In various embodiments, the one or more audiovisual responses are based at least in part on a simulated personality type and an experience rating, the experience rating associated with one or more historical performance analysis data objects associated with the user. In various embodiments, the multimodal performance analysis engine is further configured to generate a tiered sequence of real-time interactive media content comprising a recommended sequence of real-time interactive media content for the user associated with a time interval and based at least in part on one or more historical performance analysis data objects associated with the user.

Various embodiments are directed to a real-time interactive media content system comprising at least one processor and at least one memory, the at least one memory comprising computer coded instructions therein, wherein the computer coded instructions are configured to, when executed by the at least one processor, cause the system to: transmit, to a client device, real-time interactive media content, wherein the real-time interactive media content comprises at least a content audio component and a content video component, and wherein the real-time interactive media content is configured to interact with a user of the client device by displaying one or more audiovisual responses to one or more audiovisual inputs, the one or more audiovisual responses including audio outputs configured to be played to the user and simulated facial expressions configured to be displayed to the user via the real-time interactive media content; receive, from the client device, one or more audiovisual inputs comprising a user audio component comprising audio data of the user captured during display of the real-time interactive media content and a user video component comprising one or more images of the user captured during display of the real-time interactive media content; transmit, to the client device, one or more visual feedback interfaces comprising graphical representations based at least in part on one or more performance analysis data objects, the one or more performance analysis data objects determined based at least in part on the one or more audiovisual inputs.

Various embodiments are directed to a real-time interactive media content system, comprising at least one processor and at least one memory, the at least one memory comprising computer coded instructions therein, wherein the computer coded instructions are configured to, when executed by the at least one processor, cause the real-time interactive media content system to: receive one or more audiovisual inputs associated with a user, the audiovisual inputs comprising a user audio component comprising audio data of the user and a user video component comprising one or more images of the user; convert at least one of the user audio component or the user video component to one or more textual input data sets; input the one or more textual input data sets into an interaction engine configured to generate one or more contextual response data sets based at least in part on the one or more textual input data sets; and responsive to the one or more contextual response data sets, generate, via an audiovisual media content engine, one or more audiovisual responses to the one or more audiovisual inputs based at least in part on the one or more contextual response data sets, the one or more audiovisual responses including audio outputs configured to be played to the user and simulated facial expressions configured to be displayed to the user. In various embodiments, converting at least one of the user audio component or the user video component to one or more textual input data sets comprises applying a natural language processing engine to the audio component comprising audio data of the user to generate one or more transcripts associated with the user audio component. In various embodiments, the interaction engine is associated with an API, wherein inputting the one or more textual input data sets into the interaction engine comprises: formatting the one or more textual input data sets based at least in part on the API; and inputting the one or more formatted textual input data sets into the interaction engine via the API. In various embodiments, the interaction engine is configured to input the one or more contextual response data sets into the audiovisual media content engine to generate the one or more audiovisual responses. In various embodiments, the computer coded instructions are configured to, when executed by the at least one processor, further cause the real-time interactive media content system to: determine the simulated facial expressions based at least in part on the one or more contextual response data sets; and synchronize the simulated facial expressions with the audio outputs configured to be played to the user. In various embodiments, the interaction engine is trained using contextual interaction data comprising audiovisual media of interactive engagements, wherein the interaction engine is further configured to generate the contextual response data sets based at least in part on the contextual interaction data. In various embodiments, the one or more contextual response data sets are based at least in part on a simulated personality type and an experience rating, the experience rating associated with one or more historical performance analysis data objects associated with the user. In various embodiments, the computer coded instructions are configured to, when executed by the at least one processor, further cause the real-time interactive media content system to: generate one or more performance analysis data objects at least in part on the one or more audiovisual inputs associated with the user. In various embodiments, the one or more audiovisual inputs associated with a user are captured via a user device comprising at least one audio capture component and at least one video capture component. In various embodiments, the one or more contextual response data sets are based at least in part on one or more predefined answers based on contextual interaction data. In various embodiments, the interaction engine is further configured to generate the one or more contextual response data sets based at least in part on a variability parameter configured to provide variability in the interaction engine's output.

Various embodiments are directed to a computer-implemented method comprising: receiving, by one or more processors, one or more audiovisual inputs associated with a user, the audiovisual inputs comprising a user audio component comprising audio data of the user and a user video component comprising one or more images of the user; converting, by one or more processors, at least one of the user audio component or the user video component to one or more textual input data sets; inputting, by one or more processors, the one or more textual input data sets into an interaction engine configured to generate one or more contextual response data sets based at least in part on the one or more textual input data sets; and responsive to the one or more contextual response data sets, generating, by one or more processors, via an audiovisual media content engine, one or more audiovisual responses to the one or more audiovisual inputs based at least in part on the one or more contextual response data sets, the one or more audiovisual responses including audio outputs configured to be played to the user and simulated facial expressions configured to be displayed to the user. In various embodiments, converting at least one of the user audio component or the user video component to one or more textual input data sets comprises applying a natural language processing engine to the audio component comprising audio data of the user to generate one or more transcripts associated with the user audio component. In various embodiments, the interaction engine is associated with an API, wherein inputting the one or more textual input data sets into the interaction engine comprises: formatting the one or more textual input data sets based at least in part on the API; and inputting the one or more formatted textual input data sets into the interaction engine via the API. In various embodiments, the interaction engine is configured to input the one or more contextual response data sets into the audiovisual media content engine to generate the one or more audiovisual responses. In various embodiments, the audiovisual media content engine is further configured to: determine the simulated facial expressions based at least in part on the one or more contextual response data sets; and synchronize the simulated facial expressions with the audio outputs configured to be played to the user. In various embodiments, the interaction engine is trained using contextual interaction data comprising audiovisual media of interactive engagements, wherein the interaction engine is further configured to generate the contextual response data sets based at least in part on the contextual interaction data. In various embodiments, the one or more contextual response data sets are based at least in part on a simulated personality type and an experience rating, the experience rating associated with one or more historical performance analysis data objects associated with the user. In various embodiments, computer-implemented method further comprises generating one or more performance analysis data objects based at least in part on the one or more audiovisual inputs associated with the user. In various embodiments, the one or more audiovisual inputs associated with a user are captured via a user device comprising at least one audio capture device and at least one video capture device. In various embodiments, the interaction engine is further configured to generate the one or more contextual response data sets are based at least in part on one or more predefined answers based on contextual interaction data. In various embodiments, the interaction engine is further configured to generate the one or more contextual response data sets based at least in part on a variability parameter configured to provide variability in the interaction engine's output.

### BRIEF DESCRIPTION OF THE DRAWINGS

Reference will now be made to the accompanying drawings, which are not necessarily drawn to scale, and wherein:

FIG. 1 illustrates an example system environment within which at least some embodiments of the present disclosure may operate;

FIG. 2 illustrates a block diagram of an apparatus that may be specifically configured in accordance with various embodiments of the present disclosure and within which at least some embodiments of the present disclosure may operate;

FIG. 3 illustrates an example data flow diagram showing example data structures in accordance with at least some embodiments of the present disclosure;

FIG. 4 illustrates an example data flow diagram showing example data structures in accordance with at least some embodiments of the present disclosure;

FIG. 5 illustrates an example data flow diagram showing example data structures in accordance with at least some embodiments of the present disclosure;

FIG. 6 illustrates an example data flow diagram showing example data structures in accordance with at least some embodiments of the present disclosure;

FIG. 7 illustrates an example data flow diagram showing example data structures in accordance with at least some embodiments of the present disclosure.

FIG. 8 illustrates an example environment provided in accordance with at least some embodiments of the present disclosure;

FIG. 9 illustrates an example flowchart depicting operations in accordance with at least some example embodiments of the present disclosure; and

FIG. 10 an example flowchart depicting operations in accordance with at least some example embodiments of the present disclosure.

### DETAILED DESCRIPTION

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. Like numbers refer to like elements throughout. While values for dimensions of various elements may be disclosed, the drawings may not be to scale.

The words “example,” or “exemplary,” when used herein, are intended to mean “serving as an example, instance, or illustration.” Any implementation described herein as an “example” or “exemplary embodiment” is not necessarily preferred or advantageous over other implementations.

### Overview

The present disclosure includes embodiments related to generating, controlling, and providing real-time interactive media content; related to parsing audiovisual inputs and generating multimodal performance analysis. The real-time interactive media content, for example, may simulate an interactive entity configured to interact with the user to provide a simulated interaction with the user. The system may be configured to parse and analyze audiovisual inputs from a user and generate control signals to cause the interactive entity to interact with the user based on the analysis. A multimodal performance analysis engine may transform and break down the audiovisual inputs to generate performance analysis. Some example embodiments may operate as part of a vehicle provider system across a distributed network of vehicle provider locations (e.g., a distributed network served by a cloud or otherwise remote central real-time interactive media content system).

Example embodiments may cause display of real-time interactive media content to a user via a display device. For example, some embodiments, may provide at least an audio content component configured to be played to the user and a video content component configured to be displayed to the user that, together, enable a user to interact with a simulated interactive entity represented by the real-time interactive media content. Example embodiments may receive one or more audiovisual inputs captured in association with the user. For example, the one or more audiovisual inputs may include a user audio component including audio data of the user captured during display of the real-time interactive media content and a user video component including one or more images of the user captured during display of the real-time interactive media content. In some embodiments, the one or more audiovisual inputs associated with a user are captured via a user device including at least one audio capture component and at least one video capture component. In some embodiments, one or more textual input data sets may be generated based on the audiovisual inputs captured in association with the user. For example, at least one of the user audio component or the user video component may be converted to one or more textual input data sets. In some embodiments, converting a user audio component and/or user video component to one or more textual input data sets includes applying a natural language processing engine to the audio component comprising audio data of the user to generate one or more transcripts associated with the user audio component.

Example embodiments may input the one or more textual input data sets into an interaction engine. Additionally or alternatively, the one or more audiovisual inputs may be input into the interaction engine. The interaction engine may be configured to generate one or more contextual response data sets. For example, the interaction engine may generate one or more contextual response data sets based on the one or more textual input data sets. The textual response data sets may include, for example, textual data configured to provide a conversational response to the audiovisual inputs captured in association with the user. In some embodiments, the interaction engine interaction engine may be configured to generate contextual response data sets based at least in part on a variability parameter. For example, the variability parameter may be configured to provide controlled variability in the interaction engine's output such that repeated interactions with the interaction engine do not always yield the same outcomes. In some embodiments, the interaction engine may be configured to access contextual interaction data. In example embodiments, the contextual interaction data may include audiovisual data of interactive engagements. The interaction engine may generate the contextual response data sets based on the contextual interaction data. Additionally or alternatively, the interaction engine may be trained and/or fine-tuned based on the contextual interaction data. For example, in some embodiments, the one or more contextual response data sets may include one or more predefined answers based on contextual interaction data. Additionally or alternatively, the interaction engine may be associated with an API. For example, the API associated with the interaction engine may define how to input features to the interaction engine. In example embodiments, inputting the one or more textual input data sets into the interaction engine may include first formatting the one or more textual input data sets based at least in part on the API.

In some embodiments, one or more contextual response data sets may be input into an audiovisual media content engine. For example, the interaction engine may be configured to input contextual response data sets into the audiovisual media content engine. The audiovisual media engine may be configured to generate one or more audiovisual responses. For example, the audiovisual media engine may generate one or more audiovisual response based at least in part on the one or more contextual response data sets. In some embodiments, the real-time interactive media content may be programmatically caused to interact with the user in real-time by programmatically generating and display one or more audiovisual responses to the one or more audiovisual inputs. For example, the one or more audiovisual responses may include audio outputs configured to be played to the user and simulated facial expressions configured to be displayed to the user. Example embodiments may determine the simulated facial expressions based at least in part on the one or more contextual response data sets. Additionally or alternatively, example embodiments may synchronize the simulated facial expressions with the audio outputs configured to be played to the user.

In some embodiments, the audiovisual responses may be based at least in part on a simulated personality type. For example, the simulated personality type may be used to influence the simulated facial expressions, how the audiovisual responses are displayed to the user, and/or the like. Additionally or alternatively, the audiovisual responses may be based at least in part on an experience rating. For example, an experience rating may be used to influence how difficult or advanced the audiovisual responses may be. In some embodiments, the experience rating may be associated with one or more historical performance analysis data objects associated with the user. For example, the experience rating may be used to provide a user with real-time interactive media content associated with a difficulty based on one or more performance analysis data objects associated with the user's previous interactions with real-time interactive media content.

The multimodal performance analysis engine may include one or more machine learning models described herein. Additionally or alternatively, the multimodal performance analysis engine may include a behavioral analysis engine. Additionally or alternatively, the multimodal performance analysis engine may be configured to generate one or more audio-based features and/or video-based features. In some embodiments, one or more audio-based features may be generated based at least in part on the user audio component of the one or more audiovisual inputs. The one or more audio-based features may be, for example, indicative of one or more audibly detected actions associated with the user, such as, for example, a transcript of one or more words spoken by the user. In some embodiments, one or more video-based features may be generated based at least in part on the user video component of the one or more audiovisual inputs. For example, the one or more video-based features may be indicative of one or more visually detected actions associated with the user, such as, for example, a posture of the user. Example embodiments may apply the audiovisual inputs into the multimodal performance analysis engine to generate one or more performance analysis data objects. The performance analysis data objects, for example, may be based on the audio-based features and/or video-based features.

Additionally or alternatively, the one or more performance analysis data objects may be based at least in part on predetermined attention criteria data. The predetermined attention criteria data may, in some embodiments, be indicative of at least one of one or more audio-based features or one or more video-based features to be used in generating the one or more performance analysis data objects. Additionally or alternatively, the one or more performance analysis data objects may be based at least in part on predetermined scoring criteria data. The predetermined scoring criteria data may, in some embodiments, include one or more weights respective to the predetermined attention criteria data. Example embodiments may use the predetermined attention criteria data and/or predetermined scoring criteria data to, for example, control which audio-based features and/or video-based features are used in generating the performance analysis data objects and how to weight the audio-based features and/or video-based features in generating the performance analysis data objects.

Additionally or alternatively, the multimodal performance analysis engine may generate one or more audiovisual suggestions. In some embodiments, the audiovisual suggestions may be based at least in part on performance analysis data objects. The audiovisual suggestions may, for example, provide exemplary demonstrations of behaviors, interactions (e.g., verbal and/or nonverbal), and/or the like, to the user based on the user's interaction with the real-time interactive media content. For example, an audiovisual suggestion may include video data of an individual in a training program demonstrating how to conduct an interaction with a customer as a sales associate including how to behave and what to say. In some embodiments, an audiovisual suggestion may include generated data, for example, generated video and/or audio, for example, from the audiovisual media engine, demonstrating exemplary behaviors and/or interactions.

Additionally or alternatively, the multimodal performance analysis engine may generate one or more tiered sequences of real-time interactive media content. In example embodiments, the tiered sequences of real-time interactive media content may be based at least in part on performance analysis data objects. The tiered sequences of real-time interactive media content may, for example, provide a customized plan for a user to train with real-time interactive media content associated with a certain frequency for a certain time interval. Additionally or alternatively, the tiered sequences of real-time interactive media content may provide a customized plan for a user to train with real-time interactive media content associated with a certain personality type, experience rating, and/or the like.

In some embodiments, the multimodal performance analysis engine may be configured to access contextual interaction data. Additionally or alternatively, the multimodal performance analysis engine may be trained and/or fine-tuned based on the contextual interaction data. In some embodiments, the multimodal performance analysis engine may generate one or more outputs based on the contextual interaction data. For example, the performance analysis data objects, audiovisual suggestions, and/or the like may be based on or include contextual interaction data.

Example embodiments may programmatically generate one or more visual feedback interfaces based at least in part on the one or more performance analysis data objects. For example, the one or more visual feedback interfaces may include programmatically generated graphical representations configured to be displayed to the user. In some embodiments, the graphical representations may be determined based at least in part on the one or more performance analysis data objects. Additionally or alternatively, the graphical representations may be determined based at least in part on one or more audiovisual suggestions. For example, one or more graphical representations may be configured to display contextual interaction data to the user.

In some embodiments, the graphical representations may be associated with a trainee mode. For example, in the trainee mode, the graphical representations may be based on historical performance analysis data objects associated with the user. The graphical representations in the trainee mode may be configured to provide graphical representations central to the user such that the user may understand and review their performance. Additionally or alternatively the graphical representations in the trainee model may include historical performance analysis data objects associated with one or more different users such that a user may compare their performance to the one or more different users. For example, in a simulated training program, a user may wish to compare their performance to the average performance of other users in the same simulated training program.

Additionally or alternatively, the one or more graphical representations may be associated with an administrator mode. For example, in the administrator mode, the programmatically generated graphical representations may be based on a plurality of historical performance analysis data objects associated with a respective plurality of different users. The graphical representations in the administrator mode may be configured to provide graphical representations to an administrator of a simulated training program, a manager of a plurality of users, and/or the like. As such, the graphical representations in the administrator mode may be configured to provide insights into how groups of users are performing, how individuals of a group are performing, and/or the like.

Example embodiments may leverage various machine learning technologies described herein to generate real-time interactive media content to facilitate and/or provide various capabilities configured to improve simulated training and performance analysis. Embodiments described herein may receive audiovisual inputs captured in association with a user and provide audiovisual responses configured to facilitate a conversational interaction between the user and a simulated interactive entity represented by the real-time interactive media content. The system and embodiments disclosed herein may be scalable without affecting customizability or performance of the models, which improves both traditional machine learning and traditional pre-generated content systems. Accordingly, embodiments described herein provide a robust simulated training environment where users may parallelly and independently engage in real-time natural conversations that computing systems lacking such techniques cannot. For example, embodiments described herein may, in real-time, dynamically transition between generating audiovisual responses that leverage contextual interaction data (and therefore remain grounded within a certain intended context) and generating audiovisual responses independent of contextual interaction data that leverage machine learning techniques (e.g., transformer neural networks) trained to emulate natural conversation free of any constrained context. By training and/or providing contextual interaction data to the machine learning models (e.g., the interaction engine) used herein may leverage the strengths of semi structured or contextually grounded interactions to provide simulated training while simultaneously leveraging the strengths of large language models configured to excel in emulating conversational natural language.

Moreover, audiovisual responses dependent on contextual interaction data may be variable (e.g., using confidence scores to select a one of a discrete set of response options indicated from contextual interaction data, using parameters to cause variability, or combinations thereof) such that repeated interactions with real-time interactive media content yield variable results. In this manner, embodiments of the present disclosure provide technical improvements to simulated training by enabling a dynamic hybrid of interaction based on an intended context of the simulated training and freeform interaction between the user and real-time interactive media content. For example, computing systems lacking such techniques (e.g., a scripted simulated training program, a simulated training program without contextual interaction data) may be unable to intelligently respond to an input from a user that deviates from an intended context of the simulated training program or may be unable to remain contextually grounded enough to provide meaningful simulated training, thereby reducing the immersion experienced by the user and/or the quality of the simulated training. Additionally, embodiments described herein provide technical improvements to simulated training by providing systems with improved reusability compared to other systems. For example, scripted simulated training programs may be costly to generate and suffer from diminishing returns as users become accustomed to and disengaged with the limited variability inherent in such systems.

Example embodiments described herein provide technical improvements to simulated training by enabling users to visually interact with real-time interactive media content representative of a simulated interactive entity. For example, via the audiovisual media content engine, embodiments of the present disclosure enable users to see a visually displayed simulated interactive entity (e.g., a simulated human) with simulated facial expressions (e.g., visual human expressions, gestures, motions, and the like, including lip movements) configured to be contextually and semantically dependent on the interaction with the user and the simulated speech output by the simulated interactive entity. Accordingly, examples herein provide a more realistic and immersive simulated training program for users than computing systems lacking such techniques. Moreover, examples herein may provide technical improvements to simulated training by providing real-time interactive media content associated with simulated personality types and/or experience ratings. For example, via the interaction engine and/or audiovisual media content engine, embodiments herein may generate real-time interactive media content associated with various simulated personality types and/or experience ratings configured to cause the real-time interactive media content to interact with users in different personas and/or different relative difficulties such that the real-time interactive media content may provide simulated training tailored to the user to improve the efficacy, immersion, and reusability of the simulated training.

Example embodiments described herein provide technical improvements to simulated training and other content generation and delivery for certain domains, such as, for example, vehicle dealers, by providing simulated training that more accurately recreates the actual environment experienced by employees of such businesses and facilitates a distributed, dynamic, automated delivery of the real-time interactive media content (e.g., across a wide network of locations and content needs). For example, employees of vehicles dealers such as sales associates, finance and insurance (F&I) representatives, and/or the like working with cars (e.g., sedans, trucks, SUVs, etc.) and heavy trucks may face unique challenges in the workplace addressed by embodiments described herein. In some instances, such employees experience a regression in performance after initial training (e.g., in-person training with a human coach which may be time consuming and resource intensive) as the time since their training increases. Static training solutions (e.g., predetermined training modules) as well as well as training solutions that fail to provide a one-on-one experience to recreate the environment of the employee interacting with a customer do not provide the ongoing support such employees need to retain the benefits received from training. Over a distributed network of locations, scenarios, and individual modeling needs, this results in a problem that may be unsolvable by manual or analog means.

F&I representatives in particular face additional requirements as they may be involved in a post-sales price step where the F&I representative may handle financing options, contracts, paperwork, agreements, federal and/or state regulations, warranties, add-on products and/or features, and/or the like which must be incorporated into a pre-sale process of choosing an applicable product output, and as such, may utilize training and respective models that are more precise and faster than other implementations. Additionally, the F&I representative may be required to identify product/service offerings that suit the needs of a customer, be able to succinctly communicate how and why various product/service offerings suit the needs of the customer, handle objections from the customer covering a vast potential of subject matters, and/or the like, each of which may involve modeling complexity and efficiency requirements not present in other circumstances.

Moreover, a lack of routine and dynamic training and sufficient experience for sales associates, F&I representatives, and/or the like may lead to underperformance in such positions. Due to the barriers described above associated with providing training for sales associates, F&I representatives, and/or the like, providing such training may be impractical to a business and the underdevelopment of such employees may lead to high turnover. In addition to the various other technical challenges discussed herein, this underlying context raises additional technical challenges in environment with networks of numerous dealer locations and high turnover, further necessitating solutions in accordance with the various embodiments disclosed herein. Additionally, each of the numerous locations (e.g., tens, hundreds, or more) may include regional variances and/or linguistic variances that may be accounted for in model training, making traditional machine learning impractical and making pre-generated content impractical. The embodiments herein further allow training of the model to be intuitively and precisely customized by allowing custom audiovisual training inputs (e.g., preexisting or newly generated audiovisual data using human-only actors) to be made for training the models discussed herein to respond to specific input and output use cases and needs. Accordingly, example embodiments described herein may provide solutions to such deficiencies identified in training sales associates, F&I representatives, and/or the like, of vehicle dealers by providing systems configured for providing easily-accessible, dynamic, and realistic simulated training and other real-time content generation and delivery.

Example embodiments described herein provide technical improvements to performance analysis. For example, by leveraging machine learning models (e.g., the multimodal performance analysis engine) various embodiments may generate performance analysis data objects, audiovisual suggestions, tiered sequences of real-time interactive media content, and/or the like based on the performance of a user interacting with real-time interactive media content. As such, embodiments herein may provide technical improvements to performance analysis for simulated training by automating feedback processes (e.g., that might otherwise be conducted by humans, static models, and/or deterministic models), to improve the speed, accuracy, adaptability, and scalability of providing performance analysis. Some examples herein may leverage data sources rich in training program information and machine learning techniques configured to learn identifiable features and rules used to provide performance analysis. For example, the multimodal performance analysis engine may be trained on contextual interaction data including audiovisual data, scoring data, and/or the like, of training programs to learn identifiable features, including but not limited to, audio-based features and/or video-based features and rules used to automate the analysis of user's performance, and generate performance analysis data therefrom (e.g., performance analysis data objects, audiovisual suggestions, tiered sequences of real-time interactive media content). In some examples, embodiments herein may provide technical improvements to performance analysis by applying a multimodal and multilayered approach to performance analysis that enables comprehensive performance analysis including processing multimodal inputs (e.g., audiovisual inputs) to generate analyzable features (e.g., features generated by the behavioral analysis engine), applying a rules-based analysis of the features (e.g., determining if the user provided correct responses to prompted questions), and applying semantic analysis of the features (e.g., did the user express frustration, did the user have poor posture).

Example embodiments herein may provide technical improvements to performance analysis by combining the performance analysis techniques described herein with the generative machine learning techniques described herein for generating real-time interactive media content. For example, the real-time interactive media content may be configured to dynamically adapt to the user's performance and test the user via updates in real-time. For example, the real-time interactive media content may be configured to, via audiovisual responses, test a user on objection handling. As the user fails or succeeds with the object handling (e.g., as determined by the multimodal performance analysis engine), the real-time interactive media content may continue to provide more opportunities for objection handling, fewer opportunities for objection handling, opportunities for more difficult objection handing, opportunities for easier objection handling, and/or the like. In this manner, embodiments described herein may provide simulated training and performance analysis that is adaptable in real-time to a user's performance and/or behavior.

Example embodiments described herein may provide technical improvements to performance analysis by providing intelligent and contextually relevant feedback, including, in some examples, audiovisual feedback based on semantic analysis of audiovisual inputs. For example, the multimodal performance analysis engine may be configured to apply machine learning techniques (e.g., video analysis models) to identify features indicative of detected behavior of a user (e.g., a posture of the user), perform a semantic analysis of the feature to understand a contextual meaning or implication of the feature (e.g., determining the posture of the user is a poor posture), and generate or identify feedback data relevant to the feature (e.g., generating an audiovisual suggestion of good posture the user might assume).

In this manner, embodiments of the present disclosure may provide improvements to simulated training by enabling users to interact with a simulated entity (e.g., an AI simulated entity as discussed in various embodiments herein) that can respond intelligently and dynamically in real-time. For example, the real-time interactive media content may include audio output of simulated speech synchronized with video output of a simulated interactive entity including simulated facial expressions and a simulated personality. Additionally, the real-time interactive media may include audiovisual responses based on contextual interaction data to facilitate and/or provide contextually relevant, semi-guided interactions. Additionally, example embodiments may leverage various data associated with a user interacting with real-time interactive media content to generate various data objects and graphical representations based thereon to provide various insights as well as facilitate and/or provide various capabilities configured to improve performance analysis for simulated training. For example, the multimodal performance analysis engine may generate performance analysis data objects, audiovisual suggestions, tiered sequences of real-time interactive media content, and/or the like to provide, in combination with the graphical representations, detailed performance feedback, performance improvement recommendations such as areas of opportunities for improvement, exemplary demonstrations, training plans, and/or the like tailored for a user. Additionally, the graphical representations may be configured to provide feedback to a user interacting with real-time interactive media content or a user managing one or more individuals interacting with real-time interactive media content.

Embodiments of the present disclosure may be used in a plurality of domains, applications, environments, and/or architecture and not limited to any specific domain, application, environment, and/or architecture. For example, in an example domain where the users in simulated training with the real-time interactive media content are sales associates, F&I representatives, and/or the like in a sales training program, example embodiments, using techniques discussed herein, may assess performance of the sales associates, F&I representatives, and/or the like within the simulated training program with respect to a plurality of parameters such as a user's ability to provide explanations of products and/or services, warranties, legal disclosures, costs and benefits, and/or financing options; provide peer to peer comparison rankings; provide customized performance improvement recommendations; leverage weighted performance metrics to identify areas of opportunities across various behavioral characteristics; leverage training recommendations and projections; perform dynamic benchmarking using industry data; leverage peer to peer comparison rankings to facilitate recognition and awards-based systems, manage training program enrollment; facilitate and/or provide digital optimization, facilitate development of new training programs; analyze cross comparisons between different training groups, methods, techniques and/or audiovisual content; track and analyze post-training user behavior (e.g., insights on how training impacts sales associates', F&I representatives', and/or the like user's ratings, reviews, sales, etc.); create training content based on identified areas of improvement personalized to match sales associates', F&I representatives', and/or the like user's learning style in order to maximize training efficiency; and the like.

Various technical improvements will be appreciated from the present disclosure. For example, example embodiments of the present disclosure cause display of real-time interactive media content to a user, receive audiovisual input data captured in association with a user, generate audiovisual responses to the audiovisual inputs that cause or otherwise facilitate the real-time interactive media content to interact with the user, generate performance analysis data objects, audiovisual suggestions, and/or tiered sequences of real-time interactive media content based on the user's interaction with the real-time interactive media content, and provide graphical representations based on at least one of the performance analysis data objects, audiovisual suggestions, and/or tiered sequences of real-time interactive media content, to be displayed to the user. The embodiments described herein are able to provide contextually relevant and dynamic interactive media content to a user and generate performance analysis outputs based thereon. In this regard, embodiments of the present disclosure improve the technological field of simulated training and performance data analysis at least by providing real-time interactive media content and graphical representations that are accessible to users via a display device which obviates the need for users to, for example, travel to a physical location providing a training program with professional human trainers. This, in turn, reduces human resources, friction, and access barriers associated with receiving professional training and standardizes and expediates performance review processes. Embodiments of the present disclosure further provide technical improvements by leveraging trained machine learning models and specially configured framework to generate real-time interactive media content including a simulated interactive entity that provides users with a simulated training experience that is more engaging and realistic than conventional methods, relevant insights from performance analysis models, and a contextually guided interaction based on pools of data (e.g., contextual interaction data).

Embodiments of the present disclosure further provide technical improvements in the field of graphical user interfaces by at least (i) providing for visualization of a dynamically contextually guided interactive simulated entity able to provide simulated training to a user, and/or (ii) providing for visualization of performance insights tailored to the user in an efficient manner via graphical representations in a user interface of an application platform (e.g., mobile application platform, web application platform, or the like),. Embodiments of the present disclosure further provide technical improvements in the field of graphical user interfaces by providing communication interface elements in a user interface which, with the aforementioned systems and processes, allow for interaction and performance analysis between users and the real-time interactive media content. Furthermore, by providing performance analysis data objects as described above, embodiments of the present disclosure facilitate various capabilities including performance analysis improvement of simulated training systems.

### Definitions

As used herein, the terms “data,” “content,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

As used herein, the term “circuitry” refers to particular hardware configured to perform the functions associated with the particular circuitry as described herein. In some embodiments, circuitry may be used as part of (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. In some embodiments, “circuitry” may include processing circuitry, storage media, network interfaces, input/output devices, and/or the like. As a further example, as used herein, the term “circuitry” also includes an implementation comprising one or more processors and/or portion(s) thereof and accompanying software and/or firmware. As another example, the term “circuitry” as used herein also includes, for example, a baseband integrated circuit or applications processor integrated circuit for a mobile phone or a similar integrated circuit in a server, a cellular network device, other network device, and/or other computing device.

As used herein, a “computer-readable storage medium,” refers to a physical storage medium (e.g., volatile, or non-volatile memory device), and may be differentiated from a “computer-readable transmission medium,” which refers to an electromagnetic signal.

As used herein, the terms “data structure,” “data object,” or “data set” refer interchangeably to data capable of being transmitted, received, and/or stored.

As used herein, the term “machine learning model” refers to one or more processes, algorithms, and/or other data entity that describes parameters, hyper-parameters, defined operations, and/or defined mappings of a model that is configured to process one or more inputs in accordance with one or more trained parameters of the machine learning models in order to generate a prediction. An example of a machine learning model is a mathematically derived algorithm (MDA). An MDA may comprise any algorithm trained using training data to predict one or more outcome variables. Without limitation, an MDA, as used herein, may comprise machine learning frameworks including neural networks, diffusion models, generative adversarial networks, convolutional neural networks, recurrent neural networks, text-to-video models, video-to-text models, text-to-speech models, speech-to-text models, large language models, generative pre-trained transformers (GPT), support vector machines, gradient boosts, Markov models, adaptive Bayesian techniques, and statistical models (e.g., timeseries-based forecast models such as autoregressive models, autoregressive moving average models, and/or an autoregressive integrating moving average models). Additionally, and without limitation, an MDA, as used in the singular, may include ensembles using multiple machine learning and/or statistical techniques.

As used herein, the term “generative artificial intelligence model” refers to one or more artificial intelligence models, including but not limited to some example machine learning models, configured to generate new outputs in response to a prompt or other input data. In some embodiments, the generative artificial intelligence model may include any type of model configured, trained, and/or the like to generate a natural language text, images, video, widgets, or the like in response to a prompt. For example, the generative artificial intelligence model may include a large language model such as a GPT model.

As used herein, the term “contextual interaction data” refers to a data entity or collection of data entities associated with one or more interactive entities. In some examples, contextual interaction data may comprise one data object, a data set, a database, a data repository, and/or the like. In some examples, contextual interaction data may include audiovisual data, image data, numerical data, and/or textual data. In some examples, contextual interaction data may include historical data, ongoing data, recorded data, generated data, and/or the like. In some examples, contextual interaction data may include data (e.g., audiovisual data) of one or more interactive entities such as, for example, one or more humans. For example, contextual interaction data may include data (e.g., audiovisual data) of one or more humans speaking, performing actions, interacting, and/or the like. In some examples, contextual interaction data may include data associated with and indicative of humans interacting within a particular context. In some examples, contextual interaction data may include data (e.g., audiovisual data, annotated audiovisual data, textual data, numerical data) for reviewing, scoring, and/or providing feedback to humans interacting within a particular context. Contextual interaction data may include data (e.g., audiovisual data) of humans interacting within a training program, humans interacting within a workplace, humans performing demonstrations (e.g., performing exemplary interactions such as objection handling), a human interacting with real-time interactive media content, and/or the like. In some examples, contextual interaction data may include or otherwise be associated with a label, indicator, identifier, and/or the like, to indicate a purpose and/or type of contextual interaction data. For example, contextual interaction data may be labelled as training data, historical interaction data, video data, image data, textual data, and/or the like. In some examples, contextual interaction data may include data for training machine learning models. For example, contextual interaction data may include data (e.g., audiovisual data of humans interacting) and corresponding annotations, scores, metadata, and/or the like used for machine learning training (e.g., data indicative of whether the interaction data is an example of a good interaction or an example of a bad interaction). Accordingly, contextual interaction data may be used to train machine learning models (e.g., the multimodal performance analysis engine), provide data to machine learning models (e.g., provide contextual interaction data sets, portions thereof, and/or data used to generate or control contextual interaction data sets, to the interaction engine), store data of users interacting with real-time interactive media content (e.g., record and store a user's interaction with real-time interactive media content), and/or the like.

In a non-limiting example, contextual interaction data may include data (e.g., audiovisual data or data associated with or based on such audiovisual data) of a sales associate, F&I representative, and/or the like in a sales negotiation, a customer shopping, a client in a business interaction, an employee performing a work task, a sales process demonstration, a customer service scenario, a product demo, a conflict resolution, a leadership demo, a team management demo, a compliance and ethics training session, a sales training session, a safety procedure demo, and/or the like. Additionally or alternatively, contextual interaction data may include one or more segments of audio and/or video of a training program (e.g., a vehicle sales training program). Additionally or alternatively, contextual interaction data may include video data, audio data, textual data, and/or numerical data of trainers reviewing, scoring, and/or giving feedback to participants of a training program, and/or the like. As used herein, the terms “training program,” “simulated training program,”and/or the like may be used interchangeably.

As used herein, the term “audio component” refers to a data entity that includes audio data, an audio data stream, portion thereof, and/or the like. An audio component may be extracted or otherwise separated from audiovisual data or may refer to an integral audio portion of audiovisual data. In some examples, an audio component may include audio data captured by one or more audio capture components. For example, an audio component may include audio data captured by a microphone of a user during interaction with real-time interactive media content. In some examples, an audio component may include generated audio data. For example, an audio component may include audio data generated by one or more generative machine learning models, text-to-speech models, the audiovisual media content engine, the multimodal performance analysis engine, and/or the like. In some examples, an audio component may be associated with a user (e.g., recorded audio of a user) and optionally be referred to as a “user audio component.” In some examples, an audio component may be associated with real-time interactive media (e.g., an audiovisual response) and optionally be referred to as a “content audio component.” In some examples, an audio component may include stored audio data (e.g., audio data stored in a data base), transmitted audio data (e.g., audio data received over a network), ongoing audio data (e.g., audio data being captured in real-time), and/or the like. For example, an audio component may refer to audio data of historical audio retrieved from a database or audio data of real-time interactive media content. In some examples, an audio component may be associated with a video component. For example, real-time interactive media content, audiovisual inputs, audiovisual responses, audiovisual suggestions, contextual interaction data, and/or the like, may include one or more audio components and/or one or more associated video components. As used herein, the terms “audio component,” “audio,” and “audio data” may be used interchangeably. As used herein, the term “audio capture component” refers to any device including one or more sensors configured for capturing audio by converting sound into one or more electrical signals (e.g., a microphone).

As used herein, the term “video component” refers to a data entity that includes video data, a video data stream, portion thereof, and/or the like. A video component may be extracted or otherwise separated from audiovisual data or may refer to an integral video portion of audiovisual data. A video component may be made up of one or more images represented by image data. In some examples, a video component may include video data captured by one or more video capture components (e.g., cameras). For example, a video component may include video data captured by a camera of a user interacting with real-time interactive media content. In some examples, a video component may include generated video data. For example, a video component may include video data generated by one or more generative machine learning models, an animation pipeline, the audiovisual media content engine, and/or the like. In some examples, a video component may be associated with a user (e.g., recorded video of a user) and optionally be referred to as a “user video component.” In some examples, a video component may be associated with real-time interactive media (e.g., an audiovisual response) and optionally be referred to as a “content video component.” In some examples, a video component may include stored video data (e.g., video data stored in a data base), transmitted video data (e.g., video data received over a network), ongoing video data (e.g., video data being captured in real-time), and/or the like. For example, a video component may refer to video data of historical video retrieved from a database or video data of real-time interactive media content. In some examples, a video component may be associated with an audio component. For example, real-time interactive media content, audiovisual inputs, audiovisual responses, audiovisual suggestions, contextual interaction data, and/or the like, may include one or more video components and/or one or more associated audio components. As used herein, the terms “video component”, “video,” and “video data” may be used interchangeably and/or may implicitly include reference to an audio component, audio and/or audio data. For example, a camera capturing video will often capture audio simultaneously and as such, video data may implicitly include audio data. As used herein, the term “video capture component” refers to any device including one or more sensors configured for capturing video by converting light into one or more electrical signals.

As used herein, the term “audiovisual input” refers to a data entity that includes one or more audio components and/or video components. For example, an audiovisual input may include audio data and/or video data of a user interacting with real-time interactive media content. In some examples, an audiovisual input may be associated with a user, real-time interactive media content, one or more audio processing operations, video processing operations, the interaction engine, the multimodal performance analysis engine, and/or the like. In some examples, an audiovisual input may be converted into one or more textual input data sets. For example, an audiovisual input may be input into one or more machine learning models configured to output one or more textual input data sets based on the audiovisual input. In some examples, an audiovisual input may be captured by any type of input devices, including but not limited to one or more audio capture component and/or video capture component such as, for example, a camera, microphone, webcam, smartphone, tablet, conference recording device, and/or the like.

As used herein, the term “textual input data set” refers to a data entity comprising text strings or any other textual data. In some embodiments, a textual input data set may be based on one or more audiovisual inputs. In some examples, a textual input data set may include textual data descriptive of one or more audiovisual inputs. In some examples, a textual input data set may include a transcript of a user's speech, or a portion thereof, captured by an input device. In some examples, a textual input data set may include a transcript of a user's speech, or a portion thereof. In some examples, the textual input data may be associated with and/or stored within contextual interaction data. In some examples, a textual input data set may include textual data representative of one or more transformations and/or analyses based on one or more audio components and/or video components of an audiovisual input. For example, a textual input data set may include one or more transcriptions, descriptive measures, semantic measures, and/or the like. In some examples, a textual input data set may be generated by a speech-to-text model and/or a video-to-text model. Additionally or alternatively, a textual input data set may include descriptive or semantic data such as, for example, a word count, verbosity measure, vocal frequency measure, tonal analysis, emotional recognition, speaking duration data, speaker diarisation data, accent classification, language identification, and/or the like. Additionally or alternatively, a textual input data set may include descriptive or semantic data such as, for example, positional data, posture data, facial expression data, eye movement data, gesture data, and/or the like. Additionally or alternatively, a transcript of a textual input data set based on an audio component may be further based on or informed by a video component via one or more computer vision techniques such as, for example, detecting lip movement, mouth movement, speaker diarisation, and/or the like. In some embodiments, a textual input data set may be input to an interaction engine. For example, a textual input data set may be input into an interaction engine to output one or more contextual response data sets. In some examples, a textual input data set may be configured in accordance with an API associated with the interaction engine. For example, a textual input data set may be formatted based on an API associated with the interaction engine.

As used herein, the term “real-time interactive media content” refers to a data entity generated by, controlled by, or otherwise associated with an audiovisual media content engine and associated with a simulated interactive entity. In some examples, real-time interactive media content may include or otherwise be associated with one or more audio components and/or video components associated with a simulated interactive entity (e.g., a digital human configured to interact with the user). Additionally or alternatively, real-time interactive media content may include or otherwise be associated with one or more audiovisual responses (e.g., computed responses configured to be output via the simulated interactive entity). Additionally or alternatively, real-time interactive media content may include or otherwise be associated with one or more audiovisual inputs, textual input data sets, contextual response data sets, the interaction engine, a simulated personality type, an experience rating, and/or the like. For example, real-time interactive media content may output audio and video configured to output the sound and display the appearance of a simulated interactive entity. In some examples, real-time interactive media content may output the voice and appearance of a simulated human, or any other simulated interactive entity, to be dynamic, active, and reactive to a user interacting with the real-time interactive media content. For example, real-time interactive media content may enable a user to interact with (e.g., see and speak with) a simulated human. In some embodiments, real-time interactive media content may include or otherwise be associated with simulated facial expressions, simulated behaviors, simulated speech, and/or the like generated by an audiovisual media content engine and configured to be output via the user device to the user. For example, real-time interactive media content of a simulated, digital human may visually display the simulated human performing actions such as interacting with a virtual environment surrounding the simulated human, reacting to a user, making simulated facial expressions, simulated behaviors, simulated speech, and/or the like. Additionally, the real-time interactive media content of a simulated human may output audio such as the simulated human's speech, sounds caused by movements or interactions of the simulated human, sounds from a virtual environment associated with the simulated human, and/or the like.

In some embodiments, real-time interactive media content may be configured to simulate an interaction with a user associated with a particular context. For example, real-time interactive media content may be configured to train a user for a specific goal or skill, expose a user to a simulated event, situation, environment, experience, interaction and/or the like. In some examples, real-time interactive media content may be configured to simulate a customer, client, employee, coworker, associate, and/or the like to train a user for specific contexts and/or interactions. Non-limiting examples of real-time interactive media content include simulating a customer shopping in a dealership such that a user may train as a vehicle sales associate, F&I representative, and/or the like, a person in their home such that a user may train as a door-to-door sales associate, a client in a networking event such that a user may train networking skills, a customer needing technical support such that a user may train as a support technician, and/or the like. The real-time interactive media content may be generated via a series of algorithms that select or newly generate (e.g., via transformer neural network) the visual appearance (e.g., video component representative of the simulated entity) and/or corresponding sound (e.g., audio component synchronized with the video component) or specific modifications or outputs associated with an existing visual appearance and/or sound (e.g., audiovisual responses) to simulate a person interacting with the user. The real-time interactive media content may be generated continuously in response to audiovisual inputs associated with the user and/or may include sequentially generated sections of content generated in response to specific audiovisual inputs (e.g., responses to user questions).

In a non-limiting example, a user may initiate an interaction with (e.g., speak to) real-time interactive media content. The user's interaction with the real-time interactive media content may cause the generation of one or more audiovisual inputs descriptive of the user's interaction via one or more input devices. The one or more audiovisual inputs may in turn cause the generation of one or more textual input data sets, contextual response data sets, audiovisual responses, audiovisual suggestions, performance analysis data objects, tiered sequences of real-time interactive media content, and/or the like. The one or more audiovisual responses may be configured to provide a contextually relevant response to the user's interaction with the real-time interactive media content. The one or more audiovisual responses may be provided to the user such that the output causes the user to hear and see a simulated interactive entity responding to the user in a contextually relevant manner in real-time via the aforementioned processes. This may prompt or allow the user to further interact with the real-time interactive media content by responding to the one or more audiovisual responses, which may again cause the generation of one or more audiovisual inputs. In this manner, a real-time interaction loop between the user and the real-time interactive media content may be facilitated.

As used herein, the term “audiovisual media content engine” refers to one or more processes, algorithms, and/or other data entity that describes parameters, hyper-parameters, and/or defined operations of a rules-based algorithm and/or machine learning model (e.g., model including at least one or more rule-based layers, one or more layers that depend on trained parameters, coefficients, and/or the like), and/or the like configured to generate, control, or otherwise facilitate real-time interactive media content. In some examples, the audiovisual media content engine may be configured to generate real-time interactive media content, one or more audiovisual responses, one or more audiovisual suggestions, and/or the like. A trained audiovisual media content engine may include artificial intelligence algorithms and techniques, including machine learning, trained using one or more training data sets. A trained audiovisual media content engine may be configured, trained, and/or the like to generate one or more audio components and/or one or more video components based on one or more contextual response data sets. For example, a trained audiovisual media content engine may be configured, trained, and/or the like to receive one or more contextual response data sets, analyze the one or more contextual response data sets, and output real-time interactive media content and/or one or more audiovisual responses based on the analysis of the one or more contextual response data sets. A trained audiovisual media content engine may include one or more of any type of machine learning models including one or more supervised, unsupervised, semi-supervised, reinforcement learning models, one or more of any type of 2D modeling, 3D modeling, virtual reality modeling, augmented reality modeling, animation pipelines, one or more of any type of computer vision models, text-to-speech models, speech-to-text models, video-to-text models, text-to-video models, natural language processing models, and/or the like. In some examples, a trained audiovisual media content engine may include a generative artificial intelligence model, an artificial neural network, or the like, such as a transformer model or other neural network or deep learning model. In some examples, the audiovisual media content engine may be configured to directly generate real-time interactive media content. In some examples, the audiovisual media content engine may be configured to perform one or more processes (e.g., generating, transmitting, receiving, and/or the like, audio data, video data, instructions, and/or the like) at one or more remote servers, user devices, or combinations thereof.

In some embodiments, the audiovisual media content engine may be configured to generate real-time interactive media content based at least in part on a simulated personality type. For example, the audiovisual media content engine may be configured to select and/or use one or more models associated with a simulated personality type. Alternatively, the audiovisual media content engine may be configured to modify one or more outputs based on a simulated personality type (as described in greater detail below). Accordingly, a simulated personality type may influence the output of the audiovisual media content engine such as, for example, audiovisual responses and real-time interactive media content. For example, given the same audiovisual input, the audiovisual media content engine may generate different audiovisual responses based on different simulated personality types. In this manner, a simulated personality type may be used to alter the experiences of a user interacting with real-time interactive media content. For example, the audiovisual media content engine may be trained to map one or more contextual response data sets into one or more audiovisual responses configured to output audio and/or video of a simulated interactive entity based at least in part on a simulated personality type. For example, real-time interactive media content may not only be able to simulate a customer shopping in a dealership, and real-time interactive media content may be able to simulate a happy customer, a sad customer, an annoyed customer, a patient customer, an impatient customer, an easy-going customer, a difficult customer, and/or the like, shopping in a dealership.

As used herein, the term “audiovisual response” refers to a data entity including one or more audio components and/or video components or data configured to be processed to generate such audio components and/or video components and generated by an audiovisual media content engine based on one or more contextual response data sets. An audiovisual response may define an audio component and/or video component configured to be output to a user via a real-time interactive media content in response to an audiovisual input (e.g., a simulated entity represented by the real-time interactive video content responding to an audiovisual input captured in association with the user). For example, an audiovisual response may include audio data and/or video data generated by an audiovisual media content engine based on one or more contextual response data sets and in response to an audiovisual input. In some examples, an audiovisual response may include or otherwise be associated with one or more simulated facial expressions, simulated behaviors, simulated speech, and/or the like. In this manner, one or more audiovisual responses may emulate or otherwise cause a simulated human of real-time interactive media content to emulate a human conversationally interacting with a user. In some examples, an audiovisual response may include audio to be output based on a contextual response data set. For example, an audio component of an audiovisual response may include simulated speech based on a contextual response data set that is output to the user device to render video components of the simulated speech on the screen of the user device and play audio components of the simulated speech through one or more speakers associated with the user device. In an example, audio of an audiovisual response may be output by inputting a contextual response data set into a text-to-speech model of the audiovisual media content engine. In some embodiments, an audiovisual response may include video to be displayed based on a contextual response data set. For example, a video component of an audiovisual response may include video of a simulated interactive entity based on a contextual response data set. In an example, video of an audiovisual response may be displayed by inputting a contextual response data set into a text-to-video model of the audiovisual media content engine. In some examples, an audiovisual response may be configured to provide a response or otherwise cause real-time interactive media content to provide a response to a user interacting with real-time interactive media content. In some examples, an audiovisual response may include synchronized audio data and video data.

As used herein, the term “simulated facial expressions,” “simulated behaviors,” “simulated speech,” and/or the like, refers to emulations associated with a simulated interactive entity configured to be represented by real-time interactive media content. For example, simulated facial expressions may be visible changes configured to cause a simulated human to emulate real human facial expressions such as, for example, moving lips, mouth, eyes, eyebrows, forehead, cheeks, and/or the like, to mimic speaking, express smiling, frowning, laughing, concern, discomfort, frustration, anger, happiness, confusion, anticipation, and/or the like. Such simulations may be outputs of a trained machine learning model (e.g., via the audiovisual media content engine) that define at least a portion of an audiovisual response. In another example, simulated behaviors may be visible changes configured to cause a simulated human to emulate real human behaviors such as, for example, moving one's hands, arms, feet, legs, body, head, and/or the like to interact with a virtual environment, interact with a user, express mood, gestures, postures, stances, changing to or from sitting, standing, walking, and/or the like. In another example, simulated speech may be audio data configured to cause a simulated human to output audible speech.

As used herein, the term “simulated personality type” refers to a data entity configured to generate, modify, control, or otherwise cause real-time interactive media content to emulate one or more facets of a particular real human personality type. For example, a simulated personality type may include or otherwise be associated with one or more learned weights and/or parameters of one or more machine learning models (e.g., transformer models, 3D models). Additionally or alternatively, a simulated personality type may include or otherwise be associated with recorded data (e.g., data of a motion capture system, audiovisual data), manually provided data (e.g., textual prompts input to a generative machine learning model), inputs, parameters, and/or the like of one or more models (e.g., machine learning models, 3D models, and/or the like). In some examples, a simulated personality type may include an identifier, label, and/or the like and be defined by one or more pretrained models configured to collectively cause real-time interactive media content to emulate a particular personality type. For example, the selection and execution of one or more models (e.g., interaction engine, audiovisual media content engine) associated with a common simulated personality type may facilitate the generation of real-time interactive media content configured to emulate a particular personality type. In some examples, a simulated personality type may include data (e.g., pretrained weights of a machine learning model, parameters of a 3D model, prompts to a generative machine learning model, and/or the like) and be applied to or used by one or more models (e.g., interaction engine, audiovisual media content engine) to generate, modify, control, or otherwise cause outputs to align with the simulated personality type. In one example, a simulated personality type may be associated with one or more models trained using a subset of contextual interaction data determined by a sentiment analysis engine as defining an anger type sentiment such that the trained one or more models may be configured to generate real-time interactive media content, or portions thereof, representative of a simulated interactive entity expressing anger in accordance with the simulated personality type. In another example, a simulated personality type may include one or more textual prompts provided to the interaction engine configured to cause the interaction engine to output contextual response data sets in accordance with the simulated personality type such as, for example, contextual response data sets that are modified to be representative of angry speech as determined by a sentimental analysis by the interaction engine. In yet another example, a simulated personality type may include one or more weights and/or parameters associated with one or more sentiment types configured to cause the audiovisual media content engine to generate output in accordance with the simulated personality type such as, for example, one or more weights and/or parameters associated with an anger sentiment type configured to cause one or more 3D models of the audiovisual media content engine to output real-time interactive media content representative of a simulated interactive entity expressing anger. In various embodiments, one or more repositories and/or libraries may be used to store and catalog various models, parameters, and/or any other data associated with a simulated personality type. In this manner, a stored simulated personality type may be retrieved when configuring real-time interactive media content.

In some embodiments, a simulated personality type may include or otherwise be associated with one or more semantic predispositions that influence how the simulated human looks, acts, speaks, and/or the like. For example, a simulated personality type may include one or more values associated with one or more temperaments such as, for example, kindness, happiness, sadness, anxiousness, excitedness, calmness, confidence, boredom, curiosity, combativeness, stubbornness, emotional sensitivity, and/or the like. A simulated personality type may include or otherwise be associated with one or more simulated facial expressions, simulated behaviors, simulated speech, audiovisual responses, experience ratings, and/or the like. For example, a simulated human may have a simulated personality type generally associated with being angry and impatient. Accordingly, that simulated human may include or otherwise be associated with simulated facial expressions, simulated behaviors, simulated speech, and/or the like that is associated with being angry and impatient, such as, for example, frowning, a furrowed brow, crossed arms, pacing movement, aggressive posturing, elevated speech (e.g., shouting), quickened speech (e.g., speaking fast), shortened speech (e.g., speaking briefly), interjecting speech (e.g., speaking at the same time as the user), and/or the like. In another example, a simulated human may have a simulated personality type generally associated with being kind and indecisive. Accordingly, that simulated human may include or otherwise be associated with simulated facial expressions, simulated behaviors, simulated speech, and/or the like that is associated with being kind and indecisive, such as, for example, smiling, being attentive, being relaxed, normal speech (e.g., not shouting), inquisitive speech (e.g., asking many questions), and/or the like.

As used herein, the term “experience rating” refers to a data entity defining a programmatic weight generated in association with a user (e.g., a user experience score) and/or in association with one or more portions of a real-time interactive media content system (e.g., a difficulty score). In some embodiments, the experience rating may be configured to be applied to one or more features of the real-time interactive media content system to scale or otherwise affect the nature of the real-time interactive media content's interaction with the user. For example, the experience rating may be configured to control one or more parameters associated with real-time interactive media content and associated with one or more performance analysis data objects. In some examples, an experience rating may be associated with (e.g., an input associated with) real-time interactive media content, audiovisual responses, performance analysis data objects, tiered sequences of real-time interactive media content, and/or the like. For example, an experience rating may be used to control audiovisual responses, simulated personality types, the multimodal performance analysis engine, the interaction engine, and/or the like. In some examples, an experience rating may be a score associated with an intended difficulty associated with real-time interactive media content. For example, real-time interactive media content intended to be difficult to interact with may be associated with a corresponding experience rating, audiovisual responses, and/or simulated personality type. In some embodiments, an experience rating may be assigned to one or more pre-generated models associated with real-time interactive media content and/or the experience rating may be input to the training process for one or more models to generate real-time interactive media content having a predetermined difficulty. In a non-limiting example, real-time interactive media content intended to be difficult, as indicated by an experience rating, may include or otherwise be associated with audiovisual responses configured to interrupt a user while speaking, ask many questions to a user, simulate frustration, impatience, anger, object to statements made by the user, and/or otherwise make interaction more difficult for the user. In another non-limiting example, real-time interactive media content not intended to be difficult, as indicated by an experience rating, may include or otherwise be associated with audiovisual responses configured to simulate speaking in turn with the user, ask few and simple questions to the user, simulate friendliness, agree with statements made by the user, and/or otherwise make interaction easier for the user.

In some embodiments, an experience rating may be based at least in part on one or more performance analysis data objects associated with the user. For example, a user associated with few performance analysis data objects, a user associated with analysis data objects indicative of poor performance, such as a lower score relative to other users, or the like (e.g., a user with little experience) may be provided real-time interactive media content with an experience rating configured to make interactions with the real-time interactive media content simpler or easier. In some examples, as a user gains experience (e.g., a user associated with many performance analysis data objects, a user associated with performance analysis data objects indicative of good performance) the user may be provided real-time interactive media content with an experience rating configured to make interactions with the real-time interactive media relatively more difficult or challenging.

As used herein, the term “multimodal performance analysis engine” refers to a data entity configured generate one or more performance analysis data objects based at least in part on one or more audiovisual inputs. In some examples, the multimodal performance analysis engine may be configured to receive one or more audiovisual inputs, analyze one or more audio components and/or video components associated with the one or more audiovisual inputs, generate one or more features based on the analysis, and generate one or more performance analysis data objects based on the one or more features. Additionally or alternatively, the multimodal performance analysis engine may be configured to generate one or more performance analysis data objects based on real-time interactive media content, textual input data sets, simulated personality types, experience ratings, audiovisual responses, predetermined attention criteria, predetermined scoring criteria, and/or the like. In some examples, the multimodal performance analysis engine may be configured to generate one or more performance analysis data objects for a user interacting with real-time interactive media content. In some examples, the multimodal performance analysis engine may be configured to generate one or more audiovisual suggestions, tiered sequences of real-time interactive media content, and/or the like.

In some embodiments, the multimodal performance analysis engine may include one or more of any type of machine learning models including one or more supervised, unsupervised, semi-supervised, reinforcement learning models, one or more of any type of computer vision models, video analysis models, audio analysis models, text-to-speech models, speech-to-text models, text-to-video models, video-to-text models, natural language processing models, statistical models, custom models, and/or the like. In some examples, a multimodal performance analysis engine may include a generative artificial intelligence model (e.g., an artificial neural network) and/or the like. In some examples, the multimodal performance analysis engine may include or otherwise be associated with a behavioral analysis engine configured to perform one or more data processing operations, audio processing operations, video processing operations, statistical analyses, semantic analyses, and/or the like. The behavioral analysis engine may be configured to generate features descriptive or indicative of a user's behaviors including, for example, the speech and physical movements or mannerisms of a user. Examples of features include, but are not limited to, audio-based features and video-based features. In some examples, the multimodal performance analysis engine may include or otherwise be associated with one or more audio analysis models configured to generate one or more audio-based features; one or more video analysis models configured to generate one or more video-based features; one or more rules analysis models configured to learn (e.g., from contextual interaction data) and/or apply one or more rules to one or more features (e.g., apply one or more rules to one or more audio-based features, video-based features, and/or other features); and/or any other type of model configured to generate features used in performance analysis.

The multimodal performance analysis engine may comprise a plurality of components or models configured to sequentially or parallelly process audiovisual data (e.g., including but not limited to one or more data cleaning processes, one or more data transformation processes such as speech-to-text engines, one or more data segmentation processes, one or more analytical models, and/or one or more output or rendering processes). In some examples, the multimodal performance analysis engine may include one or more models where each model is configured to generate one type of feature (e.g., an audio-based feature or video-based feature). For example, the multimodal performance analysis engine may include one video analysis model configured to generate one respective video-based feature (e.g., lip movement features). In some examples, the multimodal performance analysis engine may include one or more models where each model is configured to generate one or more types of features. For example, the multimodal performance analysis engine may include a plurality of video analysis models each configured to generate a plurality of video-based features (e.g., lip movement features and eye movement features). In some embodiments, the multimodal performance analysis engine may include a layered analysis framework whereby individual analyses are combined to generate cumulative scores and analyses (e.g., lip movement features and eye movement features may be combined to generate a facial movement feature score). In some embodiments, the multimodal performance analysis engine may include a plurality of overlapping, separate analyses and models (e.g., a lip movement analysis and an independent facial movement analysis via different models).

In some embodiments, the multimodal performance analysis engine may be associated with contextual interaction data. For example, the multimodal performance analysis engine may be trained and/or fine-tuned using, have access to, query from, and/or the like, contextual interaction data. For example, the multimodal performance analysis engine may be trained on contextual interaction data and automatically learn to identify important features (e.g., using one or more models configured for audiovisual analysis, text-based analysis, and/or the like) from the contextual interaction data and apply one or more rules (e.g., using one or more rules analysis models) to the one or more features. In one example, the multimodal performance analysis engine may be trained on contextual interaction data including audiovisual data of individuals interacting in a training program where the audiovisual data may be manually revised and/or labelled by a human annotator (e.g., a subject matter expert) to, for example, indicate whether the audiovisual data includes an example of a good interaction or a bad interaction, which features within the audiovisual data are indicative of good interactions or bad interactions, scores associated with features within the audiovisual data, data defining particular answers to particular questions and corresponding rank scores assigned to the particular answers, and/or the like.

In some embodiments, the multimodal performance analysis engine may be trained and/or fine-tuned using predetermined attention criteria data and/or predetermined scoring criteria data during reinforcement learning from human feedback. For example, the multimodal performance analysis engine may be aligned with human preferences during training in a reinforcement learning from human feedback technique where a reward model is trained using predetermined attention criteria data and/or predetermined scoring criteria data (e.g., direct human feedback data from annotators associated with model output) to guide the multimodal performance analysis engine. In some examples, predetermined attention criteria data may be optionally used to indicate particular features (e.g., audio-based features and/or video-based features) to be included and/or excluded from one or more processes. For example, the multimodal performance analysis engine may use predetermined attention criteria data to include and/or exclude select features to be generated and/or used in generating performance analysis data objects. For example, predetermined attention criteria data may define a video-based feature such as facial expressions and cause the multimodal performance analysis engine to not detect facial expressions of a user and/or use facial expressions of a user in generating performance analysis data objects. In another example, predetermined attention criteria data may define one or more terms and cause the multimodal performance analysis engine to detect whether a user said the one or more terms. Predetermined attention criteria data and/or predetermined scoring criteria data may be provided manually to the multimodal performance analysis engine to optionally alter the multimodal performance analysis engine and/or performance analysis data objects (e.g., to tailor how or which features, rules, and/or scores are used in performance analysis). For example, one or more outputs or intermediate outputs of the multimodal performance analysis engine (e.g., one or more features or performance analysis data objects) may be manually revised and/or labelled by a human annotator, such as a subject matter expert to, for example, indicate whether the outputs were generated correctly or incorrectly, scores ranking the annotator's preference of outputs generated, and/or the like.

In some examples, the multimodal performance analysis engine may input audiovisual data (e.g., one or more audio components and one or more video components) into one or more multimodal analysis models to output one or more features (e.g., one or more audio-based features, video-based features, combined audiovisual features, and/or the like). In some examples, the multimodal performance analysis engine may use one or more features to determine, inform, improve, modify, and/or the like, one or more features of a different type, source, analysis, and/or the like. For example, the multimodal performance analysis engine may use a video-based feature, such as a lip movement, to inform one or more audio-based features, such as a transcript of a user speaking. In another example, the multimodal performance analysis engine may use an audio-based feature, such as a sentimental analysis of a user's tone while speaking, to inform another feature, such as a sentimental analysis of a user's body posture.

In some embodiments, the multimodal performance analysis engine may, for example, generate one or more outputs indicative of the content and context of audiovisual data (e.g., audiovisual inputs, audiovisual responses) based on one or more features. For example, the multimodal performance analysis engine may, during a pre-processing stage, generate a textual data set comprising a transcript of a user interacting with real-time interactive media content and determine which parts of the transcript are associated with the user and which parts of the transcript are associated with the real-time interactive media content based on one or more audio-based features, video-based features, and/or the like. Additionally or alternatively, the multimodal performance analysis engine may, for example, determine, via behavioral analysis engine and/or rules analysis models, how loud a user is speaking, how quiet a user is speaking, how fast a user is speaking, how clearly a user is speaking, if a user sounds frustrated, angry, and/or anxious, if a user has said certain words or phrases, what a user has said in response to certain statements or questions from the real-time interactive media content (e.g., whether a user has provides explanations of products and/or services, warranties, legal disclosures, costs and benefits, financing options, etc.), and/or the like. Additionally or alternatively, the multimodal performance analysis engine may, for example, determine where a user is looking, if a user is looking at their phone, if a user is looking towards or away from the real-time interactive media content, if a user is making certain facial expressions such as smiling, frowning, and/or scowling, how a user is postured, if a user is making certain behaviors such as moving their hands while they speak, if a user is covering their mouth while they speak, if a user is fidgeting, tapping, and/or the like. Each of the foregoing analyses may be generated by inputting audiovisual data (e.g., audio data, video data, or a combination of audio and video data, with or without additional context data and/or metadata) into one or more trained machine learning models. In some examples, the multimodal performance analysis engine may generate one or more performance analysis data objects based on such determinations about the content and context of one or more audio components and/or video components. Additionally or alternatively, the multimodal performance analysis engine may make one or more similar determinations about the content and context of real-time interactive media content. Additionally or alternatively, the multimodal performance analysis engine may generate one or more performance analysis data objects based on other data including, but not limited to, an experience rating (e.g., modifying a score of a user based on an experience rating), a simulated personality type (e.g., labeling a performance analysis data object of a user based on a simulated personality type), and/or historical performance analysis data objects (e.g., curving a score of a user based on previous scores). In various examples including one or more audio-based features and/or one or more video-based features, the one or more audio-based features and/or the one or more video-based features may be analyzed as a combined audiovisual feature set and/or separately as distinct audio and video analyses.

In a non-limiting contextual example, contextual interaction data may include data of a structured training program, such as, for example, a vehicle sales training program where trainers train participants to work as sales associates, F&I representatives, and/or the like, of a vehicle dealership. In such a case, the contextual interaction data may include, for example, video of trainers acting as customers shopping for vehicles and participants acting as sales associates, F&I representatives, and/or the like, serving the customers; review data where participants of the sales training program are reviewed on their performance; score data where participants of the sales training program are scored on their performance; feedback data where participants of the sales training program are given feedback on their performance; and/or the like. Accordingly, the multimodal performance analysis engine may identify and/or learn patterns, rules, associations, and/or the like, from the contextual interaction data (e.g., using a behavioral analysis engine, one or more audio analysis models, one or more video analysis models, one or more rules analysis models, and/or the like) such that the multimodal performance analysis engine may replicate the reviewing, scoring, and/or feedback, provided in the sales training program. In some embodiments, the learning may be facilitated via structured data generated for training one or more machine learning models. For example, one or more of the aforementioned score data (e.g., weights) may be assigned to the contextual interaction data, and the score data may be generated as a label to the constituent components of the training data set to inform training of the machine learning models (e.g., weights applied to the contextual interaction data to train the machine learning model(s) to differentiate good from bad audiovisual data). In the sales training program, participants may be required to say one or more specific answers in response to a particular question from the trainers acting as customers. It may be that some answers of the discrete set of answers are scored higher than others when scoring performances. Accordingly, the multimodal performance analysis engine may learn to identify features (e.g., from contextual interaction data) such as the particular questions from the trainers and the discrete set of answers for the participants, the scores associated with each answer, and apply one or more rules analysis models to the features and scores to generate performance analysis data objects. Moreover, outputs of the multimodal performance analysis engine (e.g., performance analysis data) may take a number of forms and may be configured to identify behavioral actions, verbal cues, verbal omissions, opportunities for improvements, exemplary demonstrations, projected training recommendations (e.g., tiered sequences of real-time interactive media content), and/or the like. In this manner, the multimodal performance analysis engine may be applied to data associated with a user interacting with real-time interactive media content (e.g., audiovisual inputs, audiovisual responses) and generate performance analysis data.

As used herein, the term “audio-based feature” refers to a data entity based at least on one or more audio components and generated by a multimodal performance analysis engine. In some examples, an audio-based feature may represent one type of feature generated by the behavioral analysis engine. In some examples, an audio-based feature may include or otherwise be associated with spectral features (e.g., mel-frequency cepstral coefficients (MFCCs), spectrograms), temporal features (tempo, root mean square energy), pitch-related features, statistical features, speech-to-text features (e.g., transcripts), embeddings (e.g., word embeddings, sentence embeddings, document embeddings), speaker diarisation features, and/or the like. In some examples, audio-based features may be associated with one or more time stamps, identifiers (e.g., entity identifiers) and/or the like.

As used herein, the term “video-based feature” refers to a data entity based at least on one or more video components and generated by a multimodal performance analysis engine. In some examples, a video-based feature may represent one type of feature generated by the behavioral analysis engine. In some examples, a video-based feature may include or otherwise be associated with pixel-level features, frame-level features, segment-level features, motion vectors, spatiotemporal features, histogram of optical flows, scale-invariant feature transform, space-time interest points, histogram of oriented gradients, bounding boxes, lip movement features, mouth movement features, eye movement features, head movement features, facial recognition features, body movement features, body posture features, body gesture features, hand movement features, hand gesture features, entity recognition features, object detection features, and/or the like. In some examples, video-based features may be associated with one or more timestamps, identifiers (e.g., entity identifiers), and/or the like.

As used herein, the term “predetermined attention criteria data” refers to a data entity indicative of one or more features and/or one or more rules, targets, and/or other criteria associated with one or more features. In some examples, predetermined attention criteria data may comprise structured data defining features (e.g., audio-based features, video-based features) and/or rules, targets, and/or other criteria and used for training one or more machine learning models. In some examples, predetermined attention criteria data may be provided to the multimodal performance analysis engine during training (e.g., as human feedback data during reinforcement learning, as label data along with a training data set, or as separate training data inputs) to indicate certain features to be included and/or excluded in generating performance analysis data objects. In some embodiments, the predetermined attention criteria may comprise one or more features and/or one or more rules, targets, and/or other criteria to direct the one or more machine learning models (e.g., in an attention mechanism layer of a neural network or similar function) to optimize certain variables. Additionally or alternatively, predetermined attention criteria data may be provided to the multimodal performance analysis engine to indicate rules associated with features (e.g., which responses should or should not be associated with which questions) in generating performance analysis data objects. In this manner, predetermined attention criteria data may be used, for example, to optionally alter, weight, or otherwise adjust the functions of the multimodal performance analysis engine and/or performance analysis data objects.

As used herein, the term “predetermined scoring criteria data” refers to a data entity indicative of one or more values, weights, categories, and/or the like associated with one or more features. In some examples, predetermined scoring criteria data may be structured data defining one or more values associated with one or more features and used for training one or more machine learning models. In some examples, predetermined scoring criteria data may be provided to the multimodal performance analysis engine during training (e.g., as human feedback data during reinforcement learning or as label data along with a training data set, as label data along with a training data set, or as separate training data inputs) to indicate that certain features (e.g., answers to certain questions, certain behaviors, etc.) are worth different scores, points, ranks, and/or the like. In this manner, predetermined scoring criteria data may be used, for example, to optionally alter, weight, or otherwise adjust the functions of the multimodal performance analysis engine and/or performance analysis data objects.

In a non-limiting example, predetermined attention criteria data may define one or more answers to a specific question such as, “vehicle A,” “promotional offer X,” and “membership program Y” as being respectively associated with predetermined scoring criteria data defining weights “0.8,” “0.9,” and “1.0.” The predetermined scoring criteria data may be used to indicate a score for training data sets that may then be used to train the one or more machine learning models to produce optimized outputs (e.g., higher scoring training data representing better outputs that influence training of the model to a greater degree). Accordingly, the multimodal performance analysis engine may use the respective weight of each term when generating performance analysis data objects (e.g., in a machine learning training process).

As used herein, the term “performance analysis data object” refers to a data entity indicative of a score or analysis associated with audiovisual data. A performance analysis data object may be based on a user's interaction with real-time interactive media content and generated by a multimodal performance analysis engine. In some examples, a performance analysis data object may include descriptive data and/or prescriptive data. In some examples, a performance analysis data object may be used to describe, provide insight to, provide feedback to, provide guidance to, score, rank, measure, analyze, and/or the like, a user's interaction with real-time interactive media content. In some examples a performance analysis data object may be based on one or more audiovisual inputs, audiovisual responses, audio components, video components, predetermined attention criteria data, predetermined scoring criteria data, contextual interaction data, simulated personality types, experience ratings, and/or the like, including but not limited to being based on one or more audio-based features and/or video-based features. In some examples, a performance analysis data object may include or otherwise be associated with one or more scores, ranks, metrics, measures, feedback, audio-based features, video-based features, audiovisual suggestions, contextual interaction data, and/or the like. The one or more audio-based features and/or the one or more video-based features used in generating performance analysis data objects may be analyzed as a combined audiovisual feature set and/or separately as distinct audio and video analyses.

In some examples, a performance analysis data object may include data (e.g., a score, rank, metric, measure, feedback) that indicates how well a user performed while interacting with real-time interactive media content. In some examples, a performance analysis data object may include data that indicates how well a user performed in association with one or more syntactic and/or semantic parameters while interacting with real-time interactive media content. Non-limiting examples of data of a performance analysis data object include one or more numbers (e.g., 0-100), percentages (e.g., 0%-100%), decimals, (e.g., 0-1), letter grades (e.g., A-F), categories (e.g., satisfactory, unsatisfactory), recommendations, and/or the like. For example, a performance analysis data object may include data indicating one or more parameters in which a user may be recommended to improve such as, for example, the user's body behaviors, the user's verbal behaviors, the user's syntactic behaviors, and/or the like. Additionally or alternatively, a performance analysis data object may include data indicating one or more statements, questions, answers, and/or the like, made by the user that were correct, incorrect, missing, and/or the like, while interacting with real-time interactive media content. Additionally or alternatively, a performance analysis data object may include data indicating that a user may improve their posture, alter their facial expressions, decrease the speed at which they speed, increase the volume at which they speak, decrease the number of words they use in responding, and/or the like. Additionally or alternatively, a performance analysis data object may include data indicating one or more reasons for which a user was scored in a particular manner such as, for example, providing certain terms or answers a user failed to say in response to certain prompts from the real-time interactive media content. In some examples one or more performance analysis data objects may be used to generate one or more graphical representations.

As used herein, the term “graphical representation” refers to a data entity configured to be displayed visually to a user, such as at a visual feedback interface. In some examples, a graphical representation may be based on one or more performance analysis data objects, audiovisual suggestions, tiered sequences of real-time interactive media content, and/or the like. In some examples, a graphical representation may be configured to display one or more bar charts, line charts, pie charts, histograms, time series, pareto charts, word clouds, bubble charts, tree maps, forecasts, timelines, icons, image data, video data, audio data, textual data fields, and/or the like. In some examples, a graphical representation may be configured to display one or more numerical values, a graph, a chart, and/or the like. Additionally or alternatively, a graphical representation may be configured to display one or more textual data fields. In some examples, a graphical representation may be used to display one or more performance analysis data objects compared across users, time, and/or combinations thereof. For example, a graphical representation may include a chart depicting one or more scores of one or more performance analysis data objects associated with a user for a given time interval. Additionally or alternatively, a graphical representation may include a chart depicting a plurality of scores of a plurality of performance analysis data objects associated with a plurality of different users for a given time interval.

In some embodiments, a graphical representation may be associated with a certain mode. For example, a graphical representation may be associated with a trainee mode, an administrator mode, and/or the like. In some examples, what data graphical representations display may be based on an associated mode. For example, in a trainee mode, the user may be the individual personally associated with one or more performance analysis data objects, audiovisual suggestions, tiered sequences of real-time interactive media content, and/or the like. Accordingly, graphical representations associated with the trainee mode may be configured to be presented to that user. For example, the graphical representations associated with the trainee mode may only provide visualizations central to the user (e.g., visualizations based at least on the user's performance analysis data objects such as trends of the user's historical scores or the user's scores compared to a benchmark). Additionally or alternatively, graphical representations associated with the trainee mode may be configured to provide visualizations that compare the user to groups of other different users. Additionally or alternatively, graphical representations associated with the trainee mode configured to provide visualizations based on other, different users, may be configured to hide identifying information to preserve the security and privacy of the other, different users. In another example, in an administrator mode, the user may be a manager of one or more individuals who are each personally associated with one or more performance analysis data objects, audiovisual suggestions, tiered sequences of real-time interactive media content, and/or the like. Accordingly, graphical representations associated with the administrator mode may be configured to be presented to that user. For example, the graphical representations associated with the administrator mode may be configured to provide visualizations representative of the plurality of individuals the user manages. Additionally or alternatively, graphical representations associated with the administrator mode may be configured to provide personally identifying information of any individuals the user manages.

In some embodiments, a graphical representation may be used to identify one or more users, performance analysis data objects, audiovisual suggestions, tiered sequences of real-time interactive media content, and/or the like. For example, in a trainee mode, a user may be able to identify (e.g., query) one or more criteria associated with a graphical representation such as for example, a date range, a highest score, a lowest score, an average score for a given time interval, and/or the like. In another example, in an administrator mode, a user may be able to identify (e.g., query) one or more criteria associated with a graphical representation such as, for example, a lowest performing individual, a highest performing individual, a summary score of a plurality of individuals, a trend of scores for a given date range, and/or the like.

As used herein, the term “audiovisual suggestion” refers to a data entity including at least one or more audio components and/or video components. In some examples, an audiovisual suggestion may include or otherwise be associated with historical data, generated data, ongoing data, video data, image data, audio data, textual data, and/or the like. In some examples, an audiovisual suggestion may be generated by the multimodal performance analysis engine, the audiovisual media content engine, a generative artificial intelligent model, and/or the like. In some examples, an audiovisual suggestion may be based on contextual interaction data, one or more performance analysis data objects, and/or the like. For example, an audiovisual suggestion may include data identified from contextual interaction data (e.g., a video segment). In another example, if a performance analysis data object indicates a user underperformed in association with a given parameter (e.g., an audio-based feature, a video-based feature), an audiovisual suggestion associated with the given parameter may be generated and provided to the user. For example, an audiovisual suggestion may be generated by the audiovisual media content engine where the audiovisual media content engine outputs one or more audiovisual responses that demonstrate an exemplary action, behavior, interaction, and/or the like. In some examples, the multimodal performance analysis engine may generate an audiovisual suggestion to be provided to a user in response to one or more performance analysis data objects associated with the user. In some examples, an audiovisual suggestion may be provided to a user as a suggestion of how the user might improve an interaction or otherwise conduct themselves. In some examples, an audiovisual suggestion may include recorded and/or generated audio data, video data, image data, and/or the like, of an exemplary interaction and/or behavior. In a non-limiting example, a performance analysis data object may indicate that a user underperforms in maintaining posture, and as such, an audiovisual suggestion including an image of a human displaying an exemplary posture may be generated. The audiovisual suggestion may be presented directly to the user (e.g., in the form of a graphical representation) or incorporated into any other output stream (e.g., the real-time interactive media content may be configured to demonstrate or otherwise directly or indirectly output the audiovisual suggestion to the user).

As used herein, the term “tiered sequence of real-time interactive media content” refers to a data entity configured to define a plurality of real-time interactive media content and/or one or more attributes thereof, including but not limited to one or more predetermined variables, settings, parameters, and/or the like. The tiered sequence of real-time interactive media content may define a sequence (also referred to as a queue) of real-time interactive media content that is at least partially configured for sequential interaction with a particular user. Each individual real-time interactive media content may be referred to as a “tier” or groups of real-time interactive media content may define the tiers (e.g., “First Level”, “Second Level”, etc. each comprising a plurality of real-time interactive media content). For sequential interaction, the system may enforce a strict hierarchy of tiers or may allow a user to choose real-time interactive media content from within a tier or subset of tiers (e.g., the user may choose any order to complete the tier/subset prior to moving on to a subsequent tier or subset of tiers). For example, a tiered sequence of real-time interactive media content may comprise a sequence of real-time interactive media content for a user such that, after completing an interaction, the user is provided a next interaction of the sequence. The tiered sequence of real-time interactive media content may be configured to provide each interaction of a sequence to a user automatically at the end of an interaction, in response to an input from the user, and/or the like.

The tiered sequence of real-time interactive media content may comprise one or more real-time interactive media content related outputs, including but not limited to, one or more simulated interactive entities comprising attributes associated with the tiered sequence of real-time interactive media content (e.g., real-time interactive media content corresponding to a higher or lower experience rating depending upon the tiered sequence of real-time interactive media content). In some embodiments, the tiered sequence of real-time interactive media content may comprise the content itself (e.g., one or more models and accompanying systems configured to display and simulate interaction between a simulated entity and a user based on audiovisual inputs) and/or one or more attributes associated with the content (e.g., a table or other data store comprising attributes to be input into or otherwise used by the real-time interactive media content system, such as via the audiovisual media content engine 130, to generate or otherwise display the real-time interactive media content on demand). In some embodiments, the entire tiered sequence of real-time interactive media content may be pre-generated upon generation of the sequence (whether including the content itself or attributes associated therewith). In some embodiments, the sequence of attributes or other information may be generated (e.g., a list of criteria or metrics, a list of experience ratings, a list of simulated entity names, etc.) and the real-time interactive content may be delivered or otherwise generated or configured at the time of access by the user or within a certain buffering window of the user's access (e.g., the audiovisual media content engine may only be called for a current real-time interactive media content). For example, a tiered sequence of real-time interactive media content may include three corresponding real-time interactive media content attributes (e.g., simulated entity identifiers and/or attributes for focus during training, such as posture, objection handling, etc.), and when a user begins a real-time interactive media content session, the system may retrieve or generate and configure a first simulated entity associated with a first tier configured to improve the user based on the identified attribute.

In some examples, a tiered sequence of real-time interactive media content may provide a sequence defining training plan of real-time interactive media content recommended for a user and generated by the multimodal performance analysis engine. In some examples, a tiered sequence of real-time interactive media content may be based on one or more performance analysis data objects associated with a user. In some examples, the tiered sequence may be based on one or more predefined metrics or goals. For example, the system may generate a comparison of target metrics or goals (e.g., predetermined targets or goals and/or comparisons with other aggregated or individual user data) to the user's performance when generating the performance analysis data objects may generate recommended real-time media content. In some embodiments, the performance analysis data objects may indicate one or more deficiencies or metrics of focus (e.g., by deviating from other users'performance or a predetermined metric, including but not limited to by deviating more than a predetermined threshold), which may trigger a generation, supplementation, and/or update of a tiered sequence of real-time interactive media content. In some embodiments, a user may first interact with a calibration sequence of one or more real-time interactive media content to establish baseline metrics before a customized tiered sequence of real-time interactive media content is generated. In some examples, a tiered sequence of real-time interactive media content may be associated with any one or more performance analysis data objects, real-time interactive media content, simulated personality types, experience ratings, and/or the like.

In some examples, a tiered sequence of real-time interactive media content may include or otherwise be associated with one or more time intervals, frequencies of interaction, and/or one or more variables associated with real-time interactive media content. In various examples, a tiered sequence of real-time interactive media content may be updated dynamically as a user progresses through the tiered sequence of real-time interactive media content. For example, if a user continually underperforms at some stage of the tiered sequence of real-time interactive media content, the multimodal performance analysis engine may adapt the tiered sequence of real-time interactive media content to allow the user to progress and return to the stage where the user underperformed at a later time, to provide additional interactions focused on the skills the user is underperforming in, to be generally easier, and/or the like. In some embodiments, the tiered sequence of real-time interactive media content may be generated in a single instance (e.g., after an interaction between a user and a simulated entity). In some embodiments, the tiered sequence of real-time interactive media content may be periodically updated and/or supplemented. For example, a predetermined sequence length of real-time interactive media content could be generated by the system, and additional sequence tiers may then be added to the end of the sequence periodically (e.g., after each subsequent interaction between the user and a particular constituent real-time interactive media content of the sequence and/or a particular constituent tier). In some embodiments, subsequent performance analysis data objects associated with a user's performance during a tier of the tiered sequence of real-time interactive media content may trigger an update to the subsequent members of the tiered sequence of real-time interactive media content (e.g., to adjust to meet new data in a continuous feedback loop). In some embodiments, updating an existing tiered sequence of real-time interactive media content may require a performance analysis data object to indicate a deviation above a predetermined threshold. The thresholds may also be scaled based on the experience rating or other similar score or level. For example, once a user is above a predetermined threshold in one or more (or all) performance metrics, the user may be advanced to a subsequent “level” or “tier” with higher predetermined thresholds and/or different (including additional) metrics.

Non-limiting examples of tiered sequence of real-time interactive media content may include a tiered sequence of real-time interactive media content recommending a user train particular skills associated with poor performance as indicated by one or more performance analysis data objects; a tiered sequence of real-time interactive media content recommending a user train with real-time interactive media content associated with a particular personality type; a tiered sequence of real-time interactive media content recommending a user train with real-time interactive media content associated with a particular experience rating; a tiered sequence of real-time interactive media content recommending a user train with real-time interactive media content associated with a gradually increasing experience rating and rotating simulated personality types for a given frequency over a given time interval; and/or the like, and/or some combination.

In some embodiments, at least a portion of the tiered sequence may be generic or not generated based on a specific user's or users'performance and additional or replacement real-time interactive media content may be added to the generic tiered sequence. In some embodiments, an administrator may be presented with options to select one or more tiers of the tiered sequence of real-time interactive media content. In some embodiments, the systems described herein may be configured to optimize the tiered sequence to produce the determined performance improvement in the user with the fewest real-time interactive media content sessions (e.g., the fewest separate sessions between the user and a simulated entity).

As used herein, the term “interaction engine” refers to one or more processes, algorithms, and/or other data entity that describes parameters, hyper-parameters, and/or defined operations of a rules-based algorithm and/or machine learning model (e.g., model at least one or more rule-based layers, one or more layers that depend on trained parameters, coefficients, and/or the like), and/or the like configured to generate or facilitate generation of contextual response data sets and related predictions, data, and other outputs. An interaction engine may include artificial intelligence algorithms and techniques, including machine learning. An interaction engine may be configured, trained, and/or the like to generate one or more contextual response data sets based on one or more audiovisual inputs. For example, an interaction engine may be configured, trained, and/or the like to receive one or more audiovisual inputs, analyze the one or more audiovisual inputs, and output one or more contextual response data sets based on the analysis of the one or more audiovisual inputs. In some examples, the interaction engine may receive one or more textual input data sets, which textual input data sets may be generated from the audiovisual data. In some examples, the interaction engine may be configured to receive one or more audiovisual inputs and generate one or more textual input data sets based on the one or more audiovisual inputs. For example, the interaction engine may input one or more audio components of an audiovisual input into a speech-to-text model to output one or more textual input data sets. An interaction engine may be configured, trained, and/or the like to generate one or more contextual response data sets based on one or more textual input data sets. For example, an interaction engine may be configured, trained, and/or the like to receive one or more textual input data sets, analyze the one or more textual input data sets, and output one or more contextual response data sets based on the analysis of the one or more textual input data sets. In some examples, an interaction engine may include one or more of any type of machine learning models including one or more supervised, unsupervised, semi-supervised, reinforcement learning models, and/or the like. In some examples, an interaction engine includes a generative artificial intelligence model, an artificial neural network, or the like. In some examples, an interaction engine may be associated with an API. For example, an API may provide, define, describe, and/or the like, a format, standard, and/or the like for how an input (e.g., a textual input data set) may be configured for the interaction engine. For example, some generative artificial intelligence models (e.g., the interaction engine) may be configured such that inputs to the generative artificial intelligence model should be formatted in a particular manner to cause the generative artificial intelligence model to output data in a particular manner.

In some embodiments, the interaction engine may be associated with contextual interaction data. For example, the interaction engine may be trained and/or fine-tuned using, have access to, query from, and/or the like, contextual interaction data. For example, the interaction engine may be trained on contextual interaction data and automatically learn to identify statements, answers, questions, phrases, and/or general contextually dependent conversational structure from the interaction data. Additionally or alternatively, the interaction engine may be trained and/or fine-tuned using reinforcement learning from human feedback. For example, the interaction engine may be aligned with human preferences during training via a reinforcement learning from human feedback technique where a reward model is trained using direct human feedback (e.g., ranking data from annotators associated with model output) to guide the interaction engine.

In some embodiments, the interaction engine may be configured to make determinations about received inputs (e.g., audiovisual inputs, textual input data sets) and dynamically manage how contextual response data sets should be generated. For example, contextual response data sets may or may not be based on contextual interaction data. In some examples, the interaction engine may be trained to analyze an input (e.g., audiovisual inputs, textual input data sets and determine, based on the analysis of the input, whether to output a contextual response data set based on contextual interaction data. In a non-limiting example where the interaction engine outputs a contextual response data set that is not based on contextual interaction data, the contextual response data set that may be considered to include “small talk”. In another non-limiting example where the interaction engine outputs a contextual response data set that is based on contextual interaction data, the contextual response data set may be more specifically configured to steer a conversation in a certain direction and provide a certain type of interaction (e.g., progress through a training program). In some examples, contextual response data sets may include or be based on predefined content. For example, the interaction engine may be configured to generate a contextual response data set based on one of a set of discrete predefined answers where the set of discrete predefined answers are based on, defined by, included within, and/or the like, contextual interaction data. In some such examples, the interaction engine may (e.g., using the aforementioned artificial intelligence models) select from a list of predefined outputs based on the engine's analysis of the audiovisual inputs (e.g., via transformation of the audiovisual inputs into textual data and analysis of the textual data). In some examples, the interaction engine may be configured to generate contextual response data sets with variability, and/or the like, such that similar interactions may result in different outcomes. For example, in a case where the interaction engine determines a contextual response data set may be based on predefined content, the interaction engine may randomly select the predefined content from a set of discrete options based on a variability parameter. In some embodiments, the discrete options may include a subset of a total predefined content set chosen by the interaction engine's artificial intelligence analysis (e.g., a subset defined by a confidence threshold based on an analysis of the audiovisual inputs). In another example, in a case where the same input is provided to the interaction engine multiple times, the interaction engine may generate different contextual response data sets each time based on a variability parameter. In this manner, the interaction engine may be configured to guide interactions via contextual response data sets to maintain a certain context, duration, style, experience, purpose, and/or the like.

As used herein, the term “contextual response dataset” refers to a data entity based on one or more audiovisual inputs or textual input data sets and generated by an interaction engine configured to be used by an audiovisual media content engine to generate an audiovisual response for real-time interactive media content. In some examples, a contextual response data set may include textual data, audio data, video data, and/or the like. A contextual response data set may include data that is contextually relevant, conversationally structured, and/or the like, in response to an input. For example, a contextual response data set may include data configured to mimic natural language and provide a conversational response to an audiovisual input. In some examples, a contextual response data set may be configured in accordance with an API associated with the interaction engine. In some examples, a contextual response data set may be configured in accordance with an API associated with a receiving entity such as, for example, the audiovisual media content engine. For example, a contextual response data set may be formatted based on an API associated with the interaction engine or audiovisual media content engine. In some embodiments, the contextual response dataset may be a textual or partly textual data set configured to be used by the audiovisual media content engine to generate audiovisual interaction by the real-time interactive media content.

As used herein, the term “user device” refers an electronic computing device that may be used by a user for any of a variety of purposes including, but not limited to, one or more of sending and/or receiving signals, storing data, displaying data, viewing data, or initiating predictive performance analysis computing task(s). For example, the user device may be capable of, but not limited to, one or more of displaying renderable virtual widgets on the screen of the user device, receiving user input that triggers predictive data analysis task(s), determining and/or receiving location data that triggers dynamic update of a screen of the user device and/or information displayed on the screen of the user device, or delivering graphical representations to a user. The user device may include computer hardware and/or software configured to perform one or more functionalities associated with the user device. In some examples, the user device may be a mobile device. As used herein, the term “mobile device” refers to a user device that is capable of being held and transported by a user. Example mobile devices include, but not limited to, smart phones, tablet computers, laptop computers, wearables, laptop computers, or the like. In some examples, the user device may include one or more sensors, systems, or the like configured for determining location data or otherwise location of the user device. For example, the user device may include a global position system (GPS) and/or other sensor systems or devices configured to determine the absolute location data for the user device.

As used herein, the term “access” refers to the ability to receive, retrieve, view, make available, make use of, or the like of a feature or data associated with a virtual widget or user interface.

### System Architecture

Embodiments of the present disclosure may be implemented in various ways, including as computer program products that comprise articles of manufacture, as hardware, including circuitry, configured to perform one or more functions, and/or as combinations of specific hardware and computer program products. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together, such as in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In some embodiments, a non-volatile computer-readable storage medium may include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may be implemented as one or more methods, apparatuses, systems, computing devices (e.g., user devices, servers, etc.), computing entities, and/or the like. As such, embodiments of the present disclosure may take the form of an apparatus, system, computing device, computing entity, and/or the like executing instructions stored on one or more computer-readable storage mediums (e.g., via the aforementioned software components and computer program products) to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams, flowchart illustrations, and other example visualizations. It should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. In embodiments in which specific hardware is described, it is understood that such specific hardware is one example embodiment and may work in conjunction with one or more apparatuses or as a single apparatus or combination of a smaller number of apparatuses consistent with the foregoing according to the various examples described herein. Accordingly, the block diagrams and flowchart illustrations support various combinations of embodiments for performing the specified instructions, operations, or steps.

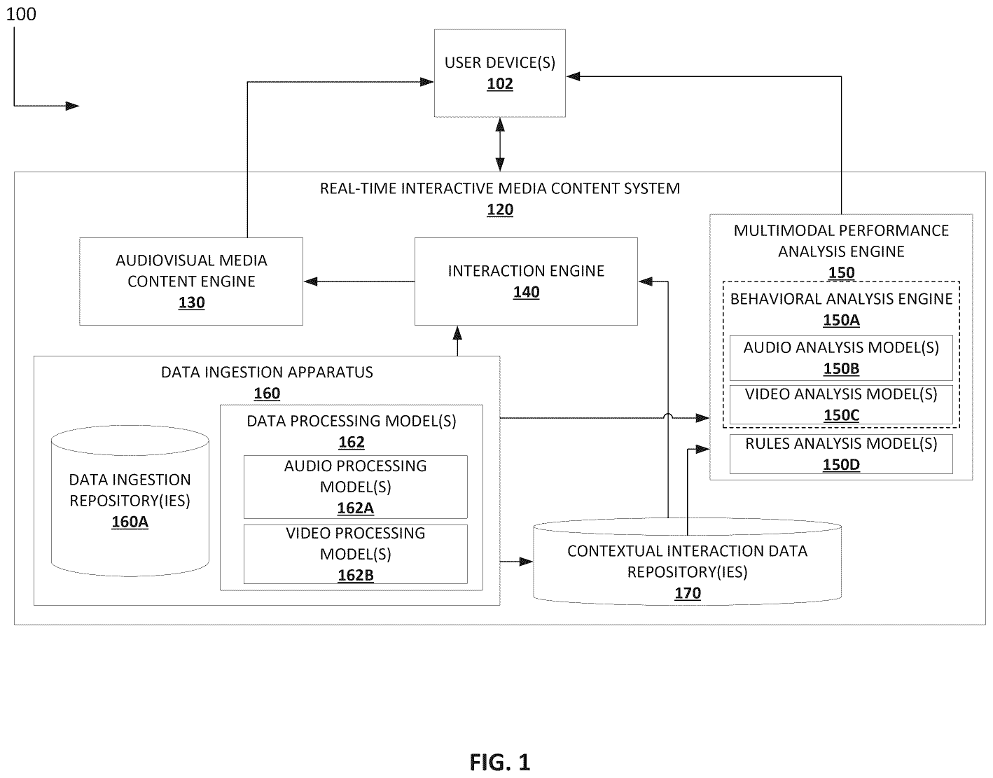

In this regard, FIG. 1 shows an example system environment 100 within which at least some embodiments of the present disclosure may operate. The depiction of the example system environment 100 is not intended to limit or otherwise confine the embodiments described and contemplated herein to any particular configuration of elements or systems, nor is it intended to exclude any alternative configurations or systems for the set of configurations and systems that can be used in connection with embodiments of the present disclosure. Rather, FIG. 1 and the system environment 100 disclosed therein is merely presented to provide an example basis and context for the facilitation of some of the features, aspects, and uses of the methods, apparatuses, computer readable media, and computer program products disclosed and contemplated herein.

With reference to FIG. 1, the depicted example system environment 100 includes a real-time interactive media content system 120 and one or more user devices 102. The real-time interactive media content system 120 may be in communication with one or more of the user device(s) 102.

It will be understood that while many of the aspects and components presented in FIG. 1 are shown as discrete, separate elements, other configurations may be used in connection with the methods, apparatuses, computer readable media, and computer programs described herein, including configurations that combine, omit, separate, and/or add aspects and/or components. For example, in some embodiments, the functions of one or more of the illustrated components in FIG. 1 may be performed by a single computing device or by multiple computing devices, which devices may be local or cloud based. It will be appreciated that the various functions performed by one or more of the real-time interactive media content system 120 and the user device(s) 102 may be embodied by a single apparatus, subsystem, or system comprising one or more sets of computing hardware (e.g., processor(s) and memory) configured to perform various functions thereof.

In some embodiments, the real-time interactive media content system 120 may be configured to provide a platform, such as a mobile application platform and/or a web application platform for access by a user. In this regard, the mobile application platform may be accessed by a user device 102 via an application installed in the user device 102. Further, the web application platform may be accessed by a user device 102 via a web browser, mobile browser application (e.g., a Wireless Application Protocol browser), and/or the like. In some embodiments, the real-time interactive media content system 120 or portions thereof (e.g., one or mor components of the real-time interactive media content system 120) may be embodied by a user device 102. For example, one or more software packages may be downloaded to a user device 102 and configured to perform the functions of one or more components of the real-time interactive media content system 120 via a memory and/or processor of the user device 102. In some embodiments, the real-time interactive media content system 120 or portions thereof (e.g., one or more components of the real-time interactive media content system 120) may be embodied by one or more portable data storage devices (e.g., USB flash drive, etc.), one or more platforms (e.g., mobile application platform, web application platform, etc), and/or some combination thereof. For example, one or more components of the real-time interactive media content system 120 (e.g., data ingestion apparatus 160, multimodal performance analysis engine 150) may be embodied by a USB flash drive and accessed by a user device 102 via a USB interface and one or more other components of the real-time interactive media content system 120 (e.g., audiovisual media content engine 130, interaction engine 140) may be embodied by one or more web application platforms where the various components are configured to communicate over the internet (e.g., via user device 102).

In some embodiments, a user device 102 is electronic computing device that may be used by a user for any of a variety of purposes including, but not limited to, one or more of sending and/or receiving signals, storing data, displaying data, viewing data, or initiating predictive performance analysis computing task(s). For example, the user device 102 may be capable of, but not limited to, one or more of displaying graphical representations on the screen of the user device 102, receiving user input that triggers predictive performance data analysis computing task(s), determining and/or receiving location data that triggers dynamic update of a screen of the user device 102 and/or information displayed on the screen of the user device 102, or delivering representations of a predictive performance data set (or portions thereof) to a user.

A user device 102 may include computer hardware and/or software configured to perform one or more functionalities associated with the user device(s) 102 described herein. In some embodiments, the user device 102 may be a mobile device. The mobile device may be a user device that is capable of being held and transported by a user. Example mobile devices include, but not limited to, smart phones, tablet computers, laptop computers, wearables, laptop computers, components or devices interacting with such devices (e.g., web cams, microphones, etc.), or the like. In various embodiments, a user device 102 may be a device owned by or otherwise assigned to the user (e.g., a personal mobile phone, tablet, laptop, desktop computer, components or other related devices, etc.). The user device 102 may use (e.g., access and/or install) one or more computer program products (e.g., a mobile application platform, desktop computer application platform) configured to provide one or more functionalities of the real-time interactive media content system 120. In some embodiments, one or more computer program products configured to provide one or more functionalities of the real-time interactive media content system 120 may be configured in association with a type of the user device 102 and/or operating system the user device 102. For example, the user device 102 using an application configured to provide one or more functionalities of the real-time interactive media content system 120 may be a smartphone using a mobile application, web browser, or the like; a desktop computer using a desktop application; and/or the like. In various embodiments, a computer program product configured to provide one or more functionalities of the real-time interactive media content system 120 may be configured to operate with one or more types of user devices 102 and/or one or more operating systems.

In some embodiments, the real-time interactive media content system 120 may include one or more of a data ingestion apparatus 160, an audiovisual media content engine 130, an interaction engine 140, a multimodal performance analysis engine 150, and/or one or more contextual interaction data repository(ies) 170. In the illustrated embodiment of FIG. 1, the data ingestion apparatus 160 includes one or more data processing models 162 configured to facilitate performance of one or more functions of the data ingestion apparatus 160. As further shown in FIG. 1, the multimodal performance analysis engine 150 includes a behavioral analysis engine 150A and rules analysis models 150D configured to facilitate performance of one or more functions of the multimodal performance analysis engine 150. Additionally, the behavioral analysis engine 150A includes audio analysis models 150B and video analysis models 150C configured to facilitate performance of one or more functions of the behavioral analysis engine 150A.

In some embodiments, the functions of one or more of the illustrated components of the real-time interactive media content system 120, including the data ingestion apparatus 160 alone or together with one or more other functions of the real-time interactive media content system, may be performed by a single computing device or by multiple computing devices, which devices may be local or cloud based.

The various functions of the real-time interactive media content system 120 and system environment 100 may be performed by other arrangements of one or more computing devices and/or computing systems without departing from the scope of the present disclosure. In some embodiments, a computing system may comprise one or more computing devices (e.g., server(s)).

The various components illustrated in the real-time interactive media content system 120 and system environment 100 may be configured to communicate via one or more communication mechanisms, including wired or wireless connections, such as over a network, bus, or similar connection. For example, a network may include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, etc.). For example, the network may include a cellular telephone, an 802.11, 802.16, 802.20, and/or WiMAX network. Further, a network may include a public network, such as the Internet, a private network, such as an intranet, or combinations thereof, and may utilize a variety of networking protocols now available or later developed including, but not limited to TCP/IP based networking protocols.

In various embodiments, the components depicted in FIG. 1 as being included in the real-time interactive media content system 120, although not required to be an integral system, may be connected via one or more networks. In some embodiments, one or more APIs may be leveraged to communicate with and/or facilitate communication between one or more of the components illustrated in the real-time interactive media content system 120 and system environment 100.

### Example System Operation

Using the various components and techniques described herein, the real-time interactive media content system 120 may facilitate an interaction between the user of user device 102 and real-time interactive media content, as well as the associated functionalities and analyses discussed herein. The real-time interactive media content system 120 may, via the audiovisual media content engine 130, generate or otherwise create, provide, update, or control real-time interactive media content to be displayed, via the user device 102, to the user of the user device 102 (e.g., via a screen of the user device). The user device 102, using one or more audiovisual capture devices (e.g., camera(s) and/or microphone(s)), may capture audiovisual inputs of the user during display of the real-time interactive media content and provide the audiovisual inputs to the real-time interactive media content system 120. The real-time interactive media content system 120 may receive the audiovisual inputs (e.g., via the data ingestion apparatus 160, interaction engine 140, multimodal performance analysis engine 150, and/or contextual interaction data repository 170), and in response, generate audiovisual responses. The audiovisual responses may be provided to the user device 102 and displayed to the user.

In some embodiments, the real-time interactive media content system 120 may be configured to cause the display of real-time interactive media content to a user via a display device (e.g., the user device 102, such as via a screen associated with the user device) where the real-time interactive media content includes at least a content audio component and a content video component. For example, the real-time interactive media content system 120 may, via the audiovisual media content engine 130, output real-time interactive media content to the user device 102 causing the user device 102 to play a content audio component and display a content video component of the real-time interactive media content to the user of the user device 102.

In some embodiments, real-time interactive media content may be generated by, controlled by, or otherwise associated with the audiovisual media content engine 130 and associated with a simulated interactive entity. In some examples, real-time interactive media content may include or otherwise be associated with one or more audio components and/or video components associated with a simulated interactive entity (e.g., a digital human configured to interact with a user). In some embodiments, the simulated interactive entity may comprise a digital human programmatically controlled to interact with the user (e.g., via rendering a human-like face or upper body on the screen and controlling the visual movement of the digital human and audio output of the digital human to simulate a human speaking to the user). For example, a simulated interactive entity (e.g., a digital human) may include or otherwise be associated with one or more meshes (e.g., 3D models of skin, hair, clothes, or other 3D models associated with a digital human), one or more rigs (e.g., an underlying structure configured to simulate a human bone structure, joints, and/or the like), one or more textures (e.g., 2D images mapped to meshes), one or more shaders (e.g., computer program instructions configured to determine how simulated light interacts with the mesh), one or more physics systems (e.g., computer program instructions configured to determine physical interactions and properties of the rig, mesh, environment, and/or the like), and/or any other systems and/or components.

In various embodiments, the real-time interactive media content may be generated using cloud-based rendering, local rendering, hybrid rendering, web-based rendering, and or the like. For example, the audiovisual media content engine 130 may render a simulated interactive entity continuously and/or periodically (e.g., with each audiovisual response) at a remote server and transmit video data (e.g., rendered video frames and corresponding audio) to a user device 102; generate and transmit instructions configured to control a locally rendered simulated interactive entity (e.g., rendered at the user device 102 via an application platform installed at the user device 102; render and/or control a simulated interactive entity directly in a web browser (e.g., using a web-based rendering system such as WebGL); or any combination thereof.

Additionally or alternatively, real-time interactive media content may include or otherwise be associated with one or more audiovisual responses (e.g., computed responses configured to be output via the simulated interactive entity), such as responses to the user's audiovisual inputs. Additionally or alternatively, the user device 102 may include, may capture, or may otherwise be associated with one or more audiovisual inputs, textual input data sets, contextual response data sets, the interaction engine 140, a simulated personality type, an experience rating, and/or the like. The real-time interactive media content system 120 may be configured, via the embodiments disclosed herein, to analyze and generate responses to the audiovisual inputs, and the real-time interactive media content system 120 may simulate interaction with the user by the real-time interactive media content by causing the real-time interactive media content to respond to the audiovisual inputs. For example, real-time interactive media content may output audio and video configured to output the sound and display the appearance of a simulated interactive entity. In some examples, real-time interactive media content may output the voice and appearance of a simulated human, or any other simulated interactive entity, to be dynamic, active, and reactive to a user interacting with the real-time interactive media content using the processes and systems discussed herein. For example, real-time interactive media content output by the real-time interactive media content system 120 may enable a user of the user device 102 to interact with (e.g., see and speak with) a simulated human via the user device.

In some embodiments, the real-time interactive media content system 120 may be configured to receive one or more audiovisual inputs captured in association with the user of user device 102. The audiovisual inputs may include a user audio component including audio data of the user captured during display of the real-time interactive media content (e.g., via one or more microphones of the user device or separate microphones) and a user video component including one or more images of the user captured during display of the real-time interactive media content (e.g., via one or more cameras of the user device or separate cameras). For example, one or more audiovisual inputs may be captured by the user device 102 and transmitted to the real-time interactive media content system 120. In some embodiments, the real-time interactive media content system 120 may convert at least one of the user audio component or the user video component to one or more textual input data sets (e.g., via the data ingestion apparatus 160) and input the one or more textual input data sets into the interaction engine 140 which may be configured to generate one or more contextual response data sets based at least in part on the one or more textual input data sets. For example, the audio component may be input to a speech-to-text model (e.g., the large-v2 Whisper model) which may be a pre-trained model (e.g., an artificial intelligence model) trained to receive the audio component in one or more languages and output a textual translation of the audio component. In some instances, the textual translation may be to a standard language (e.g., English).

By converting the audiovisual input, or one of the audio component or video component, into a textual input, the real-time interactive media content system 120 may reduce the model complexity needed to generate a contextual response data set with the interaction engine 140 or an audiovisual response with the audiovisual media content engine 130, and also increase the accuracy of the model output from the interaction engine 140 and/or audiovisual media content engine 130 by limiting the degrees of freedom in the model, which may thereby reduce the data transmission needs of the system and/or facilitate real-time interactivity of the real-time interactive media content, which allows the real-time interactive media content to carry out a live conversation with a user over a network (e.g., a wide area network). The real-time interactive media content system 120 may generate one or more audiovisual responses by inputting the one or more contextual response data sets into the audiovisual media content engine 130 which may be configured to generate one or more audiovisual responses based at least in part on the one or more contextual response data sets.

In some embodiments, an audiovisual input may be captured by the user device 102 and provided to the real-time interactive media content system 120. The real-time interactive media content system 120 may, for example, ingest the audiovisual input via data ingestion apparatus 160. In some examples, the data ingestion apparatus 160 may be configured to process and/or prepare data received by the real-time interactive media content system 120 to be input into one or more components of the real-time interactive media content system 120, such as converting the audiovisual input, or a portion thereof such as an audio component of the audiovisual input, into the textual input data set. In some embodiments, the processing and transmission of a textual input data set in place of audiovisual data, or portions thereof, may decrease bandwidth required for the transmission of data, increase the speed of data transmissions, and/or the like.

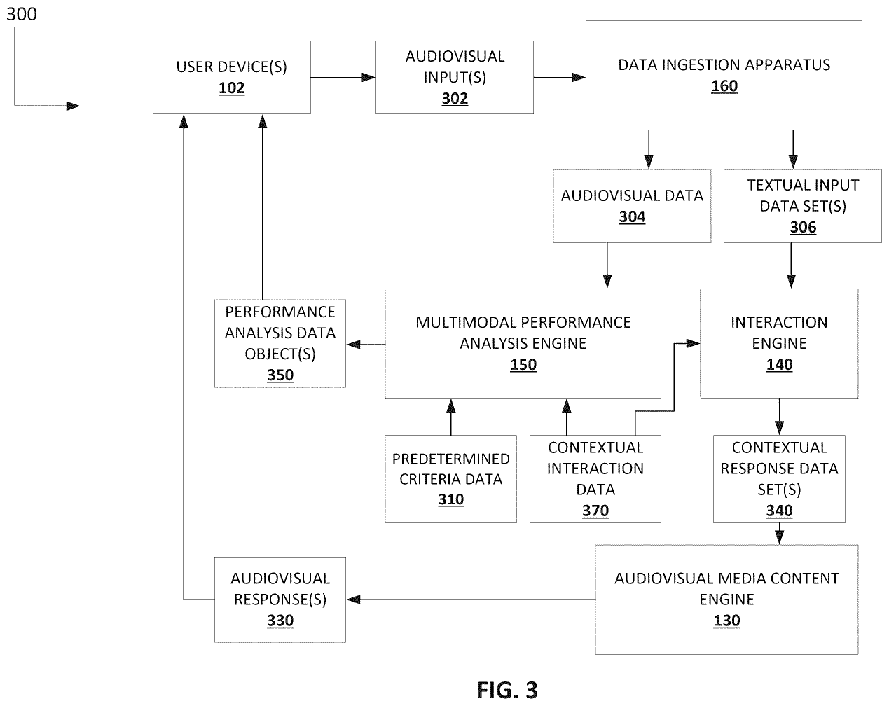

In some examples, the data ingestion apparatus 160 may store or direct the storage of audiovisual inputs. For example, the data ingestion apparatus 160 may store audiovisual inputs via the data ingestion repository 160A and/or the contextual interaction data repository 170. In some embodiments, the data ingestion repository 160A and/or contextual interaction data repository 170 may store audiovisual inputs for later retrieval such as, for example, in generating performance analysis data objects as described with respect to FIG. 3. Additionally or alternatively, the data ingestion apparatus 160 may, via data processing models 162, perform data processing operations such as, for example, audio processing operations via audio processing models 162A and/or video processing operations via video processing models 162B to improve, modify, format, isolate, and/or the like, any audio components and/or video components of an audiovisual input. For example, the data ingestion apparatus 160 may separate the audio component and video component of audiovisual data (e.g., audiovisual inputs) for isolated processing and/or transmission. Additionally or alternatively, the data ingestion apparatus 160 may generate a textual input data set from an audiovisual input. For example, the data ingestion apparatus 160 may apply an audio processing model 162A (e.g., a speech-to-text model) to an audio component of the audiovisual input to generate a textual input data set. Additionally or alternatively, the data ingestion apparatus 160 may apply a video processing model 162B (e.g., a video-to-text model) to generate a textual input data set from a video component of the audiovisual input or from both audio and video portions of the audiovisual input. The data ingestion apparatus may provide an audiovisual input, data portions thereof (e.g., an audio component, a video component), data derivative thereof (e.g., a textual input dataset, metadata), and/or any combination thereof to one or more additional components of the real-time interactive media content system 120 (e.g., the interaction engine 140, multimodal performance analysis engine 150, contextual interaction data repository 170).

In some embodiments, the data ingestion apparatus 160 may be optionally included or excluded from the real-time interactive media content system 120. For example, in an embodiment where the real-time interactive media content system 120 optionally excludes the data ingestion apparatus 160, one or more other components of the real-time interactive media content system 120 may be configured to perform one or more functions of the data ingestion apparatus 160. For example, the interaction engine 140, multimodal performance analysis engine 150, and contextual interaction data repository 170 may be configured to directly receive and process audiovisual inputs. For example, the interaction engine 140 may be configured to generate contextual response data sets based on directly received audiovisual inputs, the multimodal performance analysis engine 150 may be configured to generate performance analysis data objects based on directly received audiovisual inputs, and the contextual interaction data repository 170 may be configured to store directly received audiovisual inputs, portions thereof, and/or data derivative thereof.

The interaction engine 140 may generate or facilitate generation of contextual response data sets and related predictions, data, and other outputs. The interaction engine 140 may be configured, trained, and/or the like to receive one or more audiovisual inputs (e.g., directly and/or via textual input data), analyze the one or more audiovisual inputs, and output one or more contextual response data sets based on the analysis of the one or more audiovisual inputs. In some examples, the interaction engine 140 may receive one or more textual input data sets, which textual input data sets may be generated from the audiovisual inputs (e.g., by data ingestion apparatus 160). In some examples, the interaction engine 140 may be configured to receive one or more audiovisual inputs directly and generate one or more textual input data sets based on the one or more audiovisual inputs. For example, the interaction engine 140 may input one or more audio components of an audiovisual input into a speech-to-text model to output one or more textual input data sets.

In some embodiments, the interaction engine 140 may use or otherwise be associated with contextual interaction data of the contextual interaction data repository 170. For example, the interaction engine 140 may be trained and/or fine-tuned using, have access to, query from, and/or the like, contextual interaction data. For example, the interaction engine 140 may be trained on contextual interaction data and automatically learn to identify statements, answers, questions, phrases, and/or general contextually dependent conversational structure from the contextual interaction data.

In some embodiments, the interaction engine 140 may be configured to make determinations about received inputs (e.g., audiovisual inputs, textual input data sets) and dynamically manage how contextual response data sets should be generated. For example, contextual response data sets may or may not be based on contextual interaction data from the contextual interaction data repository 170. In some examples, the interaction engine 140 may be trained to analyze an input (e.g., audiovisual inputs, textual input data sets) and determine, based on the analysis of the input, whether to output a contextual response data set based on contextual interaction data and/or one or more models trained or otherwise generated based on contextual interaction data. In some examples, contextual response data sets may include or be based on predefined content. For example, the interaction engine 140 may be configured to generate a contextual response data set based on one of a set of discrete predefined answers where the set of discrete predefined answers are based on, defined by, included within, and/or the like, contextual interaction data. In some such examples, the interaction engine 140 may select from a list of predefined outputs based on the engine's analysis of the audiovisual inputs (e.g., via transformation of the audiovisual inputs into textual data and analysis of the textual data).

In some examples, the interaction engine 140 may be configured to generate contextual response data sets with variability, and/or the like, such that similar interactions may result in different outcomes. For example, in a case where the interaction engine 140 determines a contextual response data set may be based on predefined content, the interaction engine 140 may randomly select the predefined content from a set of discrete options based on a variability parameter. In some embodiments, the discrete options may include a subset of a total predefined content set chosen by the interaction engine's artificial intelligence analysis (e.g., a subset defined by exceeding a static or dynamic confidence threshold based on an analysis of the audiovisual inputs, such as members of the predefined content set exceeding a predetermined score or a top three members of the predefined content set). In another example, in a case where the same input is provided to the interaction engine 140 multiple times, the interaction engine 140 may generate different contextual response data sets each time based on a variability parameter. In this manner, the interaction engine 140 may be configured to guide interactions via contextual response data sets to maintain a certain context, duration, style, experience, purpose, and/or the like.

In a non-limiting contextual example, the interaction engine 140 may be trained on contextual interaction data (e.g., audiovisual data or transcript data annotated and formatted for machine learning training) of individuals interacting within a particular context, such as, for example, a vehicle sales training program. In such an example, the contextual interaction data may include data of a vehicle sales associate (or a trainee acting as such) speaking with a customer (or a trainer of the program acting as such) interested in purchasing a vehicle. The interaction engine 140 may comprise a large language model trained on such contextual interaction data to generate outputs aligned to be like the customer interested in purchasing a vehicle. For example, a large language model of the interaction engine 140 may be fine-tuned in a process where the large language model is provided an input (e.g., a textual input data set) comprising something said by the sales associate (e.g., via contextual interaction data configured for machine learning) to generate a response (e.g., contextual response data set) where the large language model's weights are updated to minimize a loss function (e.g., a cross-entropy loss based on actual and predicted word probability distributions) based on a comparison between the large language model's output and ground truth data of what the customer actually said (e.g., as indicated by the contextual interaction data configured for machine learning). Through iteratively repeating this process, the interaction engine 140 may learn to replicate the responses of various entities described by contextual interaction data, such as, for example, various customers in various vehicle sales situations. In various embodiments, contextual interaction data and/or subsets thereof, may be grouped and/or labelled (e.g., via human annotators, machine learning sentiment analyses, and/or the like) based on personality types (e.g., personality types of the customer such as agreeableness, mood, patience, etc.), interaction types (e.g., vehicle sales scenario, initial greeting scenario, price negotiation scenario, objection handling scenario, etc.), difficulty (e.g., how difficult a customer is being to deal with, how much objection handling occurs and to what extent) and/or the like, such that the interaction engine 140 may be configured to simulate various types of responses (e.g., by being fine-tuned on such data and/or having access to such data).

Additionally or alternatively, in various embodiments, the interaction engine 140 may be trained to perform intent recognition, entity recognition, and/or the like to determine when to generate a contextual response data set based on contextual response data or when to generate a contextual response data set independent of contextual response data. Continuing the above non-limiting example, the interaction engine 140 may be trained to perform an intent recognition analysis on a textual input data set and identify (e.g., using one or more natural language processing techniques, confidence scores, thresholds, and/or the like) if the textual input data set contains reference to a context associated with contextual interaction data and/or a subset thereof. For example, the interaction engine 140 may be configured to determine whether a textual input data set is associated with a context such as a vehicle specific context, a shopping context, a financing context, a sales context, and/or the like, each of which being associated with contextual interaction data and/or subsets thereof. For example, if a textual input data set were to comprise the textual string, “what are you looking for today?” the contextual interaction engine 140 may determine (e.g., via an intent recognition confidence score satisfying a predetermined threshold indicating an intent associated with contextual interaction data and/or a subset thereof) that the contextual response data set should be based at least in part on contextual interaction data. Accordingly, the interaction engine 140 may query the contextual interaction data (e.g., search the contextual interaction data for semantically similar statements and identify a corresponding answer or portion thereof), access a model trained on such contextual interaction data (e.g., a large language model fine-tuned on contextual interaction data associated with the intent), and/or the like when generating a contextual response data set.

Additionally or alternatively, the interaction engine 140 may be trained to perform an entity recognition analysis on a textual input data set and identify (e.g., using one or more natural language processing techniques, confidence scores, thresholds, and/or the like) if the textual input data set contains reference to a named entity associated with contextual interaction data and/or a subset thereof. For example, the interaction engine 140 may be configured to determine whether a textual input data set is associated with a named entity unique or likely to be unique to contextual interaction data such as a vehicle name, a vehicle feature, a promotional offer, a financing option, and/or the like, each of which being associated with contextual interaction data and/or subsets thereof. For example, if a textual input data set were to comprise the textual string, “are you interested in our promotional offer X” the contextual interaction engine 140 may determine (e.g., via an entity recognition confidence score satisfying a predetermined threshold indicating named entity X being associated with contextual interaction data) that the contextual response data set should be based at least in part on contextual interaction data. Accordingly, the interaction engine 140 may query the contextual interaction data (e.g., search the contextual interaction data for the named entity X and identify an associated answer), access a model trained on such contextual interaction data (e.g., a large language model fine-tuned on contextual interaction data associated with the named entity X), and/or the like when generating a contextual response data set. The examples of specific content are provided to give some example contexts in which the embodiments described herein may operate.

Additionally or alternatively, the interaction engine 140 may be trained to generate a contextual response data set independent of contextual interaction data. For example, the interaction engine 140 may be trained to perform an intent recognition analysis, entity recognition analysis, and/or the like, on a textual input data set to identify (e.g., using one or more of the techniques described herein) that the textual input data set contains reference to an intent, entity, and/or the like not associated with contextual interaction data. Additionally or alternatively, the interaction engine 140 may be trained to perform an intent recognition analysis, entity recognition analysis, and/or the like, on a textual input data set and, in response to failing to identify that the textual input data set contains reference to an intent, entity, and/or the like associated with contextual interaction data, determine that a contextual response data set should be independent of contextual interaction data. For example, if a textual input data set were to comprise the textual string, “how is the weather today?” the contextual interaction engine 140 may determine, via one or more of the aforementioned processes, that the textual input data set is associated with a named entity “weather” being identified as not associated with contextual interaction data (or the interaction engine 140 may fail to identify an intent, entity, and/or the like, associated with contextual interaction data), and as such, the contextual response data set should be generated independently of contextual interaction data. Accordingly, the interaction engine 140 may generate a contextual response data set without querying contextual interaction data, via a model not being fine-tuned on contextual interaction data, and/or the like (e.g., a generic response free of a context and/or predefined content associated with contextual interaction data).

As described herein, the interaction engine 140 may be configured to learn (e.g., via labelled contextual interaction data configured for machine learning training) associations between certain inputs and outputs such as, for example, certain textual input data sets and contextual response data sets, portions of textual input data sets and portions of contextual response data sets, key terms or words included in textual input data sets or contextual response data sets, semantic associations, combinations thereof, and/or the like. Additionally or alternatively, the contextual interaction data may include structured data (e.g., metadata, labels, subsets, and/or the like) to indicate such associations. For example, the interaction engine 140 may be trained to learn and/or query from contextual interaction data indicating an association between a first one or more key terms used in a first particular context (e.g., key terms A and B used within a question) and a second one or more key terms used in a second particular context (e.g., key term C used within a statement). In various embodiments, if such associations are strong enough (e.g., if the interaction engine 140 is trained to substantially always provide one of a discrete set of contextual response data sets, portions thereof, and/or derivative thereof, in response to particular textual input data sets or portions thereof, if contextual interaction data defines a discrete set of responses or portions thereof to be used in response to particular textual input data sets or portions thereof) the responses defined by such associations may be considered as predefined content, predefined outputs, predefined answers, and/or the like. In such cases where the interaction engine 140 may be configured to generate a contextual response data set based on one of a set of discrete predefined answers, the interaction engine may use a variability parameter, conversational context, and/or combinations thereof, to determine which predefined content to use. For example, in a case where the interaction engine 140 identifies four predefined answers indicated by contextual interaction data, the interaction engine 140 may select a predefined answer based on a highest confidence score computed for each of the four predefined answers as being likely outputs given the ongoing conversation (e.g., the previous textual input data sets and contextual response data sets of the interaction). Additionally or alternatively, the interaction engine 140 may use a variability parameter configured to select a predefined answer that is least used, least recently used, at random, and/or the like.

In various embodiments where the interaction engine 140 may select from a list of predefined content, generate a contextual response data set based on contextual interaction data, and/or the like, the interaction engine 140 may be configured to adapt any such outputs to a present conversational context. For example, consider a case where the interaction engine 140 determines, based on the analysis of a textual input data set, that the next output contextual response data set should be dependent on contextual interaction data defining predefined content of a statement including two key terms. In such a case, the interaction engine 140 may be configured to adapt the statement including the two key terms defined by the predefined content to fit a conversation the interaction engine 140 is engaged in with a user based on one or more parameters. For example, the interaction engine 140 may generate a contextual response data set constrained by one or more parameters such as, for example, being required to include the two key terms, include two terms that satisfy a semantic similarity threshold compared to the two key terms, satisfy a semantic similarity threshold compared to the statement defined by the predefined content, satisfy a confidence threshold for being a likely response based on the previous one or more textual input data sets and/or the previous one or more contextual response data sets, any combination thereof, and/or the like. Additionally or alternatively, in various embodiments, the interaction engine 140 may be trained to use various metadata such as, for example, the duration of a conversation to influence contextual response data sets (e.g., contextual response data sets being highly likely to be independent of contextual interaction data for the first 60 seconds of an interaction while after the first 60 seconds contextual response data sets being increasingly more likely to be based on contextual interaction data). In this manner, the interaction engine 140 may be configured to generate contextual response data sets that intelligently facilitate both freeform conversation and a structured content program while providing high reusability through variability in output.

In some embodiments, contextual response data sets may be provided to the audiovisual media content engine 130 to then cause the real-time interactive media content to interact with the user. For example, the interaction engine 140 may output contextual response data sets to the audiovisual media content engine 130 for further processing.

In some embodiments, the real-time interactive media content system 120 may programmatically cause the real-time interactive media content to interact with the user in real time by programmatically generating and displaying one or more audiovisual responses to the one or more audiovisual inputs (e.g., directly and/or via the associated textual input data). For example, the audiovisual media content engine 130 may be configured to generate one or more audiovisual responses to the one or more audiovisual inputs where the user device 102 may be configured to display the audiovisual responses. The one or more audiovisual responses may include simulated interaction of the interactive entity, such as via audio outputs configured to be played to the user (e.g., via user device 102) and/or simulated facial expressions, speech, and the like configured to be displayed to the user (e.g., via user device 102). In some embodiments, other audiovisual content (e.g., videos or other displays and/or audio signals) may be output to the user.

The audiovisual media content engine 130 may comprise one or more processes, algorithms, and/or other data entity that describes parameters, hyper-parameters, and/or defined operations of a rules-based algorithm and/or machine learning model (e.g., model including at least one or more rule-based layers, one or more layers that depend on trained parameters, coefficients, and/or the like), and/or the like configured to generate, control, or otherwise facilitate real-time interactive media content. In some examples, the audiovisual media content engine 130 may be configured to generate real-time interactive media content, one or more audiovisual responses, one or more audiovisual suggestions, and/or the like. A trained audiovisual media content engine may be configured, trained, and/or the like to generate one or more audio components and/or one or more video components based on one or more contextual response data sets. For example, the audiovisual media content engine 130 may be configured, trained, and/or the like to receive one or more contextual response data sets (e.g., from the interaction engine 140), analyze the one or more contextual response data sets, and output real-time interactive media content and/or one or more audiovisual responses based on the analysis of the one or more contextual response data sets. In some examples, the audiovisual media content engine 130 may be configured to directly generate real-time interactive media content. In some examples, the audiovisual media content engine 130 may be configured to perform one or more processes (e.g., generating, transmitting, receiving, and/or the like, audio data, video data, instructions, and/or the like) at one or more remote servers, the user devices 102, or combinations thereof. For example, a simulated interactive entity represented by real-time interactive media content may be rendered by the audiovisual media content engine 130 or controlled by the audiovisual media content engine 130. In various examples, the audiovisual media content engine 130 may render the simulated interactive entity and output video data and/or audio data of the simulated interactive entity to the user device 102; generate and output instructions configured to control a rendering of a simulated interactive entity being rendered at the user device 102 (e.g., via a locally installed application or a web browser); generate and output instructions to one or more servers configured to render the simulated interactive entity and output audio and/or video data to the user device 102; and/or some combination thereof.

In some embodiments, the real-time interactive media content system 120 may be configured to analyze the performance of a user interacting with real-time interactive media content. For example, in an embodiment where a user is interacting with real-time interactive media content to receive simulated training, the real-time interactive media content system 120 may receive audiovisual input data (e.g., the same audiovisual input as the preceding processes or a separate stream of audiovisual input data) and analyze the audiovisual input data to provide performance analysis data objects based on various evaluations associated with the user. For example, the real-time interactive media content system 120 may apply audiovisual inputs into the multimodal performance analysis engine 150 to generate one or more performance analysis data objects. In some embodiments, applying the one or more audiovisual inputs into the multimodal performance analysis engine 150 to generate one or more performance analysis data objects may include generating one or more audio-based features indicative of one or more audibly detected actions associated with the user based at least in part on the user audio component of the one or more audiovisual inputs (e.g., via the audio analysis models 150B). Additionally or alternatively, applying the one or more audiovisual inputs into the multimodal performance analysis engine 150 to generate one or more performance analysis data objects may include generating one or more video-based features indicative of one or more visually detected actions associated with the user based at least in part on the user video component of the one or more audiovisual inputs (e.g., via the video analysis models 150C). Additionally or alternatively, applying the one or more audiovisual inputs into the multimodal performance analysis engine 150 to generate one or more performance analysis data objects may include generating the one or more performance analysis data objects based at least in part on the one or more audio-based features and/or the one or more video-based features. The one or more audio-based features and/or the one or more video-based features may be analyzed as a combined audiovisual feature set and/or separately as distinct audio and video analyses.

In some embodiments, the multimodal performance analysis engine 150 may comprise a data entity configured generate one or more performance analysis data objects based at least in part on one or more audiovisual inputs. Additionally or alternatively, the multimodal performance analysis engine 150 may be configured to generate one or more performance analysis data objects based on real-time interactive media content, textual input data sets, simulated personality types, experience ratings, audiovisual responses, predetermined attention criteria, predetermined scoring criteria, and/or the like. In some examples, the multimodal performance analysis engine 150 may be configured to generate one or more audiovisual suggestions, tiered sequences of real-time interactive media content, and/or the like.

In various embodiments, the multimodal performance analysis engine 150 may be configured to receive inputs (e.g., audiovisual inputs, audiovisual responses, experience ratings, other attributes or criteria, etc.) for processing to generate outputs (e.g., performance analysis data objects, audiovisual suggestions, etc.) in real-time. In other embodiments, the multimodal performance analysis engine 150 may be provided and/or retrieve inputs from storage (e.g., the data ingestion repository 160A, the contextual interaction data repository 170) for processing to generate outputs at a later time (e.g., at the end of an interaction, in response to a request). In various embodiments, the multimodal performance analysis engine 150 may be configured to perform batch processing (e.g., only processing inputs once a certain volume of data has been collected, a certain period of time passed, and/or the like). In some embodiments, the multimodal performance analysis engine 150 may use some combination of techniques for processing inputs and generating outputs as described herein.

In some embodiments, the multimodal performance analysis engine 150 may include one or more of any type of machine learning models including one or more supervised, unsupervised, semi-supervised, reinforcement learning models, one or more of any type of computer vision models, video analysis models, audio analysis models, text-to-speech models, speech-to-text models, text-to-video models, video-to-text models, natural language processing models, statistical models, custom models, and/or the like. In some embodiments, the multimodal performance analysis engine 150 may be configured to perform a bifurcated analysis on the incoming audiovisual input data, which may include both a rules analysis (e.g., with a rules analysis model 150D) and a behavioral analysis (e.g., with a behavioral analysis engine 150A), either one or both of which may include a machine learning analysis of the audiovisual input data or a portion thereof.

In some embodiments, the multimodal performance analysis engine 150 includes the behavioral analysis engine 150A configured to perform one or more data processing operations, audio processing operations (e.g., via audio analysis models 150B), video processing operations (e.g., via video analysis models 150C), statistical analyses, semantic analyses, and/or the like. The behavioral analysis engine 150A may be configured to generate features descriptive or indicative of a user's behaviors including, for example, the speech and physical movements or mannerisms of a user. Examples of features include, but are not limited to, audio-based features and video-based features. In various embodiments, the multimodal performance analysis engine 150 includes or is otherwise associated with the audio analysis models 150B configured to generate one or more audio-based features; the video analysis models 150C configured to generate one or more video-based features; the rules analysis models 150D configured to learn (e.g., from contextual interaction data of the contextual interaction data repository 170) and/or apply rules (e.g., whether predetermined or learned) to one or more features (e.g., apply one or more rules to one or more audio-based features, video-based features, and/or other features); and/or any other type of model configured to generate features used in performance analysis.

In some embodiments, the multimodal performance analysis engine 150 may use the behavioral analysis engine 150A in combination with the rules analysis models 150D to provide a multi-layered performance analysis. For example, the multimodal performance analysis engine 150 may initially process inputs to generate analyzable features. For example, the behavioral analysis engine may generate one or more features from received audiovisual inputs (e.g., the audio analysis models 150B may generate one or more audio-based features and the video analysis models 150C may generate one or more video-based features). The one or more audio-based features and/or the one or more video-based features may be analyzed as a combined audiovisual feature set and/or separately as distinct audio and video analyses. The multimodal performance analysis engine 150 may then perform a rules-based analysis to one or more features. For example, the rules analysis models 150D may apply one or more rules to one or more features to make various determinations such as, for example, applying one or more rules to one or more transcripts of the speech of the user of user device 102 to determine if a one or more correct answers were provided in response to one or more corresponding prompts from the audiovisual media content engine 130. For example, the multimodal performance analysis engine 150 may be trained to detect one or more key terms, phrases, sentences, and/or the like that a user should mention as a part of a simulated training program. The multimodal performance analysis engine 150 may then perform a semantic rules-based analysis of one or more features to make various determinations such as, for example, applying one or more rules to semantic features descriptive of a user's speech to determine if the user was performing good verbal behaviors (e.g., speaking clearly and calmly). In some examples, the multimodal performance analysis engine 150 may make determinations such as whether a user performed adequate objection handling. For example, real-time interactive media content system 120 may be configured to provide audiovisual responses to the user device that simulate a customer expressing concerns, hesitation, or disagreement. Accordingly, using the various techniques described herein, the multimodal performance analysis engine 150 may determine whether the user adequately handled such objections and generate scores (e.g., via performance analysis data objects) descriptive of such objection handling including, for example, whether the user showed empathy, provided clarifications to any misunderstandings, offered solutions or alternatives to problems raised, provided follow up statements after a certain duration of time, and/or the like. In various embodiments, one or more steps of the layered performance analysis described above may be performed by various components of the multimodal performance analysis engine 150 sequentially, in parallel, or combinations thereof.

In some embodiments, the multimodal performance analysis engine 150 may leverage one or more audio processing techniques, language processing techniques, and/or the like, (e.g., a recurrent neural network, convolutional neural network, transformer model), configured to generate features (e.g., audio-based features) from received audiovisual inputs and analyze the generated features to generate transcript data. For example, the behavioral analysis engine 150A may apply one or more audio analysis models 150B to an audiovisual input to generate features (e.g., MFCCs) representative of an audio component within the audiovisual inputs. Additionally or alternatively, one or more natural language processing models may be applied to the features to generate transcript data. Additionally or alternatively, one or more natural language processing models may be applied to the transcript data to improve the accuracy of the transcript data and/or generate additional features representative of the contextual and/or semantic meaning of the transcript data. For example, one or more models (e.g., a transformer model) trained for natural language processing may tokenize the transcript data and generate embeddings representative of the semantic meaning of each token.

In various embodiments, the multimodal performance analysis engine 150 may leverage one or more matching techniques used to parse transcript data generated from audiovisual inputs to determine whether the transcript data includes one or more predefined terms, statements and/or the like. For example, the multimodal performance analysis engine 150 may use the behavioral analysis engine 150A in combination with the rules analysis models 150D to determine if one or more predetermined terms, phrases, and/or the like, were said by a user by comparing the predetermined terms or phrases (e.g., defined by the rules analysis models 150D) against transcript data (e.g., generated by the behavioral analysis engine 150A) generated from audiovisual inputs. In various examples, one or more matching techniques may be used. For example, a syntactic matching technique may be used to determine if an exact syntactical match is found (e.g., a predetermined phrase “buy one item X, get one item Y free” may be exactly matched with the user spoken phrase “buy one item X, get one item Y free”); a fuzzy matching technique may be used to determine if a similar syntactical match is found (e.g., a predetermined phrase “buy one item X, get one item Y free” may be fuzzy matched with the user spoken phrase “buy an item X, get our item Y free”); an intent matching technique may be used to determine if a semantically similar match is found (e.g., a predetermined phrase “buy one item X, get one item Y free” may be intent matched with the user spoken phrase “we have a BOGO deal on item X and item Y”); and/or any other matching techniques and/or combination of techniques. The aforementioned techniques may allow the real-time interactive media content to simulate human interaction with generative AI content (e.g., free-form or less constrained content generation) while still imposing rigid requirements on input analysis and output generation.

In various embodiments, the multimodal performance analysis engine 150 may leverage one or more image recognition and/or image analysis techniques configured to generate features (e.g., video-based features) from received audiovisual inputs and analyze the generated features to generate, for example, posture analysis data, or any other behavioral analysis data. For example, the behavioral analysis engine 150A may apply one or more video analysis models 150C (e.g., a deep convolutional neural network) trained for human body posture detection or other visual inputs, including those discussed herein, to generate classifications of the posture of a user detected within the audiovisual input. For example, such models may be applied to one or more images of a user (e.g., a video component of an audiovisual input) to identify and track key points of the user (e.g., head, face, eyes, shoulders, elbows, hands, hips, torso, etc.) and analyze angles and distances between various key points to identify and classify the posture of a user. In various examples, different video-analysis models 150C may be used. For example, some lightweight models (e.g., PoseNet) may be configured to perform posture analysis in real-time and run in a web browser while other models may be more computationally expensive and configured to perform posture analysis at various time intervals (e.g., using a delay), at a cloud server, and/or the like.

In some embodiments, the multimodal performance analysis engine 150 may use various features to determine, inform, improve, modify, and/or the like, one or more features of a different type, source, analysis, and/or the like. For example, the multimodal performance analysis engine 150 may leverage various independent analyses, combined analyses, multimodal analyses, and/or the like, in generating performance analysis data objects. In one example, the multimodal performance analysis engine 150 may use a weighted combination of features including features generated from a verbal sentiment analysis and features generated from a posture analysis to determine a mood of a user at a given time (e.g., short answers combined with a poor posture may indicate an unengaged user, a tired user, etc.). In another example, the multimodal performance analysis engine 150 may use features generated from one analyses to inform the generation of features of another analysis such as, for example, combining (e.g., via temporal alignment, feature fusion) lip detection features (e.g., features generated by a convolutional neural network trained to generate video-based features) with speech detection features (e.g., features generated by a recurrent neural network trained to generate audio-based features), and inputting the combined features into a multimodal model trained to generate transcript data.

The contextual interaction data repository 170 may be configured to store contextual interaction data for the real-time interactive media content system 120. For example, the contextual interaction data repository 170 may comprise one or more repositories, databases, and/or the like configured to store contextual interaction data. The contextual interaction data repository 170 may be configured to provide or otherwise make available contextual interaction data to the various components and models of the real-time interactive media content system 120 (e.g., the audiovisual media content engine 130, interaction engine 140, multimodal performance analysis engine 150). Additionally or alternatively, the contextual interaction data repository 170 may be configured to receive audiovisual inputs captured by the user device 102 and store the audiovisual inputs for later use.

### Example Apparatuses of the Disclosure

Having discussed example systems in accordance with the present disclosure, example apparatuses in accordance with the present disclosure will now be described.

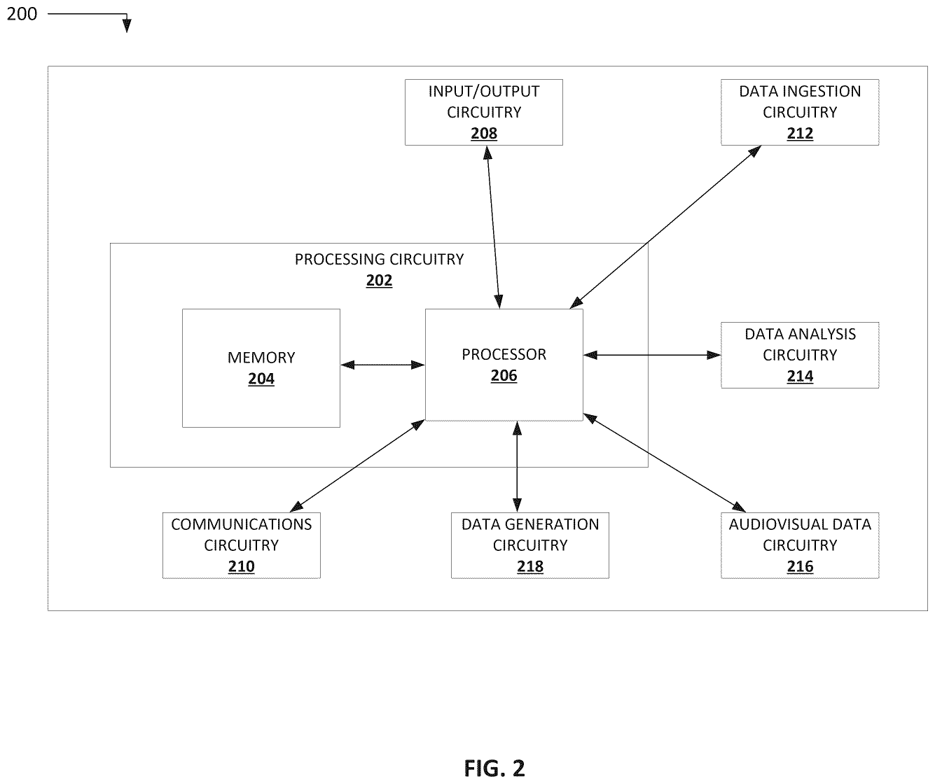

FIG. 2 illustrates a block diagram of an apparatus 200 in accordance with some example embodiments. For example, in some embodiments, the audiovisual media content engine 130, interaction engine 140, multimodal performance analysis engine 150, the data ingestion apparatus 160, and/or contextual interaction data repositories 170 may be embodied by one or more apparatuses 200. In this regard, in some embodiments, the real-time interactive media content system 120 or one or more portions (e.g., one or more individual apparatuses) thereof, if embodied in a particular embodiment, may be embodied by one or more apparatuses 200.

In some embodiments, the apparatus 200 may include a processing circuity 202 as shown in FIG. 2. It should be noted, however, that the components, or elements illustrated in and described with respect to FIG. 2 below may not be mandatory and thus one or more may be omitted in certain embodiments. Additionally, some embodiments, may include further or different components or elements beyond those illustrated in and described with respect to FIG. 2. In some embodiments, the functionality of the real-time interactive media content system 120 or any subset thereof may be performed by a single apparatus 200 or multiple apparatuses 200. In some embodiments, the apparatus 200 may comprise one or a plurality of physical devices, including distributed, cloud-based, and/or local devices.

Although some components are described with respect to functional limitations, it should be understood that the particular implementations necessarily include the use of particular computing hardware, such as the hardware shown in FIG. 2. It should also be understood that certain of the components described herein may include similar or common hardware. For example, two sets of circuitries for example, may both leverage use of the same processor(s), network interface(s), storage medium(s), and/or the like, to perform their associated functions, such that duplicate hardware is not required for each set of circuitry and a single physical circuitry may be used to perform the functions of multiple circuitries described herein. The use of the term “circuitry” as used herein with respect to components of the apparatuses described herein should therefore be understood to include particular hardware configured to perform the functions associated with the particular circuitry as described herein.

In some embodiments, “circuitry” may include processing circuitry, storage media, network interfaces, input/output devices, and/or the like. In some embodiments, other elements of the apparatus 200 may provide or supplement the functionality of another particular set of circuitry. For example, the processor 206 in some embodiments provides processing functionality to any of the sets of circuitries, the memory 204 provides storage functionality to any of the sets of circuitry, the communications circuitry 210 provide network interface functionality to any of the sets of circuitry, and/or the like.

The apparatus 200 may include or otherwise be in communication with processing circuitry 202 that is configurable to perform actions in accordance with one or more example embodiments disclosed herein. In this regard, the processing circuitry 202 may be configured to perform and/or control performance of one or more functionalities of the apparatus 200 in accordance with various example embodiments, and thus may provide means for performing functionalities of the apparatus 200 in accordance with various example embodiments. The processing circuitry 202 may be configured to perform data processing, application, and function execution, and/or other processing and management services according to one or more example embodiments. In some embodiments, the apparatus 200 or a portion(s) or component(s) thereof, such as the processing circuitry 202, may be embodied as or comprise a chip or chip set. In other words, apparatus 200 or the processing circuitry 202 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 200 or the processing circuitry 202 may therefore, in some cases, be configured to implement an embodiment of the disclosure on a single chip or as a single “system on a chip.” As such, in some cases, a chip or chipset may constitute means for performing one or more operations for providing the functionalities described herein.

In some embodiments, the processing circuitry 202 may include a processor 206 (and/or co-processor or any other processing circuitry assisting or otherwise associated with the processor) and, in some embodiments, such as that illustrated in FIG. 2, may further include memory 204. The processing circuitry 202 may be in communication with or otherwise control a user interface (e.g., embodied by input/output circuitry 208) and/or a communications circuitry 210. As such, the processing circuitry 202 may be embodied as a circuit chip (e.g., an integrated circuit chip) configured (e.g., with hardware, software or a combination of hardware and software) to perform operations described herein.

The processor 206 may be embodied in a number of different ways. For example, the processor 206 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. Although illustrated as a single processor, it will be appreciated that the processor 206 may comprise a plurality of processors. The plurality of processors may be in operative communication with each other and may be collectively configured to perform one or more functionalities of the apparatus 200 as described herein. In some example embodiments, the processor 206 may be configured to execute instructions stored in the memory 204 or otherwise accessible to the processor 206. As such, whether configured by hardware or by a combination of hardware and software, the processor 206 may represent an entity (e.g., physically embodied in circuitry—in the form of processing circuitry 202) capable of performing operations according to embodiments of the present disclosure while configured accordingly. Thus, for example, when the processor 206 is embodied as an ASIC, FPGA or the like, the processor 206 may be specifically configured hardware for conducting the operations described herein. Alternatively, as another example, when the processor 206 is embodied as an executor of software instructions, the instructions may specifically configure the processor 206 to perform one or more operations described herein. The use of the terms “processor” and “processing circuitry” may be understood to include a single core processor, a multi-core processor, multiple processors internal to the apparatus 200, and/or one or more remote or “cloud” processor(s) external to the apparatus 200.

In some example embodiments, the memory 204 may include one or more non-transitory memory devices such as, for example, volatile and/or non-volatile memory that may be either fixed or removable. In this regard, the memory 204 may comprise a non-transitory computer-readable storage medium. It will be appreciated that while the memory 204 is illustrated as a single memory, the memory 204 may comprise a plurality of memories. The memory 204 may be configured to store information, data, applications, instructions and/or the like for enabling the apparatus 200 to carry out various functions in accordance with one or more example embodiments. For example, the memory 204 may be configured to buffer input data for processing by the processor 206. Additionally or alternatively, the memory 204 may be configured to store instructions for execution by the processor 206. The memory 204 may include one or more databases that may store a variety of files, contents, or data sets. Among the contents of the memory 204, applications may be stored for execution by the processor 206 in order to carry out the functionality associated with each respective application. In some cases, the memory 204 may be in communication with one or more of the processors 206, input/output circuitry 208 and/or communications circuitry 210, via a bus(es) for passing information among components of the apparatus 200.

The input/output circuitry 208 may provide output to the user or an intermediary device and, in some embodiments, may receive one or more indication(s) of user input. In some embodiments, the input/output circuitry 208 is in communication with processor 206 to provide such functionality. The input/output circuitry 208 may include one or more user interface(s) and/or include a display that may comprise the user interface(s) rendered as a web user interface, an application interface, and/or the like, to the display of a user device, a backend system, or the like. The input/output circuitry 208 may be in communication with the processing circuitry 202 to receive an indication of a user input at the user interface and/or to provide an audible, visual, mechanical, or other output to the user. As such, the input/output circuitry 208 may include, for example, a keyboard, a mouse, a joystick, a display, a touch screen display, a microphone, a speaker, and/or other input/output mechanisms. As such, the input/output circuitry 208 may, in some example embodiments, provide means for a user to access and interact with the apparatus 200. The processor 206 and/or input/output circuitry 208 comprising or otherwise interacting with the processor 206 may be configured to control one or more functions of one or more user interface elements through computer program instructions (e.g., software and/or firmware) stored on a memory accessible to the processor 206 (e.g., stored on memory 204, and/or the like).

The communications circuitry 210 may include one or more interface mechanisms for enabling communication with other devices and/or networks. In some cases, the communications circuitry 210 may be any means such as a device or circuitry embodied in either hardware, or a combination of hardware and software that is configured to receive and/or transmit data from/to a network and/or any other device or module in communication with the processing circuitry 202. The communications circuitry 210 may, for example, include an antenna (or multiple antennas) and supporting hardware and/or software for enabling communications with a wireless communication network (e.g., a wireless local area network, cellular network, global positing system network, and/or the like) and/or a communication modem or other hardware/software for supporting communication via cable, digital subscriber line (DSL), universal serial bus (USB), Ethernet or other methods.

In some embodiments, the apparatus 200 may include a data ingestion circuitry 212 which may include hardware components, software components, and/or a combination thereof configured to, with the processing circuitry 202, input/output circuitry 208 and/or communications circuitry 210, perform one or more functions associated with the data ingestion apparatus 106 (as described above with reference to FIG. 1). For example, the data ingestion circuitry 212 may access, facilitate access, receive process, manipulate, provide, or otherwise use, or make available for use, data (e.g., audiovisual data, and/or other data) used by one or more other components of the apparatus 200 through, for example, the use of applications or APIs executed using a processor, such as the processor 206. In some embodiments, the data ingestion circuitry 212 may interact with the memory 204, which may store the aforementioned data. It should also be appreciated that, in some embodiments, the data ingestion circuitry 212 may include a separate processor, specially configured field programmable gate array (FPGA), or application specific interface circuit (ASIC) to provide or otherwise facilitate access to such data used by one or more other components of the apparatus 200. The data ingestion circuitry 212 may also provide for communication with other components of the apparatus, system and/or external systems via a network interface provided by the communications circuitry 210.

In some embodiments, the apparatus 200 may include a data analysis circuitry 214 which may include hardware components, software components, and/or a combination thereof configured to, with the processing circuitry 202, input/output circuitry 208 and/or communications circuitry 210, perform one or more functions associated with the real-time interactive media content system 120 (as described above with reference to FIG. 1). For example, the data analysis circuitry 214 may access, facilitate access, receive process, manipulate, provide, or otherwise use, or make available for use, certain data (e.g., audiovisual inputs, audiovisual responses, textual input data, contextual response data, performance analysis data objects, audiovisual suggestions, tiered sequences of real-time interactive media content, contextual interaction data, and/or other data) used by one or more other components of the apparatus 200 through, for example, the use of applications or APIs executed using a processor, such as the processor 206. In some embodiments, the data analysis circuitry 214 may interact with the memory 204, which may store the aforementioned data. It should also be appreciated that, in some embodiments, the data analysis circuitry 214 may include a separate processor, specially configured field programmable gate array (FPGA), or application specific interface circuit (ASIC) to receive such data utilized by the data analysis circuitry 214. The data analysis circuitry 214 may also provide for communication with other components of the apparatus, system and/or external systems via a network interface provided by the communications circuitry 210.

In some embodiments, the apparatus 200 may include an audiovisual data circuitry 216 which may include hardware components, software components, and/or a combination thereof configured to, with the processing circuitry 202, input/output circuitry 208 and/or communications circuitry 210, perform one or more functions associated with the real-time interactive media content system 120 (as described above with reference to FIG. 1). For example, the audiovisual data circuitry 216 may access, facilitate access, receive process, manipulate, provide, or otherwise use, or make available for use, certain data e.g., audiovisual inputs, audiovisual responses, contextual response data, audiovisual suggestions, contextual interaction data, and/or the like) used by one or more other components of the apparatus 200 through, for example, the use of applications or APIs executed using a processor, such as the processor 206. In some embodiments, the audiovisual data circuitry 216 may interact with the memory 204, which may store the aforementioned data. It should also be appreciated that, in some embodiments, the predictive data analysis circuitry 216 may include a separate processor, specially configured field programmable gate array (FPGA), or application specific interface circuit (ASIC) to manage access and use of such data. The audiovisual data circuitry 216 may also provide for communication with other components of the apparatus, system and/or external systems via a network interface provided by the communications circuitry 210.

In some embodiments, the apparatus 200 may include a data generation circuitry 218 which may include hardware components, software components, and/or a combination thereof configured to, with the processing circuitry 202, input/output circuitry 208 and/or communications circuitry 210, perform one or more functions associated with the real-time interactive media content system 120 (as described above with reference to FIG. 1). For example, the data generation circuitry 218 may access, facilitate access, receive process, manipulate, provide, or otherwise use, or make available for use, certain data (e.g., audiovisual responses, textual input data, contextual response data, performance analysis data objects, audiovisual suggestions, tiered sequences of real-time interactive media content, contextual interaction data, and/or other data) used by one or more other components of the apparatus 200 through, for example, the use of applications or APIs executed using a processor, such as the processor 206. In some embodiments, the data generation circuitry 218 may interact with the memory 204, which may store the aforementioned data. It should also be appreciated that, in some embodiments, the data generation circuitry 218 may include a separate processor, specially configured field programmable gate array (FPGA), or application specific interface circuit (ASIC) to receive such data utilized by the data generation circuitry 218. The data generation circuitry 218 may also provide for communication with other components of the apparatus, system and/or external systems via a network interface provided by the communications circuitry 210.

In this regard, FIG. 1 shows an example system environment 100 within which at least some embodiments of the present disclosure may operate. The depiction of the example system environment 100 is not intended to limit or otherwise confine the embodiments described and contemplated herein to any particular configuration of elements or systems, nor is it intended to exclude any alternative configurations or systems for the set of configurations and systems that can be used in connection with embodiments of the present disclosure. Rather, FIG. 1 and the system environment 100 disclosed therein is merely presented to provide an example basis and context for the facilitation of some of the features, aspects, and uses of the methods, apparatuses, computer readable media, and computer program products disclosed and contemplated herein.

As shown in FIG. 1, the example system environment 100 includes a real-time interactive media content system 120 and one or more user devices 102. The real-time interactive media content system 120 includes an audiovisual media content engine 130, interaction engine 140, multimodal performance analysis engine 150, data ingestion apparatus 160, and contextual interaction data repository 170. The real-time interactive media content system 120 may be in communication with one or more of the user device(s) 102.

It will be understood that while many of the aspects and components presented in FIG. 1 are shown as discrete, separate elements, other configurations may be used in connection with the methods, apparatuses, computer readable media, and computer programs described herein, including configurations that combine, omit, separate, and/or add aspects and/or components. For example, in some embodiments, the functions of one or more of the illustrated components in FIG. 1 may be performed by a single computing device or by multiple computing devices, which devices may be local or cloud based. It will be appreciated that the various functions performed by the real-time interactive media content system 120 and the user device(s) 102 may be embodied by a single apparatus, subsystem, or system comprising one or more sets of computing hardware (e.g., processor(s) and memory) configured to perform various functions thereof.

In some embodiments, the real-time interactive media content system 120 or portions thereof (e.g., one or more components of the real-time interactive media content system 120) may be embodied by a user device 102. The real-time interactive media content system 120 may be configured to provide a platform, such as a mobile application platform and/or a web application platform for access by a user. In this regard, the mobile application platform may be accessed by a user device 102 via an application installed in the user device 102. Further, the web application platform may be accessed by a user device 102 via a web browser, mobile browser application (e.g., a Wireless Application Protocol browser), and/or the like.

In some embodiments, a user device 102 is electronic computing device that may be used by a user for any of a variety of purposes including, but not limited to, one or more of sending and/or receiving signals, storing data, displaying data, viewing data, or initiating predictive performance analysis computing task(s). For example, the user device 102 may be capable of, but not limited to, one or more of displaying renderable virtual widgets on the screen of the user device 102, receiving user input that triggers predictive data analysis task(s), determining and/or receiving location data that triggers dynamic update of a screen of the user device 102 and/or information displayed on the screen of the user device 102, or delivering graphical representations to a user.

A user device 102 may include computer hardware and/or software configured to perform one or more functionalities associated with the user device 102. In some examples, the user device 102 may be a mobile device. The mobile device may be a user device that is capable of being held and transported by a user. Example mobile devices include, but not limited to, smart phones, tablet computers, laptop computers, wearables, laptop computers, or the like. In some embodiments, the user device 102 may include one or more sensors, systems, or the like configured for determining location data or otherwise the location of the user device 102. For example, the user device 102 may include a global position system (GPS) and/or other sensor systems or devices configured to determine the absolute location data for the user device 102.

In the illustrated embodiment of FIG. 1, the multimodal performance analysis engine 150 includes behavioral analysis engine 150A configured to facilitate performance of one or more functions of the multimodal performance analysis engine 150. The behavioral analysis engine 150A includes one or more audio analysis models 150B, video analysis models 150C which may be used in combination with the one or more rules analysis models 150D to facilitate performance of one or more functions of the multimodal performance analysis engine 150. As further shown in FIG. 1, the data ingestion apparatus 160 includes data processing models 162 which includes one or more audio processing models 162A and video processing models 162B configured to facilitate performance of one or more functions of the data ingestion apparatus 160.

In some embodiments, the functions of one or more of the illustrated components of the real-time interactive media content system 120 may be performed by a single computing device or by multiple computing devices, which devices may be local or cloud based. It will be appreciated that the various functions performed by two or more of the audiovisual media content engine 130, interaction engine 140, multimodal performance analysis engine 150, data ingestion apparatus 160, and/or contextual interaction data repository 170 may be performed by a single apparatus, subsystem, or system. For example, two or more of the audiovisual media content engine 130, interaction engine 140, multimodal performance analysis engine 150, data ingestion apparatus 160, and/or contextual interaction data repository 170 may be embodied by a single apparatus, subsystem, or system comprising one or more sets of computing hardware (e.g., processor(s) and memory) configured to perform various functions thereof.

The various functions of the real-time interactive media content system 120 and system environment 100 may be performed by other arrangements of one or more computing devices and/or computing systems without departing from the scope of the present disclosure. In some embodiments, a computing system may comprise one or more computing devices (e.g., server(s)).

The various components illustrated in the real-time interactive media content system 120 and system environment 100 may be configured to communicate via one or more communication mechanisms, including wired or wireless connections, such as over a network, bus, or similar connection. For example, a network may include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, etc.). For example, the network may include a cellular telephone, an 802.11, 802.16, 802.20, and/or WiMAX network. Further, a network may include a public network, such as the Internet, a private network, such as an intranet, or combinations thereof, and may utilize a variety of networking protocols now available or later developed including, but not limited to TCP/IP based networking protocols.

In various embodiments, the components depicted in FIG. 1 as being included in the real-time interactive media content system 120, although not required to be an integral system, may be connected via one or more networks. In some embodiments, one or more APIs may be leveraged to communicate with and/or facilitate communication between one or more of the components illustrated in the real-time interactive media content system 120 and system environment 100.

### Example Data Flows of the Disclosure

FIG. 3 is an example data flow 300 presented in accordance with one or more embodiments of the present disclosure. In some example embodiments, the data structures and processes shown and described with respect to the data flow diagram of FIG. 3 may be generated, performed, and/or otherwise facilitated by the various systems and apparatuses shown and described with respect to FIGS. 1-2.

In some embodiments, one or more audiovisual inputs 302 associated with a user are received. For example, the audiovisual inputs 302 may be received from the user device 102 associated with a user. The audiovisual inputs 302 may include a user audio component including audio data of the user and a user video component including one or more images of the user. In some embodiments, the one or more audiovisual inputs 302 associated with a user are captured via a user device 102 including at least one audio capture component and at least one video capture component. The audiovisual inputs 302 may be received by the data ingestion apparatus 160. As described with respect to FIG. 1, the data ingestion apparatus 160 may perform one or more processing operations on the audiovisual inputs 302 including, but not limited to, generating one or more textual input data sets 306 to be provided to the interaction engine 140.

In some embodiments, the audiovisual input 302 may include one or more audio components and/or video components. For example, the audiovisual input 302 may include audio data and/or video data of a user interacting with real-time interactive media content. In some examples, the audiovisual input 302 may be associated with a user, real-time interactive media content, one or more audio processing operations and/or video processing operations (e.g., via data ingestion apparatus 160, interaction engine 140, and/or multimodal performance analysis engine 150), the interaction engine 140, the multimodal performance analysis engine 150, and/or the like. In some examples, the audiovisual input 302 may be converted into one or more textual input data sets 306. For example, the audiovisual input 302 may be input into one or more machine learning models (e.g., via data ingestion apparatus 160, interaction engine 140, and/or multimodal performance analysis engine 150), configured to output one or more textual input data sets based on the audiovisual input. In some examples, the audiovisual input 302 may be captured by any type of input devices, including but not limited to one or more audio capture components and/or video capture components such as, for example, a camera, microphone, webcam, smartphone, tablet, conference recording device, and/or the like (e.g., user device 102).

As described above with respect to FIG. 1, one or more components or models described herein may be configured to convert at least one of the user audio component and/or the user video component to one or more textual input data sets 306. For example, the data ingestion apparatus 160 may convert the user audio component and/or the user video component included within the audiovisual input 302 to one or more textual input data sets 306. Additionally or alternatively, the audiovisual input 302 may be provided directly to the interaction engine 140 and/or the multimodal performance analysis engine 150. In such a case, the interaction engine 140 and/or multimodal performance analysis engine 150 may be configured to directly process the audiovisual input 302 (e.g., to generate a textual input data set). The data ingestion apparatus 160 may, in some embodiments, be optionally included or excluded. In an embodiment where the data ingestion apparatus 160 is optionally excluded, the interaction engine 140 may generate a textual input data set from the audiovisual input 302.

In some embodiments, converting at least one of the user audio component or the user video component to one or more textual input data sets includes applying a natural language processing engine to the audio component comprising the audio data of the user to generate one or more transcripts associated with the user audio component. For example, the data ingestion apparatus 160 may apply a natural language processing model to an audio component of audiovisual input 302 to generate the textual input data set 306 including one or more transcripts associated with the user audio component. In another example, the interaction engine 140 may directly receive audiovisual input 302 and apply a natural language processing model to an audio component of the audiovisual input 302 to generate a textual input data set including one or more transcripts associated with the user audio component. In some embodiments, the interaction engine 140 may be associated with an API. Accordingly, inputting one or more textual input data sets 306 into the interaction engine 140 may include formatting the one or more textual input data sets 306 based at least in part on the API and inputting the one or more formatted textual input data sets 306 into the interaction engine 140 via the API. For example, the data ingestion apparatus 160 may format the textual input data 306 according to an API and input the textual input data set 306 to the interaction engine 140 via the API.

In some embodiments, the one or more textual input data sets 306 may be input into the interaction engine 140 configured to generate the one or more contextual response data sets 340 based at least in part on the one or more textual input data sets 306. In some embodiments, the interaction engine 140 is trained using contextual interaction data 370 including audiovisual data of interactive engagements (e.g., previous human-to-human recorded interactions). Additionally or alternatively, the interaction engine 140 may be configured to generate the contextual response data set 340 based at least in part on the contextual interaction data 370. Additionally or alternatively, in some embodiments, one or more contextual response data sets 340 may be based at least in part on one or more predefined answers based on contextual interaction data 370. For example, the interaction engine 140 may generate the contextual response data set 340 based on one or more answers defined by the contextual interaction data 370. Additionally or alternatively, in some embodiments, the contextual interaction engine may be configured to generate one or more contextual response data sets 340 based at least in part on a variability parameter configured to provide variability in the interaction engine's output. For example, if a user of user device 102 were to repeat interactions with the real-time interactive media content in similar manners such that the textual input data sets 306 provided to the interaction engine 140 were substantially the same across the repeat interactions (e.g., the user says the same thing in different simulated training sessions), the interaction engine 140 may generate different contextual response data sets 340 such that the interactions do not proceed identically each time (e.g., the real-time interactive media content may not respond the same way in different simulated training sessions given the same inputs).

Responsive to one or more contextual response data sets 340, in some embodiments, the audiovisual media content engine 130 may be configured to generate one or more audiovisual responses 330 to the one or more audiovisual inputs 302 based at least in part on the one or more contextual response data sets 340. The one or more audiovisual responses 330 may include audio outputs configured to be played to the user (e.g., via an audio output component of user device 102) and simulated facial expressions configured to be displayed to the user (e.g., via a video output component of the user device 102).

In some embodiments, the data ingestion apparatus 160 may provide audiovisual data 304 to the multimodal performance analysis engine 150. Audiovisual data 304 may include the audiovisual input 302, portions thereof (e.g., an audio component or a video component), data derivative thereof (textual input data sets, processed audiovisual data, metadata, separated or isolated audio data and/or video data), and/or the like. For example, although not shown in FIG. 3, one or more textual input data sets 306 may be provided to the multimodal performance analysis engine 150 as a part of, in place of, and/or in addition to the audiovisual data 304. Additionally or alternatively, the audiovisual input 302 may be provided directly to the multimodal performance analysis engine 150 (e.g., in an embodiment where the data ingestion apparatus is optionally excluded). As described above with respect to FIG. 1, the multimodal performance analysis engine 150 may be trained to generate one or more performance analysis data objects 350 based at least in part on the audiovisual input 302 and/or audiovisual data 304. Additionally or alternatively, the multimodal performance analysis engine 150 may be trained to generate performance analysis data objects 350 based at least in part on contextual interaction data 370. For example, the multimodal performance analysis engine 150 may be trained on various contextual interaction data 370 configured for training one or more machine learning models. In various examples, the contextual interaction data 370 may include training data such as, training data configured for supervised learning, unsupervised learning, semi supervised learning, and/or the like. Examples of training data included within contextual interaction data 370 include, but are not limited to, image data labeled for posture classification, facial recognition, eye gaze detection, and/or the like, audio data labeled for speech recognition, tonal classification, intent recognition, and/or the like, and textual data labeled for sentiment recognition, intent recognition, topic classification, and/or the like. In some examples, the multimodal performance analysis engine 150 may include one or more models configured for different machine learning tasks where each model is trained on a different subset of contextual interaction data 370 configured for a respective machine learning task.

In some embodiments, the multimodal performance analysis engine 150 may be trained to generate performance analysis data objects 350 based at least in part on predetermined criteria data 310 (e.g., predetermined attention criteria data, predetermined scoring criteria data). For example, in some embodiments, the multimodal performance analysis engine 150 may be trained using reinforcement learning data received from human feedback based at least in part on predetermined attention criteria data. In some examples, the predetermined attention criteria data may be indicative of at least one or more audio-based features or one or more video-based features to be used in generating the one or more performance analysis data objects 350. The one or more audio-based features and/or the one or more video-based features may be analyzed as a combined audiovisual feature set and/or separately as distinct audio and video analyses. Additionally or alternatively, the reinforcement learning data received from human feedback may be based at least in part on predetermined scoring criteria data including one or more weights respective to the predetermined attention criteria data. In some embodiments, the multimodal performance analysis engine 150 may use the predetermined criteria data 310 indicative of one or more predefined answers and respective weights and audiovisual data 304 to identify whether a user of user device 102 interacting with real-time interactive media content responded with any of the predefined answers (given the corresponding question was prompted) and apply the respective weights of any such answer when generating performance analysis data objects 350.

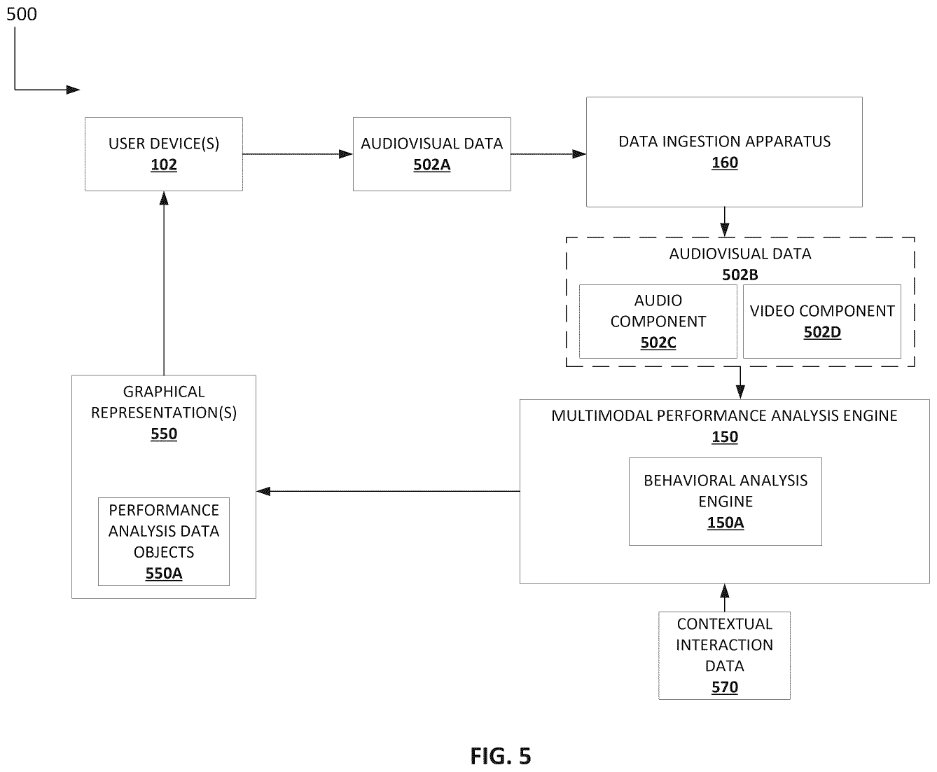

In various embodiments, performance analysis data objects 350 and other outputs of the multimodal performance analysis engine 150 (e.g., audiovisual suggestions, tiered sequences of real-time interactive media content) may be used to maximize the value of a simulated training program provided to a user. For example, tiered sequences of real-time interactive media content may be used to update training frequency recommendations for users and track which types of training a user needs (e.g., which experience ratings a user should train with, which simulated personality types a user should train with, which features a user should pay attention to improving, or combinations thereof) based on performance analysis data objects 350. In this manner, the simulated training provided by real-time interactive media content may adapt to a user over time and respond dynamically to the needs of a user. Additionally, the multimodal performance analysis data objects 350, as described with respect to FIG. 5, may be presented to users via graphical representations which may provide insights into a user's past performances and the progress a user is making. In this manner, the user may track their own performance and gain various insights into how they are performing. In various embodiments, simulated training programs may be structured to provide users with progressive difficulty and skill usage. For example, users may be initially presented with real-time interactive media content configured to expose users to easier training (e.g., using real-time interactive media content associated with lower experience ratings, using easier scoring with performance analysis data objects, scoring on few features, scoring with rules that are easier to satisfy), and as users progress, exposing user to more difficult training (e.g., using real-time interactive media content associated with higher experience ratings, using harder scoring with performance analysis data objects, scoring on more features, scoring with rules that are more difficult to satisfy). In some embodiments, such structure may be defined and/or controlled by tiered sequences of real-time interactive media content generated by the multimodal performance analysis engine 150.

In some embodiments, real-time interactive media content may be generated based on one or more variables (e.g., defined, directed, and/or controlled by tiered sequences of real-time interactive media content) configured to modify and/or control a user's interaction with the real-time interactive media content. In a non-limiting example, a first-time user beginning a training program facilitated by real-time interactive media content may initially be presented with real-time interactive media content associated with a low experience rating. As such, the audiovisual media content engine 130 may be configured to generate audiovisual responses that make interaction with the real-time interactive media content easier for the user. For example, the audiovisual media content engine 130 may be configured to output audiovisual responses 330 associated with a simulated personality type configured to represent a happy customer that is ready to buy a vehicle. For example, the simulated interactive entity may smile frequently, use a friendly tone, and assume a friendly posture. Additionally, the audiovisual media content engine 130 may be configured to provide audiovisual responses 330 to the user device 102 in turn of conversation (e.g., waiting until a threshold duration of time passes after the user stops speaking before causing the simulated interactive entity to respond). Additionally, the interaction engine 140 may be configured to generate contextual response data sets 340 that are agreeable with statements made by the user (e.g., complying with offers and suggestions made by the user). Additionally, the multimodal performance analysis engine 150 may be configured to use one or more techniques to cause easier scoring of the user when generating performance analysis data objects 350, such as, for example, using a limited feature set (e.g., ignoring one or more features such as tonal analysis, posture analysis, and/or the like) and/or using curved scoring (e.g., providing additional points to a user's scores based on the scores of other users).

Continuing the above non-limiting example, as the user progresses through the training program facilitated by the real-time interactive media content, the user may be presented with real-time interactive media content associated with different variables (e.g., defined and/or controlled by tiered sequences of real-time interactive media content) configured to modify and/or control the user's interaction with the real-time interactive media content dynamically without requiring pre-generated content (e.g., videos, articles, etc.). For example, the user may be presented with progressively more difficult interactions using the real-time interactive media content generation systems discussed herein as informed by the tiered sequence. Such interactions may span a greater domain of content, include more difficult scoring techniques, and/or the like and may be delivered remotely on-the-fly while remaining customized for the user. Such variables of the real-time interactive media content may be predefined by the training program. For example, a predetermined decision tree may provide a structure for the training program through which a user may progress. Each stage of the decision tree may define one or more variables for the real-time interactive media content presented to the user. In some examples, a tiered sequence of real-time interactive media content may comprise or otherwise be associated with such a predetermined decision tree. Additionally or alternatively, such variables may be autonomously or semi-autonomously managed by the training program based at least in part on the performance of the user (e.g., as indicated by historic performance analysis data objects associated with the user). For example, the training program may use a scaling system in which real-time interactive media content is configured to be more or less difficult in association with an experience rating of the user. In some embodiments, large volumes (e.g., hundreds or more) of tiered sequences may be autonomously managed and remotely distributed to a plurality of locations due to the efficiencies and other improvements described herein. Similarly, the aforementioned models and generated real-time interactive media content may be customized or otherwise tuned for each user, which may solve unique regional or linguistic issues (both visual and audio-based issues) caused by inaccurate models or pre-generated content without losing the benefit of scale afforded by the embodiments of the present disclosure. For example, a library of simulated entities (e.g., digital humans) may be selected from and customized for each user in some embodiments.

Continuing the above non-limiting example, as a result of the user progressing through the training program facilitated by real-time interactive media content, the user may be presented with real-time interactive media content associated with a high experience rating. As such, the audiovisual media content engine 130 may be configured to generate audiovisual responses that make interaction with the real-time interactive media content more difficult for the user. For example, the audiovisual media content engine 130 may be configured to output audiovisual responses 330 associated with a simulated personality type configured to represent an unhappy customer that is reluctant to buy a vehicle. For example, the simulated interactive entity may frown, use an unfriendly tone, and assume an unfriendly posture (e.g., crossed arms). Additionally, the audiovisual media content engine 130 may be configured to provide audiovisual responses 330 to the user device 102 out of turn of conversation (e.g., causing the simulated interactive entity to respond while the user is still speaking). Additionally, the interaction engine 140 may be configured to generate contextual response data sets 340 that are disagreeable with statements made by the user (e.g., objecting to statements made by the user). Additionally, the multimodal performance analysis engine 150 may be configured to use one or more techniques to cause more difficult scoring of the user when generating performance analysis data objects 350, such as, for example, using an expansive feature set (e.g., using one or more features such as tonal analysis, posture analysis, and/or the like) forcing the user to score over a certain benchmark to pass (e.g., failing the user for scoring under an 80% score in any analysis), checking for an expansive list of predefined content which the user is supposed to mention during the interaction, and/or the like.

In various embodiments, one or more performance analysis data objects 350 may be stored in a repository for later retrieval. Performance analysis data objects 350 may be stored (e.g., in association with metadata describing each performance analysis data object) such that they may be organized for later retrieval and use (e.g., modifying variables of real-time interactive media content as described above, in various analyses and graphical representations, and/or the like). For example, a user may wish to view their own progress over time. As such, one or more historical performance analysis data objects associated with the user may be retrieved from a repository and used to generate a corresponding graphical representation. In another example, an administrator may wish to view the progress of one or more individuals within a tiered sequence, view the analyses and assumptions underlying the tiered sequence, and/or modify or supplement an existing tiered sequence. As such, one or more historical performance analysis data objects respective to the one or more individuals may be retrieved from a repository and used to generate a corresponding graphical representation. In another example, an administrator may wish to identify any individuals who have, for example, received a certain number of scores below a certain benchmark or otherwise compare multiple users across one or more metrics. As such, one or more historical performance analysis data objects matching such criteria may be retrieved from a repository along with data identifying any respective individuals associated with the performance analysis data objects. In yet another example, an administrator may wish to view various summary statistic of performance analysis data for a cohort of individuals (e.g., all individuals associated with a particular location). As such, performance analysis data objects respective to individuals within the cohort may be retrieved from a repository and used to generate one or more corresponding graphical representations. The various examples for storing, retrieving, and processing performance analysis data objects 350 described herein may be performed by the multimodal performance analysis engine 150.

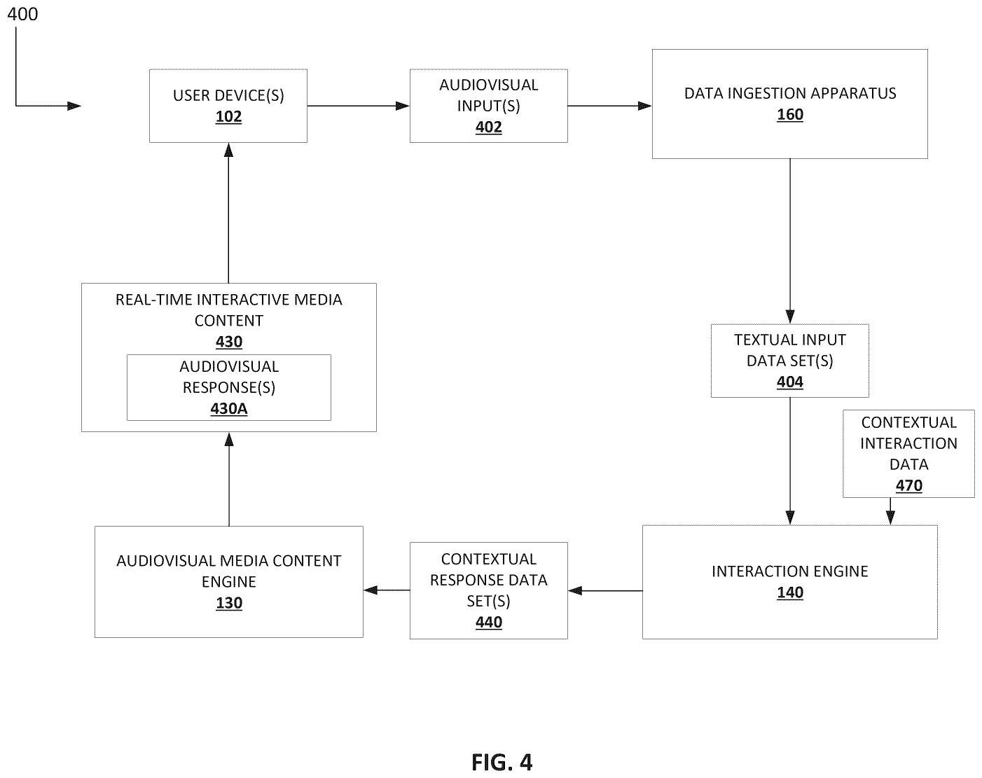

FIG. 4 is an example data flow 400 presented in accordance with one or more embodiments of the present disclosure. In some example embodiments, the data structures and processes shown and described with respect to the data flow diagram of FIG. 4 may be generated, performed, and/or otherwise facilitated by the various systems and apparatuses shown and described with respect to FIGS. 1-2. The process shown in FIG. 4 may be performed based on the same data or same type of data (e.g., audiovisual inputs 402) as one or more other processes (e.g., the process shown in FIG. 5). In some embodiments, the processes shown in FIG. 4 and FIG. 5 may be performed in parallel or sequentially with each other. In some embodiments, the process of FIG. 4 may occur in real time to generate the interaction between the simulated entity and the user while the process of FIG. 5 may occur following a particular user session (e.g., training session) or at another delayed interval or cumulative analysis.

In some embodiments, one or more audiovisual inputs 402 may be provided to data ingestion apparatus 160. As described with respect to FIG. 1 and FIG. 3, in some embodiments, the data ingestion apparatus 160 may be optionally included or excluded, and as such, the audiovisual inputs 402 may be optionally provided directly to the interaction engine 140 configured to generate a textual input data set. The interaction engine 140 may be configured to output one or more contextual response data sets 440 based on the textual input data sets 404. Additionally or alternatively, the interaction engine 140 may be configured to output the contextual response data sets 440 based at least in part on the contextual interaction data 470. The contextual response data sets 440 may be provided to the audiovisual media content engine 130. In some embodiments, the interaction engine 140 may be configured to input the one or more contextual response data sets 440 into the audiovisual media content engine 130 to generate the one or more audiovisual responses 430A.

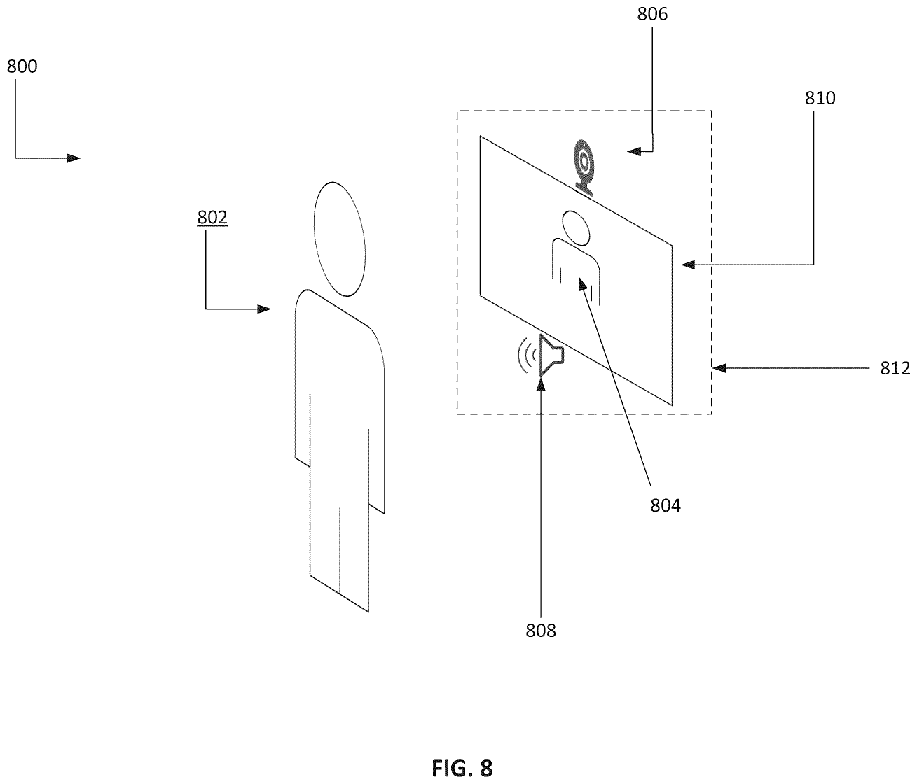

The audiovisual media content engine 130 may be configured to output the real-time interactive media content 430 including, but not limited to, the audiovisual responses 430A. For example, ongoing real-time interactive media content 430 may be configured to provide the audiovisual responses 430A in real-time in response to a user of user device 102 interacting with the real-time interactive media content 430. As described with respect to FIG. 8, the real-time interactive media content 430 may be representative of a simulated interactive entity configured to provide the audiovisual responses 430A, for example, to provide a simulated training session for the user of user device 102.

In various embodiments, one or more of the processes of FIG. 4 may be continuous. For example, one or more processes may be performed in parallel to maintain continuous input data streams and continuous output data streams. For example, audiovisual inputs 402 may be received as continuous data streams processed in parallel with the generation of textual input data sets 404, contextual response data sets 440, and/or audiovisual responses 430A. In this manner, embodiments described herein may maintain a seamless presentation of real-time interactive media content 430 to a user of user device 102 via a continuous output that may be generated and/or updated simultaneously as audiovisual inputs 402 of the user are captured and provided to the real-time interactive media content system 120. Likewise, a plurality of users may be simultaneously presented with different, seamless presentation of real-time interactive media content.

FIG. 5 is an example data flow 500 presented in accordance with one or more embodiments of the present disclosure. In some example embodiments, the data structures and processes shown and described with respect to the data flow diagram of FIG. 5 may be generated, performed, and/or otherwise facilitated by the various systems and apparatuses shown and described with respect to FIGS. 1-2.

As described with respect to FIG. 1 and FIG. 3, audiovisual data 502 may be received by the data ingestion apparatus 160 from user device 102. In some examples, the data ingestion apparatus 160 may output audiovisual data 502B to the multimodal performance analysis engine 150. The audiovisual data 502B may include the same audiovisual data as audiovisual data 502A, portions thereof, or data derivative thereof. As shown, audiovisual data 502B includes an audio component 502C and video component 502D. For example, the data ingestion apparatus 160 may separate the audio data and the video data of audiovisual data 502A and provide the separated data to the multimodal performance analysis engine 150 as two separate streams (e.g., audio component 502C and video component 502D of audiovisual data 502B) to optimize processing efficiency of the multimodal performance analysis engine 150. The multimodal performance analysis engine 150 may be configured to generate the performance analysis data objects 550A based at least in part on the audiovisual data 502B (e.g., using the behavioral analysis engine 150A and one or more rules analysis models). In some embodiments, the multimodal performance analysis engine 150 may generate the performance analysis data objects 550A based at least in part on the contextual interaction data 570.

In some embodiments, the performance analysis data objects 550A may be provided to the user device 102 as graphical representations 550. In some embodiments, visual feedback interfaces may be programmatically generated based at least in part on one or more performance analysis data objects 550A where the one or more visual feedback interfaces include programmatically generated graphical representations 550 determined based at least in part on the one or more performance analysis data objects 550A. In some embodiments, the multimodal performance analysis engine 150 may be configured to generate one or more audiovisual suggestions (not shown) based at least in part on the one or more performance analysis data objects 550A where the programmatically generated graphical representations 550 are based at least in part on the one or more audiovisual suggestions.

Additionally or alternatively, in some embodiments, the multimodal performance analysis engine 150 may be configured to generate a tiered sequence of real-time interactive media content (not shown) including a recommended training plan for a user of user device 102 associated with a time interval and based at least in part on one or more historical performance analysis data objects associated with the user.

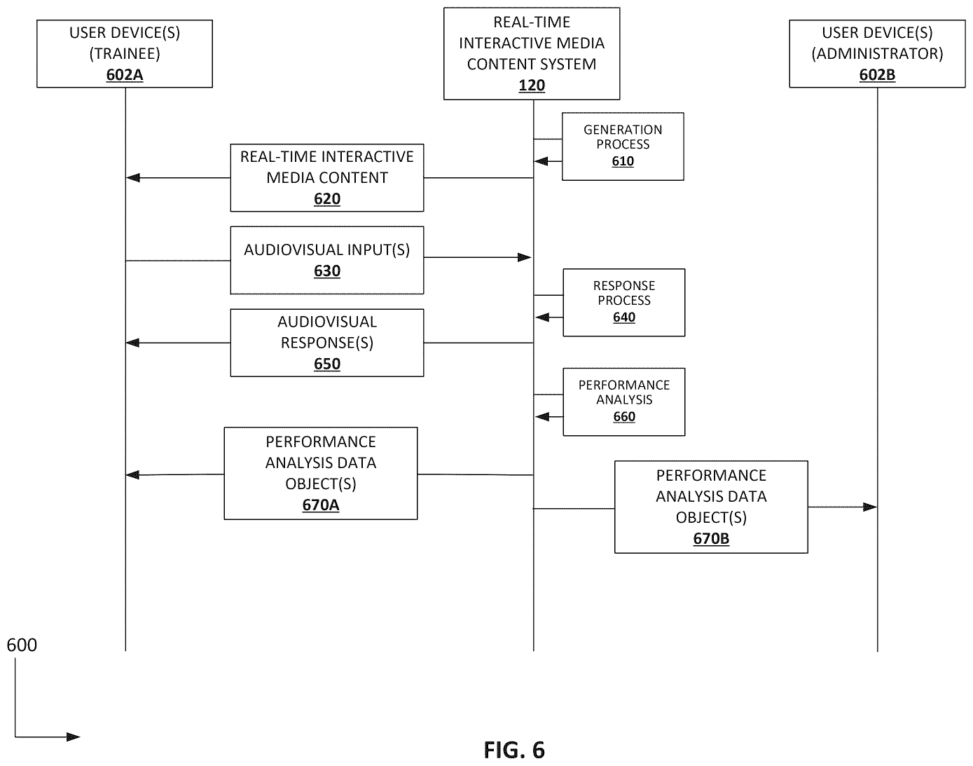

FIG. 6 is an example data flow 600 presented in accordance with one or more embodiments of the present disclosure. In some example embodiments, the data structures and processes shown and described with respect to the data flow diagram of FIG. 6 may be generated, performed, and/or otherwise facilitated by the various systems and apparatuses shown and described with respect to FIGS. 1-2.

As shown, various data entities and processes may be received and or transmitted between the user device 602A, the real-time interactive media content system 120, and the user device 602B. The user device 602A may be a user device associated with a trainee mode and the user device 602B may be a user device associated with an administrator mode. In some examples, the user device 602A and user device 602B may be the same user device or different user devices. For example, the user device 602A may refer to the same user device as user device 602B where the user device 602A is in a trainee mode and the user device 602B is in an administrator mode. The user device may be in a trainee mode or administrator mode based on a user or user profile associated with the user of the devices. For example, a user who is a trainee in a simulated training program facilitated by real-time interactive media content may use the user device 602A in a trainee mode while an administrator (e.g., an administrator of the simulated training program, a manager of the trainees, and/or the like) associated with the simulated training program may use the user device 602B (being the same user device as 602A) in an administrator mode. Alternatively, the user devices 602A and 602B may be separate devices used respectively by a trainee and administrator.

As described with respect to FIG. 1 and FIG. 3, the real-time interactive media content system 120 may generate real-time interactive media content 620 during generation process 610. For example, generation process 610 may include generating, via the audiovisual media content engine 130, real-time interactive media content 620 (e.g., audio data and video data of a simulated interactive entity rendered by the real-time interactive media content system 120), instructions configured to control real-time interactive media content (instructions to control a simulated interactive entity rendered at the user device 602A or a cloud server), and/or the like. The real-time interactive media content 620 (or instructions configured to control real-time interactive media content) may be provided to the user device 602A and consequently output to the user, for example, by playing audio and displaying video of the real-time interactive media content 620. The user of user device 602A may interact with (e.g., speak to, respond to) the real-time interactive media content 620. Audio and video data of the user interacting with the real-time interactive media content 620 may be captured by the user device 602A and transmitted back to the real-time interactive media content system 120 as audiovisual inputs 630.

The real-time interactive media content system 120 may analyze the audiovisual inputs 630 (e.g., via the data ingestion apparatus 160, interaction engine 140, audiovisual media content engine 130) and generate one or more audiovisual responses 650 in a response process 640. For example, the interaction engine 140 may process the audiovisual inputs 630 to generate one or more contextual response data sets, provide the one or more contextual response data sets to the audiovisual media content engine 130, and, in response to the one or more contextual response data sets, the audiovisual media content engine 130 may generate and provide one or more audiovisual responses 650 to the user device 602A. The real-time interactive media content system 120 may provide the audiovisual responses 650 back to the user device 602A to be played and displayed to the user in response to the audiovisual inputs 630. Additionally, the real-time interactive media content system 120 may generate one or more performance analysis data objects 670A and/or 670B during performance analysis 660 (e.g., via the multimodal performance analysis engine 150). The performance analysis data objects 670A may be provided to the user device 602A and the performance analysis data objects 670B may be provided to the user device 602B. Accordingly, the performance analysis data objects 670A may be configured in accordance with a trainee mode while the performance analysis data objects 670B may be configured in accordance with an administrator mode. In this manner, embodiments described herein may provide performance analysis data tailored for trainees of a simulated training program such as, for example, employees, as well as performance analysis data tailored for administrators associated with a simulated training program, such as, for example, managers of trainees. As described with respect to FIG. 5, the real-time interactive media content system 120 may further generate one or more graphical representations for the user device 602A and/or the user device 602B respectively associated with a trainee mode or an administrator mode.

In various embodiments, the performance analysis data objects 670A provided to the user device 602A may be used to provide various performance analysis insights to the user in addition to or instead of informing a tiered sequence of real-time interactive media content. The user of user device 602A may be, for example, a sales associate, F&I representative, and/or the like. In a non-limiting contextual example, the user of user device 602A may be a sales associate of a vehicle sales business (e.g., a dealership) enrolled within a training program facilitated by the real-time interactive media content system 120. Accordingly, the performance analysis data objects 670A may be used to show (e.g., via various graphical representations) the sales associate their progress in the training program such as which portions of the training program they have completed (e.g., based on a tiered sequence of real-time interactive media content), how long they take to progress through the portions of the training program (e.g., how long it takes to complete one or more tiers of a tiered sequence of real-time interactive media content), how long they take to progress through the portions of the training program compared to a benchmark (e.g., compared to a cohort of other users), particular scores associated with their interactions with real-time interactive media content (e.g., a score indicating they only provided legal disclosure 70% of the times necessary), how their scores have progressed over time, how their scores correlate with one or more variables of real-time interactive media content (e.g., how they perform when interacting with a particular simulated personality type, how they perform when interacting with a simulated entity of an older man, how they perform when interacting with a simulated entity of a younger woman, etc.), how often they have trained over a certain time interval, how their scores compare with a cohort of other users (e.g., how their scores compare to the average score of other sales associates who work at the same location), how their scores compare with another individual user (e.g., how their scores compare to one or more scores of another particular sales associate), specific skills they underperform on (e.g., informing the sales associate they only provide required legal disclosures 70% of the time), and/or the like.

In some embodiments, the performance analysis data objects 670B provided to an administrator user device 602B may be used to provide various performance analysis insights to the user. Continuing the above non-limiting contextual example, the user of user device 602B may be a manager of a vehicle sales business (e.g., a dealership) where the sales associates managed by the manager are enrolled within the training program facilitated by the real-time interactive media content system 120. Accordingly, the performance analysis data objects 670B may be used (e.g., via various graphical representations) to show the manager the progress of the sales associates enrolled within the training program such as which portions of the training program they have completed, how long they take to progress through portions of a training program (e.g., how long it takes the sales associates to complete one or more tiers of a tiered sequence of real-time interactive media content, such as a time per training session), how long they take to progress through the portions of the training program compared to a benchmark (e.g., compared to a cohort of other sales associates), particular scores associated with interactions with real-time interactive media content (e.g., a score indicating a sales associate only provided legal disclosure 70% of the times necessary), how their scores have progressed over time, how their scores correlate with one or more variables of real-time interactive media content (e.g., how the sales associates perform when interacting with a particular simulated personality type, how they perform when interacting with a simulated entity of a younger man, how they perform when interacting with a simulated entity of an older woman, etc.), how often the sales associates train over a certain time interval, how the sales associates scores compare with a cohort of other users (e.g., how the average scores of the sales associates at the same dealership compare with the average scores of sales associates at another dealership), and/or the like. Additionally or alternatively, the manager may be able to query the performance analysis data objects 670B to make various determinations such as, for example, which sales associates have scored beneath a certain threshold, which sales associates have progressed through the training program beyond a certain threshold (e.g., based on a tiered sequence of real-time interactive media content), which sales associates have trained least frequently, which sales associates have improved their scores the most over a certain time interval, and/or the like. Additionally or alternatively, a user of user device 602B may be associated with a certain level of authorization and/or access within the administrator mode. For example, one user of the user device 602B may be a manager of a single team and have access to view and/or manage data associated with the users (e.g., sales associates, F&I representatives, etc.) of the single team, another user of the user device 602B may be a manager of a single location or other group comprising several teams and have access to view and/or manage data associated with the several teams of the single location, yet another user of the user device 602B may be a manager of several locations (e.g., an entire enterprise, developer, etc.) and have access to view and/or manage data associated with the sales teams of the several business locations, and yet another user of the user device 602B may be a manager of all business locations and have access to view and/or manage data associated with all teams of all business locations. For example, the administrator user may have access to view and/or manage data associated with any of the foregoing categories or outputs, including but not limited to, identification of specific areas the supervised group(s) or individual(s) should focus on (e.g., only provide legal disclosures 70% of the time); scores of the supervised group(s) or individual(s) by personas (e.g., personalities of digital humans) such as young women, older men; and/or analyses of time per training session or other training increment for the supervised group(s) or individual(s), in each instance including absolute metrics and/or comparative outputs versus others, including aggregated data sets.

Continuing the above non-limiting contextual example, in various embodiments, the administrator (e.g., manager) may be able to modify and/or control the real-time interactive media content provided to a sales associate within the training program. For example, the manager may be able to, via the user device 602B, provide instruction to the real-time interactive media content system 120 configured to modify and/or control a tiered sequence of real-time interactive media content for one or more trainees. For example, the manager may be able to assign a sales associate to train with real-time interactive media content associated with certain variables defined by the manager (e.g., the manager may be able to assign training of a certain simulated personality type to a sales associate who they determine needs such additional training). In another example, the manager may be able to assign a sales associate to train for a certain frequency over a certain duration (e.g., 3 times a week until the sales associate's scores rise to a certain threshold). In this manner, a user of user device 602B may be able to control the interactions with real-time interactive media content for a user of user device 602A.

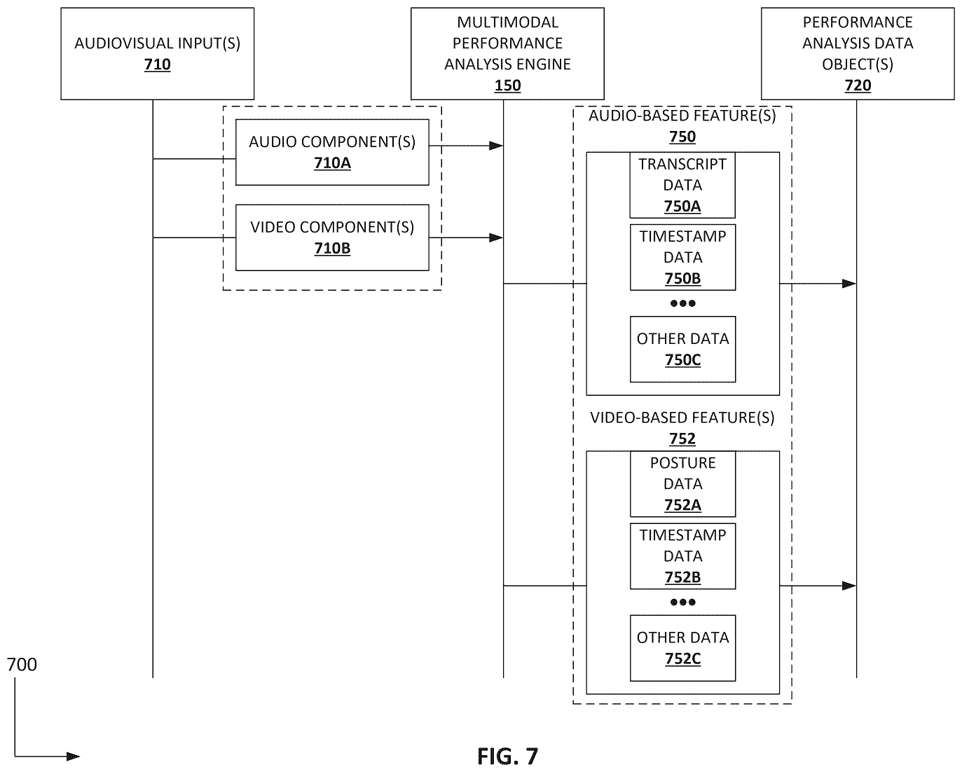

FIG. 7 is an example data flow 700 presented in accordance with one or more embodiments of the present disclosure. In some example embodiments, the data structures and processes shown and described with respect to the data flow diagram of FIG. 7 may be generated, performed, and/or otherwise facilitated by the various systems and apparatuses shown and described with respect to FIGS. 1-2.

As described with references to FIG. 1 and FIG. 3, audiovisual inputs 710 may include audiovisual data of a user interacting with real-time interactive media content. For example, the audiovisual input 710 may include audiovisual data of a user interacting with real-time interactive media content output by the real-time interactive media content system 120. The audiovisual input 710 includes audio component 710A and video component 710B respectively including audio data and video data captured by a user device (e.g., user device 102) during display of real-time interactive media content. The audiovisual input 710 may be provided to the multimodal performance analysis engine 150 to generate performance analysis data object 720. The performance analysis data object 720 may be used to provide performance analysis data associated with the user interacting with the real-time interactive media content and the multimodal performance analysis engine 150 may generate one or more features which the performance analysis data object 720 may be based on. For example, the performance analysis data object 720 may be based on the audio-based feature 750 and/or the video-based feature 752. In some embodiments, the performance analysis data object 720 may be based on one feature (e.g., the audio-based feature 750, the video-based feature 752, or any other feature) or a plurality of features (e.g., a combination of the audio-based feature 750 and the video-based feature 752 or any other features). For example, one or more audio-based features 720 and/or one or more video-based features 752 may be analyzed as a combined audiovisual feature set and/or separately as distinct audio and video analyses.

As shown, the audio-based feature 750 includes transcript data 750A, timestamp data 750B, and other data 750C (e.g., additional features, metadata, and/or the like). For example, the transcript data 750A may include one or more terms, phrases, and/or the like spoken by the user and detected within the audio components 710A of the audiovisual inputs 710. The transcript data 750A may be associated with timestamp data 750B indicating a relative and/or absolute time with which the transcript data 750A is associated. Similarly, the video-based feature 752 includes posture data 752A, timestamp data 752B, and other data 752C (e.g., additional features, metadata, and/or the like). For example, the posture data 752A may include data descriptive of a posture of the user detected within the video component 710B of the audiovisual inputs 710. The posture data 752A may be associated with timestamp data 752B indicating a relative and/or absolute time with which the posture data 752A is associated. In this manner, embodiments described herein may track when and which features are generated.

In a non-limiting contextual example, the audiovisual inputs 710 may include audiovisual data of a trainee interacting with real-time interactive media content for a simulated training program where the trainee is training as a vehicle sales associate, F&I representative, and/or the like, and the real-time interactive media content is representing a customer shopping for a vehicle. The multimodal performance analysis engine 150 may, via the behavioral analysis engine, generate the audio-based feature 750 indicative of the trainee providing an incorrect answer to a question prompted by the real-time interactive media content at a first time interval associated with timestamp data 750B. Additionally, the multimodal performance analysis engine 150 may, via the behavioral analysis engine, generate the video-based feature 750 indicative of the trainee having poor posture while speaking to the real-time interactive media content at a second time interval associated with timestamp data 752B. The audio-based feature 750 and video-based feature 752 may be used by the multimodal performance analysis engine 150 (e.g., using one or more rules analysis models) to generate the performance analysis data object 720. In some examples, the multimodal performance analysis engine 150 may generate one or more performance analysis data objects 720 for each of the audio-based features 750 and/or video-based features 752 or any combination thereof.

The performance analysis data object 720 may include a score reflective of the trainee's overall performance, performance associated with only the audio-based feature 750, performance associated with only the video-based feature 752, or any combination thereof. Continuing the non-limiting contextual example above, the performance analysis data object 720 may be configured to provide performance feedback data to the trainee associated with the trainee providing the incorrect answer and having poor posture. For example, the performance analysis data object 720 may indicate that the trainee's performance was “unsatisfactory.” In other examples, as discussed with respect to FIG. 3, the performance analysis data object 720 may provide any variety of scores or score types as performance analysis feedback to the trainee. Additionally or alternatively, the performance analysis data object 720 may indicate to the trainee the answer they incorrectly provided to the prompted question, the prompted question, one or more correct answers to the prompted question, or any combination thereof. Additionally or alternatively, the performance analysis data object 720, may indicate to the trainee that the trainee assumed a poor posture while interacting with the real-time interactive media content. Additionally or alternatively, the performance analysis data object 720 may provide relevant audiovisual data of the trainee in association with the performance analysis data object 720. For example, the performance analysis data object 720 may provide for display to the trainee, one or more segments of the audiovisual inputs 710 such that the trainee may see and/or hear their incorrectly provided answer and/or poor posture (e.g., using timestamp data 750B and/or timestamp data 752B to retrieve one or more segments of the audiovisual inputs 710 stored in the data ingestion repository 160A or the contextual interaction data repository 170). Additionally or alternatively, the multimodal performance analysis engine 150 may provide one or more audiovisual suggestions and/or tiered sequences of real-time interactive media content (not shown) based on the performance analysis data object 720. For example, an audiovisual suggestion including audiovisual data of an exemplary posture may be provided (e.g., generated by the audiovisual media content engine 130, retrieved from contextual interaction data repository 170). In another example, a tiered sequence of real-time interactive media content may be generated to suggest the trainee assume an increased simulated training frequency (e.g., defined by a specific training frequency, associated with a specific experience rating, and/or the like) as a result of the unsatisfactory performance.

In various embodiments, the multimodal performance analysis engine 150 may store the performance analysis data objects 720 in a repository for later retrieval. Additionally or alternatively, the performance analysis data objects 720 may be associated with data identifying a respective user for which the performance analysis data objects 720 were generated. Such data may include, for example, personally identifying information, other personal information (e.g., a location, such as a place of work; a reason for being enrolled in a respective training program; etc.), metadata associated with a respective training program (e.g., a current tier of a tiered sequence of real-time interactive media content), metadata associated with the respective real-time interactive media content (e.g., an experience rating, a simulated personality type, a duration of interaction), date and time information, and/or the like.

### Example Embodiment and User Interaction

FIG. 8 is an example environment 800 presented in accordance with one or more embodiments of the present disclosure. In some example embodiments, some of the various entities shown and described with respect to the example environment of FIG. 8 may be generated, performed, and/or otherwise facilitated by the various systems and apparatuses shown and described with respect to FIGS. 1-2.

As shown, the environment 800 includes the user 802 interacting with real-time interactive media content representative of the simulated interactive entity 804. The audiovisual input device 806 may be any one or more devices (e.g., a webcam) including an audio capture component (e.g., a microphone) configured to capture audio of the user 802 and a video capture component (e.g., a camera) configured to capture video of the user 802. In some examples, one or more independent components and/or devices (e.g., an independent microphone and camera) may be used to capture audio and video of the user 802. The audio output device 808 may be any device configured to output audio (e.g., one or more speakers) and the video output device 810 may be any device configured to output video (e.g., a screen). In some examples, the device 806, the audio output device 808, and/or the video output device 810 may be included within the same device (e.g., a laptop, tablet, smartphone), one or more independent devices (e.g., an external microphone, external camera, a speaker, and/or display screen of a computer system), or any combination thereof. The depicted user device 812 may be equivalent to the user devices 102 described herein and represents the collective of the audiovisual input device 806, audio output device 808, and video output device 810. The collective 812 may represent the user devices, or portions thereof, described herein (e.g., user device 102). For example, the user device 102, 812 may be any device or combination of devices (e.g., a personal computer, television, tablet, phone, and/or the like with one or more inboard or external input and output devices such as microphones, speakers, screens, and cameras), including but not limited to the audiovisual input device 806, audio output device 808, and video output device 810 in combination.

As described with respect to FIG. 1 and FIG. 3, the user 802 may initiate an interaction with (e.g., speak to) the simulated interactive entity 804. The interaction of the user 802 with the simulated interactive entity 804 may cause the generation of one or more audiovisual inputs descriptive of the interaction of the user 802 via one or more input devices (e.g., the device 806). The one or more audiovisual inputs may in turn cause the generation of one or more textual input data sets, contextual response data sets, audiovisual responses, audiovisual suggestions, performance analysis data objects, tiered sequences of real-time interactive media content, and/or the like. The one or more audiovisual responses may be configured to provide a contextually relevant response to the interaction of the user 802 with the simulated interactive entity 804. The one or more audiovisual responses may be provided to the user 802 such that the output causes the user to hear and see (e.g., via the audio output device 808 and video output device 810) the simulated interactive entity 804 responding to the user 802 in a contextually relevant manner in real-time via the aforementioned processes described herein. This may prompt or allow the user 802 to further interact with the simulated interactive entity 804 by responding to the one or more audiovisual responses, which may again cause the generation of one or more audiovisual inputs. In this manner, a real-time interaction loop between the user 802 and the simulated interactive entity 804 may be facilitated.

In some embodiments, the audiovisual responses may include simulated facial expressions, gestures, and other visual portions of the real-time interactive media content configured to be displayed to the user 802. For example, the simulated interactive entity 804 represented by the real-time interactive media content may be a simulated human, and as such, may use simulated facial expressions to emulate a real human. In some embodiments, the simulated facial expressions may be determined based at least in part on one or more contextual response data sets. Additionally or alternatively, the simulated facial expressions may be synchronized with the audio outputs configured to be played to the user 802.

In some embodiments, simulated facial expressions, simulated behaviors, simulated speech, and/or the like may be emulations associated with the simulated interactive entity 804 configured to be represented by real-time interactive media content.

In some embodiments, one or more contextual response data sets may be based at least in part on a simulated personality type. Additionally or alternatively, in some embodiments, one or more audiovisual responses may be based at least in part on a simulated personality type. For example, the real-time interactive media content may be associated with a simulated personality type, and as such, contextual response data sets and/or audiovisual responses may be based on the simulated personality type.

Additionally or alternatively, in some embodiments, one or more contextual response data sets may be based at least in part on an experience rating. Additionally or alternatively, in some embodiments, one or more audiovisual responses may be based at least in part on an experience rating. Additionally or alternatively, the experience rating may be associated with one or more historical performance analysis data objects associated with the user 802. In some embodiments, an experience rating may include data defining a programmatic weight generated in association with the user 802 (e.g., a user experience score) and/or in association with one or more portions of the real-time interactive media content system 120 (e.g., a difficulty score). In some embodiments, the experience rating may be configured to be applied to one or more features of the real-time interactive media content system 120 to scale or otherwise affect the nature of the real-time interactive media content's interaction with the user 802. For example, the experience rating may be configured to control one or more parameters associated with real-time interactive media content and associated with one or more performance analysis data objects. In some examples, an experience rating may be associated with (e.g., an input associated with) real-time interactive media content, audiovisual responses, performance analysis data objects, tiered sequences of real-time interactive media content, and/or the like. For example, an experience rating may be used to control audiovisual responses, simulated personality types, the multimodal performance analysis engine 150, the interaction engine 140, the audiovisual media content engine 130, and/or the like. In some examples, an experience rating may be a score associated with an intended difficulty associated with real-time interactive media content. For example, real-time interactive media content intended to be difficult to interact with may be associated with a corresponding experience rating, audiovisual responses, and/or simulated personality type. In some embodiments, an experience rating may be assigned to one or more pre-generated models associated with real-time interactive media content and/or the experience rating may be input to the training process for one or more models to generate real-time interactive media content having a predetermined difficulty. In a non-limiting example, real-time interactive media content intended to be difficult, as indicated by an experience rating, may include or otherwise be associated with audiovisual responses configured to cause the simulated interactive entity 804 to interrupt the user 802 while speaking, ask many questions to the user 802, simulate frustration, impatience, anger, object to statements made by the user 802, and/or otherwise make interaction more difficult for the user 802. In another non-limiting example, real-time interactive media content not intended to be difficult, as indicated by an experience rating, may include or otherwise be associated with audiovisual responses configured to cause the simulated interactive entity 804 to speak in turn with the user 802, ask few and simple questions to the user 802, simulate friendliness, agree with statements made by the user 802, and/or otherwise make interaction easier for the user 802.

In some embodiments, an experience rating may be based at least in part on one or more performance analysis data object associated with the user 802. For example, if the user 802 is associated with few performance analysis data objects, associated with analysis data objects indicative of poor performance, such as a lower score relative to other users, or the like (e.g., data indicative of the user 802 having little experience), the user 802 may be provided real-time interactive media content with an experience rating configured to make interactions with the real-time interactive media content simpler or easier. In some examples, as the user 802 gains experience (e.g., the user 802 becomes associated with many performance analysis data objects, associated with performance analysis data objects indicative of good performance) the user 802 may be provided real-time interactive media content with an experience rating configured to make interactions with the real-time interactive media relatively more difficult or challenging.

In some embodiments, real-time interactive media content may be configured to simulate an interaction with the user 802 associated with a particular context. For example, real-time interactive media content may be configured to train the user 802 for a specific goal or skill, expose the user 802 to a simulated event, situation, environment, experience, interaction and/or the like. In some examples, the real-time interactive media system 120 may use information provided by the user 802 to configure a tiered sequence of real-time interactive media content (e.g., a training program) for the user 802. For example, the user 802 may provide information (e.g., personally identifying information, account information, and/or the like) that identifies the user 802 as being associated with an existing tiered sequence (e.g., a tiered sequence set up for the place of business of the user 802). Accordingly, the user 802 may provide such information to the real-time interactive media content system 120 (e.g., via an application provided by the real-time interactive media content system 120) in order to be enrolled in a tiered sequence that will begin providing the user 802 with real-time interactive media content (e.g., a tiered sequence of real-time interactive media content). In various examples, the user 802 may have a private and/or portable account that maintains historical data for the user's interactions with the real-time interactive media content system 120 (e.g., historical performance analysis data objects, tiered sequences of real-time interactive media content, etc.) and/or any other related data associated with the user 802 and the real-time interactive media content (e.g., personally identifying information, information managed by and/or generated by an administrator of the user, information on the place of business of the user). In such an example, the user 802 may be able to access such an account independent of location, a place of business, an employer, and/or the like. If a user changes locations, employers, etc., the stored data may be transmitted to a new storage device associated with the new location, employer, etc. or the data may be maintained independent of the location, employer, etc. Accordingly, the user 802 may, for example, change employers, move to a new place of business, and/or the like, while still maintaining their historical data associated with the real-time interactive media content system. In some such instances, a data value may be updated in memory to indicate the user's change while preserving the data values labeling the user's previous data for analysis. For example, data associated with the new employer, location, etc. may be labeled as such, while data associated with the old employer, location, etc. may retain the old labels to group analyses with the correct tag in each event. In some examples, this may enable the user 802 to maintain training between jobs, show credentials and/or proof of historical interactions with real-time interactive media content to a new employer, resume training with real-time interactive media content after time off without losing progress, and/or the like.

In some examples, the simulated interactive entity 804 represented by the real-time interactive media content may be configured to simulate a customer, client, employee, coworker, associate, and/or the like to train the user 802 for specific contexts and/or interactions. Non-limiting examples of real-time interactive media content include simulating (e.g., via the simulated interactive entity 804) a customer shopping in a dealership such that the user 802 may train as a vehicle sales associate, a person in their home such that the user 802 may train as a door-to-door sales associate, a client in a networking event such that the user 802 may train networking skills, a customer needing technical support such that the user 802 may train as a support technician, and/or the like. The real-time interactive media content may be generated via a series of algorithms that select or newly generate (e.g., via transformer neural network) the visual appearance (e.g., content video component representative of the simulated interactive entity 804) and/or corresponding sound (e.g., content audio component synchronized with the content video component representative of the simulated interactive entity 804) or specific modifications or outputs associated with an existing visual appearance and/or sound (e.g., audiovisual responses) of the simulated interactive entity 804 to simulate interacting with the user 802. The real-time interactive media content may be generated continuously in response to audiovisual inputs associated with the user 802 and/or may include sequentially generated sections of content generated in response to specific audiovisual inputs (e.g., responses to the questions of user 802).

In this manner, embodiments described herein provide improvements to simulated training by enabling users to engage with realistic interactive entities that express dynamic and interactive facial expressions according to what is being said.

### Example Methods

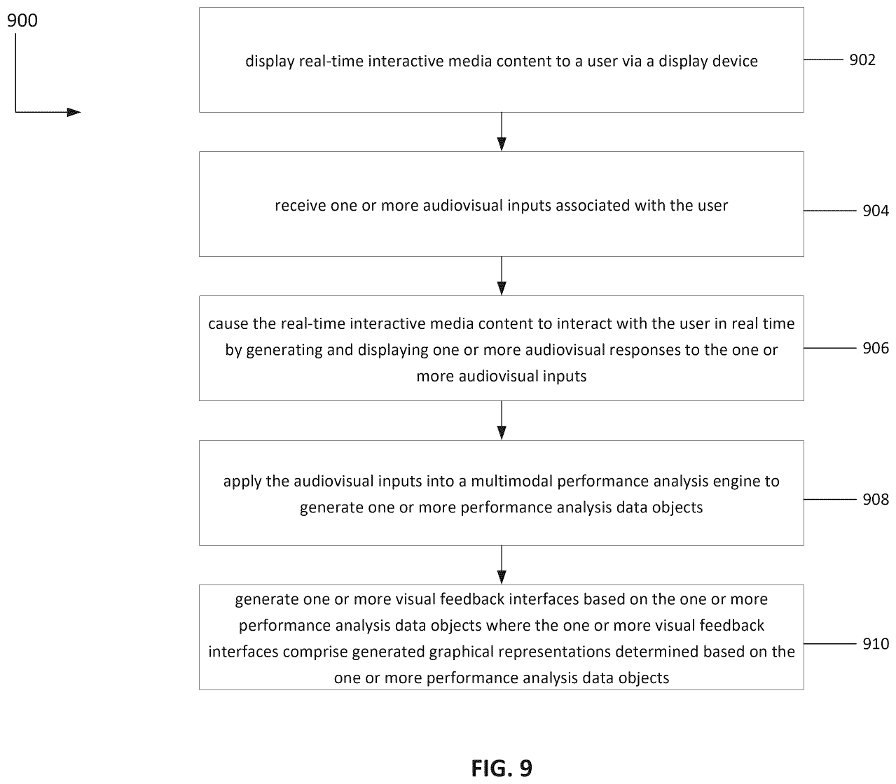

FIG. 9 illustrates an example flowchart depicting operations for predictive performance analysis in accordance with at least some example embodiments of the present disclosure. As depicted at block 902, the process 900 begins with the display of real-time interactive media content to a user via a display device. In some embodiments, the real-time interactive media content includes at least a content audio component and a content video component.

At block 904, the process continues to receive one or more audiovisual inputs associated with the user. For example, the audiovisual inputs may include a user audio component including audio data of the user captured during display of the real-time interactive media content and a user video component including one or more images of the user captured during display of the real-time interactive media content.

At block 906, the process continues to cause the real-time interactive media content to interact with the user in real time by programmatically generating and displaying one or more audiovisual responses to the one or more audiovisual inputs. In some embodiments, the one or more audiovisual responses include audio outputs configured to be played to the user and simulated facial expressions configured to be displayed to the user via the real-time interactive media content.

At block 908, the process continues to apply the audiovisual inputs into a multimodal performance analysis engine to generate one or more performance analysis data objects.

At block 910, the process continues to generate one or more visual feedback interfaces based at least in part on the one or more performance analysis data objects. In some embodiments, the one or more visual feedback interfaces include programmatically generated graphical representations determined based at least in part on the one or more performance analysis data objects.

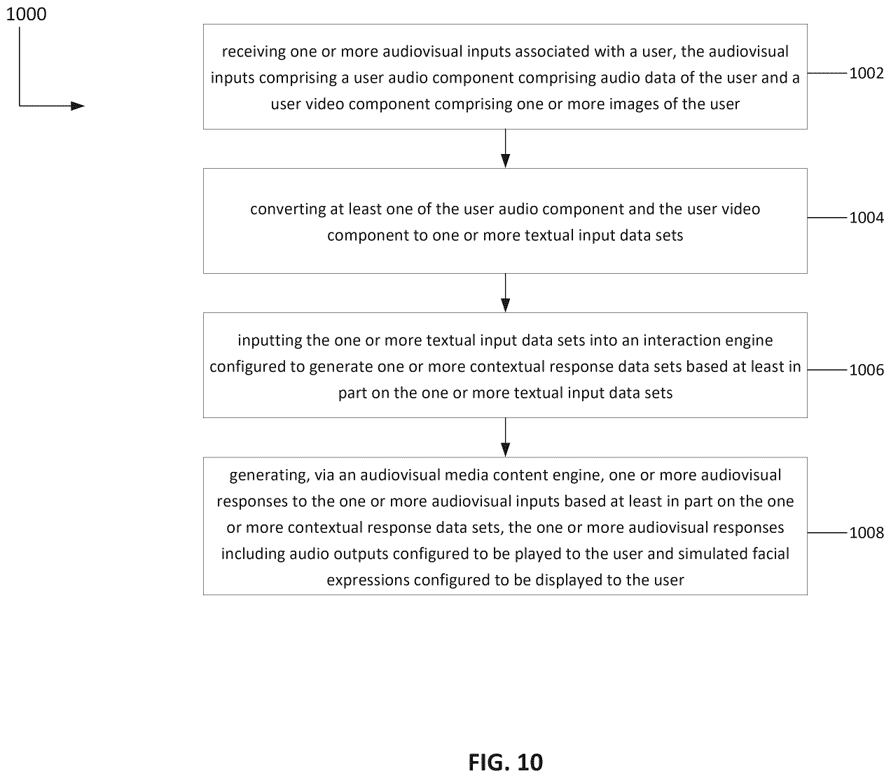

FIG. 10 illustrates an example flowchart depicting operations for predictive performance analysis in accordance with at least some example embodiments of the present disclosure. As depicted at block 1002, the process 1000 begins by receiving one or more audiovisual inputs associated with a user. In some embodiments, the audiovisual inputs include a user audio component including audio data of the user and a user video component including one or more images of the user.

At block 1004, the process continues to convert at least one of the user audio component or the user video component to one or more textual input data sets. For example, the user audio component may be applied to a natural language processing model to generate one or more textual input data sets.

At block 1006, the process continues to input the one or more textual input data sets into an interaction engine configured to generate one or more contextual response data sets based at least in part on the one or more textual input data sets.

At block 1008, the process continues to generate, via an audiovisual media content engine, one or more audiovisual responses to the one or more audiovisual inputs based at least in part on the one or more contextual response data sets. For example, the one or more audiovisual responses may be generated in response to the one or more contextual response data sets. In some embodiments, the one or more audiovisual responses include audio outputs configured to be played to the user and simulated facial expressions configured to be displayed to the user.

### Conclusion

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1.-20. (canceled)

21. A real-time interactive media content system, comprising at least one processor and at least one memory, the at least one memory comprising computer coded instructions therein, wherein the computer coded instructions are configured to, when executed by the at least one processor, cause the real-time interactive media content system to:
receive one or more audiovisual inputs associated with a user, the audiovisual inputs comprising a user audio component comprising audio data of the user and a user video component comprising one or more images of the user;
convert at least one of the user audio component or the user video component to one or more textual input data sets;
input the one or more textual input data sets into an interaction engine configured to generate one or more contextual response data sets based at least in part on the one or more textual input data sets; and
responsive to the one or more contextual response data sets, generate, via an audiovisual media content engine, one or more audiovisual responses to the one or more audiovisual inputs based at least in part on the one or more contextual response data sets, the one or more audiovisual responses including audio outputs configured to be played to the user and simulated facial expressions configured to be displayed to the user.

22. The real-time interactive media content system of claim 21, wherein converting at least one of the user audio component or the user video component to one or more textual input data sets comprises applying a natural language processing engine to the audio component comprising audio data of the user to generate one or more transcripts associated with the user audio component.

23. The real-time interactive media content system of claim 21, wherein the
interaction engine is associated with an API, wherein inputting the one or more textual input data sets into the interaction engine comprises:
formatting the one or more textual input data sets based at least in part on the API; and
inputting the one or more formatted textual input data sets into the interaction engine via the API.

24. The real-time interactive media content system of claim 21, wherein the interaction engine is configured to input the one or more contextual response data sets into the audiovisual media content engine to generate the one or more audiovisual responses.

25. The real-time interactive media content system of claim 21, wherein the computer coded instructions are configured to, when executed by the at least one processor, further cause the real-time interactive media content system to:
determine the simulated facial expressions based at least in part on the one or more contextual response data sets; and
synchronize the simulated facial expressions with the audio outputs configured to be played to the user.

26. The real-time interactive media content system of claim 21, wherein the interaction engine is trained using contextual interaction data comprising audiovisual media of interactive engagements, wherein the interaction engine is further configured to generate the contextual response data sets based at least in part on the contextual interaction data.

27. The real-time interactive media content system of claim 21, wherein the one or more contextual response data sets are based at least in part on a simulated personality type and an experience rating, the experience rating associated with one or more historical performance analysis data objects associated with the user.

28. The real-time interactive media content system of claim 21 wherein the computer coded instructions are configured to, when executed by the at least one processor, further cause the real-time interactive media content system to:
generate one or more performance analysis data objects at least in part on the one or more audiovisual inputs associated with the user.

29. The real-time interactive media content system of claim 21, wherein the one or more audiovisual inputs associated with a user are captured via a user device comprising at least one audio capture component and at least one video capture component.

30. The real-time interactive media content system of claim 21, wherein the one or more contextual response data sets are based at least in part on one or more predefined answers based on contextual interaction data.

31. The real-time interactive media content system of claim 21, wherein the interaction engine is further configured to generate the one or more contextual response data sets based at least in part on a variability parameter configured to provide variability in the interaction engine's output.

32. A computer-implemented method comprising:
receiving, by one or more processors, one or more audiovisual inputs associated with a user, the audiovisual inputs comprising a user audio component comprising audio data of the user and a user video component comprising one or more images of the user;
converting, by one or more processors, at least one of the user audio component or the user video component to one or more textual input data sets;
inputting, by one or more processors, the one or more textual input data sets into an interaction engine configured to generate one or more contextual response data sets based at least in part on the one or more textual input data sets; and
responsive to the one or more contextual response data sets, generating, by one or more processors, via an audiovisual media content engine, one or more audiovisual responses to the one or more audiovisual inputs based at least in part on the one or more contextual response data sets, the one or more audiovisual responses including audio outputs configured to be played to the user and simulated facial expressions configured to be displayed to the user.

33. The computer-implemented method of claim 32, wherein converting at least one of the user audio component or the user video component to one or more textual input data sets comprises applying a natural language processing engine to the audio component comprising audio data of the user to generate one or more transcripts associated with the user audio component.

34. The computer-implemented method of claim 32, wherein the interaction engine is associated with an API, wherein inputting the one or more textual input data sets into the interaction engine comprises:
formatting the one or more textual input data sets based at least in part on the API; and
inputting the one or more formatted textual input data sets into the interaction engine via the API.

35. The computer-implemented method of claim 32, wherein the interaction engine is configured to input the one or more contextual response data sets into the audiovisual media content engine to generate the one or more audiovisual responses.

36. The computer-implemented method of claim 32, wherein the audiovisual media content engine is further configured to:
determine the simulated facial expressions based at least in part on the one or more contextual response data sets; and
synchronize the simulated facial expressions with the audio outputs configured to be played to the user.

37. The computer-implemented method of claim 32, wherein the interaction engine is trained using contextual interaction data comprising audiovisual media of interactive engagements, wherein the interaction engine is further configured to generate the contextual response data sets based at least in part on the contextual interaction data.

38. The computer-implemented method of claim 32, wherein the one or more contextual response data sets are based at least in part on a simulated personality type and an experience rating, the experience rating associated with one or more historical performance analysis data objects associated with the user.

39. The computer-implemented method of claim 32 further comprising:
generating one or more performance analysis data objects based at least in part on the one or more audiovisual inputs associated with the user.

40. The computer-implemented method of claim 32, wherein the one or more audiovisual inputs associated with a user are captured via a user device comprising at least one audio capture device and at least one video capture device.

41. The real-time interactive media content system of claim 32, wherein the interaction engine is further configured to generate the one or more contextual response data sets are based at least in part on one or more predefined answers based on contextual interaction data.

42. The real-time interactive media content system of claim 32, wherein the interaction engine is further configured to generate the one or more contextual response data sets based at least in part on a variability parameter configured to provide variability in the interaction engine's output.
